(19) United States
(12) Patent Application Publication
(10) Pub. No.: US 2025/0036862 A1
(43) Pub. Date: Jan. 30, 2025

(54) METHODS AND SYSTEMS FOR SPECIFYING AND USING JOINS BETWEEN DATA SETS IN A SPREADSHEET DATA VISUALIZER

(71) Applicant: Adaptam Inc., Palo Alto, CA (US)

(72) Inventors: Robert E. Dvorak, Portola Valley, CA (US); Yuriy Garin, San Carlos, CA (US); Alexey Verkhovskiy, Calgary (CA)

(73) Assignee: Adaptam Inc., Palo Alto, CA (US)

(21) Appl. No.: 18/777,446

(22) Filed: Jul. 18, 2024

Related U.S. Application Data
(60) Provisional application No. 63/529,135, filed on Jul. 26, 2023.

(51) Int. Cl. G06F 40/18

(52) U.S. Cl. CPC G06F 40/18

(57) ABSTRACT

The disclosed technology creates a range of manual to automated ways of setting up and verifying the correct joining of data sets for use generating charts within a spreadsheet visualizer. Handling pairing of data sets and then chaining/sequencing of joins resulting in joins of three or more data sets. Limiting joins, as desired, to data value matching criteria and data modelling cardinality requirements. Allowing the qualification of the data sets for joining to be done within or before spreadsheet visualizer input panel. Making the qualified joinable data sets available in situationally intelligent data field/column selection lists for use populating the data visualizer inputs. Availing those joined data fields/columns to be used to generate spreadsheet visualizer charts.

### CROSS-REFERENCE

This application claims priority to and the benefit of U.S. Provisional Application No. 63/529,135, filed 26 Jul. 2023 (Atty. Docket No. ADAP 1017 1). The priority application is incorporated by reference herein for all purposes.

### RELATED APPLICATIONS

This application is related to and incorporates by reference the following applications:
U.S. application Ser. No. 16/031,339 titled “Methods and Systems for Providing Selective Multi-Way Replication and Atomization of Cell Blocks and Other Elements in Spreadsheets and Presentations,” filed 10 Jul. 2018, now U.S. Pat. No. 11,182,548, issued 23 Nov. 2021 (Atty. Docket No. ADAP 1000-2), which claims the benefit of U.S. Provisional Application No. 62/530,835, filed 10 Jul. 2017 (Atty. Docket No. ADAP 1000-1).
U.S. application Ser. No. 16/031,379 titled “Methods and Systems for Connecting a Spreadsheet to External Data Sources with Formulaic Specification of Data Retrieval,” filed 10 Jul. 2018, now U.S. Pat. No. 11,354,494, issued 7 Jun. 2022 (Atty. Docket No. ADAP 1001-2), which claims the benefit of U.S. Provisional Application No. 62/530,786, filed 10 Jul. 2017 (Atty. Docket No. ADAP 1001-1).
U.S. application Ser. No. 16/031,759 titled, “Methods and Systems for Connecting a Spreadsheet to External Data Sources with Temporal Replication of Cell Blocks,” filed 10 Jul. 2018, now U.S. Pat. No. 11,017,165, issued 25 May 2021 (Atty. Docket No. ADAP 1002-2), which claims the benefit of U.S. Provisional Patent Application No. 62/530,794, filed 10 Jul. 2017 (Atty. Docket No. ADAP 1002-1).
U.S. application Ser. No. 16/191,402 titled, “Methods and Systems for Connecting a Spreadsheet to External Data Sources with Ordered Formulaic Specification of Data Retrieved,” filed 14 Nov. 2018, now U.S. Pat. No. 11,036,929, issued 15 Jun. 2021 (Atty. Docket No. ADAP 1003-2), which claims the benefit of U.S. Provisional Patent Application No. 62/586,719, filed on Nov. 15, 2017 (Atty Docket ADAP 1003-1).
U.S. application Ser. No. 17/359,430 titled, “Methods and Systems for Constructing a Complex Formula in a Spreadsheet Cell,” filed 25 Jun. 2021, now U.S. Pat. No. 11,836,444, issued 5 Dec. 2023(Atty Docket ADAP 1004-2), which claims the benefit of U.S. Provisional Patent Application No. 63/044,990, filed 26 Jun. 2020 (Atty Docket No. ADAP 1004-1).
U.S. application Ser. No. 17/359,418 titled “Methods and Systems for Presenting Drop-Down, Pop-Up or Other Presentation of a Multi-Value Data Set in a Spreadsheet Cell,” filed 25 Jun. 2021, now U.S. Pat. No. 11,657,217, issued 25 May 2023 (Atty Docket No. ADAP 1005-2), which claims the benefit of U.S. Provisional Patent Application No. 63/044,989, filed 26 Jun. 2020 (Atty Docket No. ADAP 1005-1).
U.S. application Ser. No. 17/384,404 titled “Method and System for Improved Spreadsheet Charts,” filed 23 Jul. 2021, now U.S. Pat. No. 12,056,445, issued 6 Aug. 2024 (Atty Docket No. ADAP 1006-2), which claims the benefit of U.S. Provisional Patent Application No. 63/055,581, filed 23 Jul. 2020 (Atty Docket No. ADAP 1006-1).
U.S. application Ser. No. 17/374,898 titled “Method and System for Improved Spreadsheet Analytical Functioning,” filed 13 Jul. 2021, now U.S. Pat. No. 11,694,023, issued 4 Jul. 2023 (Atty Docket No. ADAP 1007-2), which claims the benefit of U.S. Provisional Patent Application No. 63/051,280, filed 13 Jul. 2020 (Atty Docket No. ADAP 1007-1).
U.S. application Ser. No. 17/374,901 titled “Method and System for Improved Ordering of Output from Spreadsheet Analytical Functions,” filed 13 Jul. 2021, now U.S. Pat. No. 11,972,204, issued 30 Apr. 2024 (Atty Docket No. ADAP 1008-2), which claims the benefit of U.S. Provisional Patent Application No. 63/051,283, filed 13 Jul. 2020 (Atty Docket No. ADAP 1008-1).
U.S. application Ser. No. 17/752,814 titled “Method and System for Spreadsheet Error Identification and Avoidance,” filed 24 May 2022, now U.S. Pat. No. 11,977,835, issued 7 May 2024 (Atty Docket No. ADAP 1009-2) which claims the benefit of U.S. Provisional Patent Application No. 63/192,475, filed 24 May 2021 (Atty Docket No. ADAP 1009-1).
U.S. application Ser. No. 17/903,934 titled “Method and System for Improved 2d Ordering of Output from Spreadsheet Analytical Functions,” filed 6 Sep. 2022, now U.S. Pat. No. 12,050,859, issued 30 Jul. 2024 (Atty Docket No. ADAP 1010-2) which claims the benefit of U.S. Provisional Patent Application No. 63/240,828, filed 3 Sep. 2021 (Atty Docket No. ADAP 1010-1).
U.S. application Ser. No. 17/988,641 titled “Methods and Systems for Sorting Spreadsheet Cells with Formulas,” filed 16 Nov. 2022 (Atty Docket No. ADAP 1011-2) which claims the benefit of U.S. Provisional Patent Application No. 63/280,590, filed 17 Nov. 2021 (Atty Docket No. ADAP 1011-1).
U.S. application Ser. No. 18/074,301 titled “Method and System for Improved Visualization of Charts in Spreadsheets,” filed 2 Dec. 2022 (Atty Docket No. ADAP 1012-2) which claims the benefit of U.S. Provisional Patent Application No. 63/25,945, filed 3 Dec. 2021 (Atty Docket No. ADAP 1012-1).
U.S. application Ser. No. 18/142,560 titled “Methods and Systems for Spreadsheet Function and Flex Copy-Paste Control of Formatting and Use of Selection List Panels,” filed 2 May 2022 (Atty Docket No. ADAP 1013-2) which claims the benefit of U.S. Provisional Application No. 63/337,576, filed 2 May 2022 (Atty Docket No. ADAP 1013-1).
U.S. application Ser. No. 18/142,557 titled “Methods and Systems for Bucketing Values in Spreadsheet Functions,” filed 2 May 2023 (Atty Docket No. ADAP 1014-2) which claims the benefit of U.S. Provisional Application No. 63/337,572, filed 2 May 2022 (Atty Docket No. ADAP 1014-1).
U.S. application Ser. No. 18/542,510 titled “Methods and Systems for Flexibly Linking Spreadsheet Cell Movements and Formulas,” filed 15 Dec. 2023 (Atty Docket No. ADAP 1015-2) which claims the benefit of U.S. Provisional Application No. 63/433,408,” filed 16 Dec. 2022 (Atty Docket No. ADAP 1015-1).
U.S. application Ser. No. 18/765,168 titled “Methods and Systems for Specifying and Using in Spreadsheet Cell Formulas Joins Between Data Sets,” filed 5 Jul. 2024 (Atty Docket No. ADAP 1016-2) which claims the benefit of U.S. Provisional Application No. 63/525,138, filed 5 Jul. 2023 (Atty Docket No. ADAP 1016-1).

### BACKGROUND

As described in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021 in today's spreadsheets creating a chart from external data that involves analytics (e.g., data calculations or filtering) is a multi-step complicated process involving data import into the spreadsheet cells, data manipulation to support the analyses, data calculation, results organization for the chart, and finally, the chart input/creation. This process is even more complicated if sizeable data sets are involved, range or array function calculations, complex repetitive calculations and/or charts that change with different data constraints/filters (e.g., varying by different dates or ranges of dates). Creating the same chart from in-cell data, while one big step of data importation easier, can still be a multi-step complicated process that requires data manipulation, calculations, and results organization for the chart. Therein lay a large opportunity to dramatically simplify creating charts from external data and charts from in-cell data which involve analytics (e.g., data calculations, sorting and/or filtering) as addressed by our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021. However, that spreadsheet visualizer works on a single data set and therein lays a large opportunity to instead have the visualizer work with joined data from multiple data sets which are very easily utilized by the spreadsheet user. There also arises an opportunity to ensure users do not execute data joins that will not work (e.g., with keys of different data types) and joins which do not join (e.g., with keys that have no overlapping/shared values) through verified (qualified) joinable selection lists for the visualizer inputs only showing fields in data sets hitting certain join parameters (e.g., join keys with of the same data type and shared values). There is an opportunity to make it extremely easy for the spreadsheet users to join data via lists of joinable data which also screens out certain data modelling cardinalities of the data sets (e.g., limited Cartesian Product joins from many to many join key situations or Full Cartesian joins from a cross join) that result in data row duplication the unsophisticated user may not understand. There are opportunities to automate the determination of joinable data set pairings and to then automatically determine combinations of joinable data set pairings (via chaining or sequencing of joins) resulting in three or more data set joins for use in the spreadsheet visualizer charts.

### SUMMARY

The disclosed technology creates a range of manual to automated ways of setting up and verifying the correct joining (e.g., same data type keys with shared values) of data sets for use in spreadsheet data visualizer. Handling pairing of data sets and then chaining/sequencing of joins resulting in joins of three or more data sets. These qualified (validated) joinable data set fields/columns are then usable in spreadsheet visualizer which is then error protected against unverified joins through lack of access, warnings, or error messages. The situationally qualified (e.g., validated or verified) data set joins of the in-cell and/or external joined data sets is then presented by our technology in selection lists for easy population into the visualizer inputs. Those joinable data selection lists (e.g., hints) can be further limited to exclude limited and/or full Cartesian Product joins to protect unsophisticated users from joins that duplicate data rows in ways they may not understand.

Embodiments of the disclosed technology range from human qualified joinability to fully automated qualification with different combinations of human and automated qualification/validation processes and steps. That qualification can include eliminating joins between keys that are not the same data type and join keys that share no overlapping/shared values which would of course generate no inner join values. It can also be extended to narrow the range of acceptable joins, for example 1) accepting only referential integrity 2) accepting a less limiting variant of “unique to unique” cardinality 3) accepting the combination of “unique to unique” and “unique to non-unique” and so on. Embodiments can make it easy for users to set up the desired joins via selection lists presenting information on the potential join key combinations through to removing options not meeting qualification criteria. Embodiments can go as far as automating the determination of the joining keys and therefore the data set joins. Embodiments can make using the joined data sets easy via sequentially organized data selection lists that automatically avail users to the joinable data sets. Embodiments of those selection lists can make it easy to use certain joins that require little sophistication to understand the outcomes and more difficult to do data set joins typically requiring more sophistication to understand the outcomes (e.g., Cartesian Product joins or composite key joins).

Embodiments can ensure that once the joining moves beyond a pair of data sets that the selection list supported joinable data does not violate any of the cardinality join limitations (e.g., limited Cartesian Product joins) for the chained/sequenced joins. Embodiments can give users access to chained/sequenced joinable data sets from joins qualified before the visualizer inputs and that execute in the visualizer inputs with no visible join argument or arguments. With further embodiments that allow more sophisticated users the ability to specify any of the SQL type joins (e.g., inner, left outer, right outer, full outer, cross, and self) and specify joins not prequalified.

Embodiments of the disclosed technology allow usage in visualizer formulaic data algebraic formulas, prebuilt function formulas, and/or formulaic data formulas. Where that usage results in adding a joined data field/column to the formula and/or substituting a joined data field for a field/column from another joined data set. Embodiments support the data join being done as input into the visualizer chart setup. Embodiments support default join types and join keys which can then be changed via overrides of prequalified joins. Those joined data sets can reside within the spreadsheet cells and/or in non-spreadsheet cells (NSCs) external to the spreadsheet cells.

Embodiments support multiple joins between the same two data sets automatically creating a field/column naming approach to identify the multiple joined fields. Further embodiments support the automatic or user decision supported conversion of a multiple joined field after another visualizer input requires the former input to be translated to a multiple joined field.

Embodiments of the disclosed technology can situationally specific present a qualified joinable list of selectable formulaic data fields/columns for user population into the spreadsheet visualizer inputs. Where that list changes with selections and is not present when there are no joinable options or no pre-verified options. Embodiments support informing users should they type a non-joinable set of formulaic data fields into a formula with ERROR messages after they enter the input. Embodiments help users who want to specify a join within a visualizer chart set of inputs or before then with information to inform the join specification, e.g., key pair data type compatibility, value matches and data modelling cardinality, through to automated screening of key pairs passing qualification (join validation) tests.

Particular aspects of the technology disclosed are described in the claims, specification, and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The color drawings also may be available in USPTO's Patent Center via the Supplemental Content tab.

The included drawings are for illustrative purposes and serve only to provide examples of possible structures and process operations for one or more implementations of this disclosure. These drawings in no way limit any changes in form and detail that may be made by one skilled in the art without departing from the spirit and scope of this disclosure. A more complete understanding of the subject matter may be derived by referring to the detailed description and claims when considered in conjunction with the following figures, wherein like reference numbers refer to similar elements throughout the figures.

FIG. 1 examples locations of join qualification (flag setting) or requalification.

FIG. 2 examples some of the manual, automated, and combinations therein of ways the join qualification (flag setting) can be done.

FIG. 3 examples a number of different join qualification validation test paths.

FIG. 4 examples a two data set lookup join (left outer join of a unique to non-unique) done in SQL with no duplication of the non-unique data set rows.

FIG. 5 examples a two data set join (left outer join of a non-unique to non-unique) done in SQL with duplication of the non-unique data set rows (Partial Cartesian Product).

FIG. 6A illustratively examples the data sets for our spreadsheet application being non-spreadsheet cell (NSC) external data sets residing in a database on the device (e.g., laptop) running the spreadsheet application.

FIG. 6B illustratively examples the data sets for our spreadsheet application being non-spreadsheet cell (NSC) external data sets residing in a database somewhere in the cloud.

FIG. 7A illustratively examples the data sets for our spreadsheet application being in-cell data ranges residing within a worksheet within the spreadsheet.

FIG. 7B illustratively examples the data sets for our spreadsheet application being in-cell data tables residing within a worksheet within the spreadsheet.

FIG. 8 examples a UI for join key setting following a user manual, then automated and then user manual selection process supported by automated qualification screening and validation criteria information for the user selection.

FIG. 9 examples a UI for a user setting join qualification flag (in a Data Intake tool although it be used elsewhere).

FIG. 10 examples a UI for a user setting join qualification flag with an automated join qualification validation that the specified join keys failed.

FIG. 11 examples a UI exampling a join qualification flag process starting with an automated determination of the suggested join key pairs followed by a user manual finalization of the pairs following the ‘a/e/f/h’ path in FIG. 2.

FIGS. 12A, 12B, 12C, and 12D example two of many different modes of accessing join setup and setting up joins (to join qualification flags) for an entire spreadsheet.

FIG. 13 examples a spreadsheet visualizer tab displaying a bar chart created using a sidebar input panel with a visualizer join specifier.

FIG. 14A examples a menu mode of accessing a visualizer join specifier.

FIG. 14B examples one of many ways to specify joins employing a manual setup of the join arguments including tables/keys, cardinality, and two-way key value matches.

FIG. 15A illustratively examples a user specifying the data sets which are joinable and their join keys.

FIG. 15B illustratively examples our technology automatically (algorithmically) determining the join keys and therefore the joinable data sets.

FIG. 16 examples our spreadsheet visualizer creating a chart using fields/columns from one data set.

FIG. 17 illustratively examples the actions automatically executed by our visualizer to generate the chart in FIG. 16.

FIG. 18A examples a field/column selection list triggered by clicking the dropdown button in a visualizer without our joining technology.

FIGS. 18B and 18C example two field/column selection list variants triggered by clicking the dropdown button in a visualizer with our joining technology.

FIGS. 18D and 18E example user selections of a joined field/column in two different selection list variants triggered by clicking the dropdown button in a visualizer with our joining technology.

FIGS. 19A, 19B, 19C, 19D, and 19E examples two different dropdown selection list sequences employing an ‘ADD another table’ selection to access the joinable data set fields/columns in our technology.

FIG. 20A examples a field/column selection list triggered by clicking the popup button in a visualizer without our joining technology.

FIGS. 20B and 20D example two field/column selection list variants triggered by clicking the popup button in a visualizer with our joining technology.

FIGS. 20C and 20E example user selections of a joined field/column in two different selection list variants triggered by clicking the popup button in a visualizer with our joining technology.

FIGS. 21A, 21B, 21C, 21D, and 21E examples two different popup selection list sequences employing an ‘ADD another table’ selection to access the joinable data set fields/columns in our technology.

FIG. 22 examples our spreadsheet visualizer creating a chart using our prequalified joined fields/columns from two data sets.

FIG. 23 illustratively examples our spreadsheet visualizer data set joining technology doing four different types of joins for use generating a visualizer chart.

FIG. 24 illustratively examples the actions automatically executed by our visualizer to generate the chart in FIG. 23 using the joined data.

FIG. 25 visually examples the result of four types of (SQL) data joins.

FIG. 26A illustratively examples a user specifying the data sets which are joinable and their join keys for a unique to non-unique data modelling cardinality join.

FIG. 26B illustratively examples our technology automatically (algorithmically) determining the join keys and therefore the joinable data sets for a unique to non-unique data modelling cardinality join.

FIG. 27 examples our spreadsheet visualizer creating a chart using our prequalified joined fields/columns from two data sets with a unique to non-unique cardinality join for a Y input using a custom formula with two functions and an algebraic operator.

FIGS. 28A, 28B, and 28C examples a sequence of joined data set selection lists for a custom formula combining field/column and prebuilt function potential selections.

FIG. 29 illustratively examples an inner and full outer join of unique to non-unique cardinality executed by our technology to support the generation of a visualizer chart.

FIGS. 30A and 30B illustratively examples the actions automatically executed by our visualizer to generate the chart in FIG. 27.

FIG. 31A illustratively examples a user situationally specifying or not specifying the data sets which are joinable and their join keys for a non-unique to non-unique data modelling cardinality join.

FIG. 31B illustratively examples our technology automatically (algorithmically) situationally determining or not determining the join keys and therefore the joinable data sets for a non-unique to non-unique data modelling cardinality join.

FIG. 32 examples a user unknowingly generating a visualizer chart with a partial Cartesian Product non-unique to non-unique join doubling some of the donations, thereby distorting the results.

FIG. 33 examples a more sophisticated user using a visualizer constraint to generate a visualizer chart avoiding a partial Cartesian Product non-unique to non-unique join distortion the results.

FIG. 34 examples a more sophisticated user overriding the prequalified block of non-unique to non-unique cardinality joins by adding an in visualizer join via the join specifier panel in our technology.

FIG. 35 illustratively examples a left outer join of non-unique to non-unique cardinality executed by our technology to support the generation of the visualizer charts in FIGS. 32, 33, and 34.

FIG. 36 illustratively examples the actions automatically executed by our visualizer to generate the chart in FIG. 32.

FIG. 37 illustratively examples the actions automatically executed by our visualizer to generate the chart in FIGS. 33, and 34.

FIG. 38A examples three data sets used to example a chained/sequenced join in our technology where one of the joins is unique to unique and the other is unique to non-unique.

FIGS. 38B, 39A, and 39B illustratively examples a user or our technology automatically specifying two pairs of data sets which are joinable and their join keys.

FIG. 40 examples our spreadsheet visualizer creating a chart using our prequalified chained/sequenced joined fields/columns from three data sets.

FIGS. 41A, 41B, and 41C examples a three-step selection list sequence (including a table selection) for chain/sequence joined data employing dropdown UIs starting from an ‘ADD another selection’.

FIGS. 41D, 41E, and 41F examples a three-step selection list sequence (including a table selection) for chain/sequence joined data employing popup UIs starting from an ‘ADD’ selection.

FIG. 42 illustratively examples an inner and full outer chained/sequence join of three data sets executed by our technology to support the generation of a visualizer chart.

FIGS. 43A and 43B illustratively examples the actions automatically executed by our visualizer to generate the chart in FIG. 40.

FIG. 44A examples three data sets used to example a chained/sequenced join in our technology where both of the joins are unique to non-unique.

FIGS. 44B, 45A, and 45B illustratively examples a user or our technology automatically specifying two pairs of data sets which are joinable and their join keys, both joins with data modelling cardinality of non-unique to non-unique.

FIG. 46 examples our spreadsheet visualizer creating a chart using our prequalified joined fields/columns from three data sets employing chained/sequenced joins pairs of non-unique to non-unique joins.

FIG. 47 illustratively examples an inner and full outer chained/sequence join of three data sets executed by our technology to support the generation of a visualizer chart.

FIGS. 48A and 48B illustratively examples the actions automatically executed by our visualizer to generate the chart in FIG. 46.

FIG. 49 examples our spreadsheet visualizer creating a chart using our prequalified joined fields/columns from three data sets employing chained/sequenced joins pairs of non-unique to non-unique joins and populating a visible join argument in the join specifier panel, within the visualizer input panel, when the join is used by a visualizer input.

FIGS. 50A, 50B, 51A, 51B, 52, 53, and 54 examples a chained/sequenced join with a cardinality constraint allowing only unique to unique and unique to non-unique joins where each of the joins passes the test but the sequenced join does not and therefore the impact on selection lists and chart generation.

FIGS. 55, 56, 57A, and 57B are examples of letting a user override cardinality qualification tests.

FIGS. 58A, 58B, 59, 60, 61A, 61B, 62A, and 62B examples our spreadsheet visualizer charting a more complicated formula with multiple functions and algebraic operators employing chained/sequenced joins of four different data sets.

FIGS. 63A, 63B, 64A, 64B, 65, 66, 67, 68, 69A, and 69B examples our spreadsheet visualizer double joining two data sets as part of the visualizer chart including automatically adjusting the double joined field/column names.

FIGS. 70, 71, 72, and 73 examples additional capabilities of our double (or more joining) technology between two data sets, where user selections result in the automatic or user selection replacement of a non-joined field with one of its double (or more in situations with triple or more joins) join fields.

FIG. 74 examples a visualizer chart input with a join specifier input and no prequalified joins.

FIGS. 75A, 75B, 75C, 75D, 75E, 75F, 76A, 76B, and 76C example selection list UIs supporting the creation of join within a join specifier input.

FIGS. 76D and 76E examples two different ways of displaying the join completed in the join input specifier.

FIG. 77 examples the visualizer in FIG. 74 with the same field input selection list open post the join input resulting in the display of the joinable fields (not displayed pre the input of the join).

FIG. 78 examples the visualizer in FIG. 77 after all the field inputs employing the join in the join specifier to generate the chart.

FIG. 79 illustratively examples the actions automatically executed by our visualizer using the in visualizer specified join to generate the chart in FIG. 78.

FIGS. 80, 81, 82, 83, and 84 examples the charity user creating the same chart as in FIG. 78 except with a much more manual embodiment with no join creation selection lists, no field/column selection lists and only typical spreadsheet syntax help.

FIG. 85 examples the same visualizer chart as FIG. 22 however automatically populating the prequalified join used in a join specifier input so that the user can see it or them.

FIG. 86 examples the overriding of a prequalified join by a user input in the visualizer join specifier of a replacement join, altering the join in FIG. 85.

FIG. 87 examples the reset of the visualizer chart caused by a replacement join which renders the previously used join inputs invalid as occurred in FIG. 86 versus FIG. 85.

FIGS. 88A and 88B example two selection lists supported by our technology when a user has specified one data set, its join key, and the other data set.

FIGS. 88C and 88D example selection list join validation outcomes supported by our technology when a user has specified one data set, its join key and the other data set and its join key.

FIG. 89 examples a visualizer input field/column selector list displaying data from three joinable data sets filtered to allow selection of the numeric fields because of the limitation of use in a SUM prebuilt function.

FIG. 90 examples our spreadsheet visualizer creating a chart using two in visualizer join specifier joins which are automatically chain/sequence joined to generate the visualizer chart supported by join creation selection lists and then joinable field/column selection lists.

FIGS. 91A and 91B illustratively examples the actions automatically executed by our visualizer to generate the chart in FIG. 90.

FIGS. 92, and 93 examples our spreadsheet visualizer creating a chart using two in visualizer join specifier joins which then automatically chain/sequence joined to generate the visualizer chart supported by no join creation selection lists and then no joinable field/column selection lists.

FIGS. 94A and 94B illustratively examples the actions automatically executed by our visualizer to generate the chart in FIG. 93.

FIGS. 95 and 96 examples a join specifier argument embodiment where a set of joins using the same join type can combine into a single input box (term).

FIG. 97 examples a variant of the embodiment in FIG. 95 and FIG. 96 where the different joins are repeating in what we call argument groups that contain the join key arguments (e.g., JoinKey1 and JoinKey2) separated by a comma and then each group is separated from the next group by a vertical bar ‘l’.

FIG. 98 examples a join specifier argument type where the argument is a prebuilt function.

FIG. 99 examples another prebuilt function join specifier embodiment employing join type specific prebuilt functions.

FIG. 100 examples FIG. 59 after the user hid the visualizer input panel.

FIG. 101 depicts an example computer system that can be used to implement aspects of the technology disclosed.

### DETAILED DESCRIPTION

The following detailed description is made with reference to the figures. Example implementations are described to illustrate the technology disclosed, not to limit its scope, which is defined by the claims. Those of ordinary skill in the art will recognize a variety of equivalent variations on the description that follows.

When spreadsheet applications were first created, they electronically emulated tabular paper spreadsheets. More recently, Microsoft Excel, Google Sheets, Apple Numbers, and others have dramatically increased the breadth of capabilities and usefulness of spreadsheets. Spreadsheet applications now access data across a wide variety of sources including relational, structured, and semi-structured, open data protocol (OData), Web and Hadoop among others; and these applications manipulate data—such as in pivot tables and via Microsoft PowerPivot. Additionally, spreadsheets have extensive functionality for creating charts with SmartArt and for building forms, and they even have programming languages embedded within them, such as Visual Basic (VBA in Excel), Apps Script (in Google Sheets) and Apple Script (in Numbers).

With all the added capabilities, spreadsheet applications have become substantially more complicated. All this complexity has led to over a hundred books and thousands of online videos that have been published to help users understand the capabilities of Excel alone. However, unlike programming languages and programming where users tend to spend long hours of focused use day after day, most spreadsheet users are much more occasional users episodically working in spreadsheets as part of being a student, doing their job or doing some other activity. Therefore, they tend to know how to use a small fraction of the spreadsheet capabilities and not to remember non-intuitive instructions. For these users it is incredibly beneficial to make the usage simple and intuitive requiring no memory of what to do and how to do it. For those users it is very valuable to have external data (e.g., web or their employer company data) simply available in their spreadsheets and to eliminate as much data manipulation and data analytics as possible. Spreadsheet providers like Microsoft Excel and Google Sheets, as well as the other spreadsheet providers, have not made external data directly available in their chart creation instead requiring users to import the data into their spreadsheet cells. The joining of the data would need to happen in that importation process or occur in an additional capability within the spreadsheet (e.g., Microsoft Excel PowerPivot) as current spreadsheets have no ability to join data in regular spreadsheet formulas. Thus, we are talking a many step process to import and join the data then typically followed by other repetitive operations to do any further data manipulation and calculations to then finally setup the chart. Our new technology gets rid of all but the last step of setting up the chart, making it dramatically simpler for low and even high skilled spreadsheet users to chart external data and then change the desired chart by changing the input specification(s) it is using (e.g., filtering or constraining it) or changing the analytic formula it is charting.

Our technology also greatly simplifies charting in-cell data joined across two or more data sets. It eliminates all the repetitive XLOOKUP, VLOOKUP or HLOOKUP manipulations or the importation of the data ranges/tables into PowerPivot for its limited table joining (e.g., join type, join chaining and cardinality limitation), data manipulation (e.g., sorting), and calculation capabilities (very limited functions and algebraic operation combinations). It also eliminates any further all data manipulation (e.g., copying, sorting and layout changes) required to support the desired analytics (e.g., calculations and/or filtering), eliminates the in-cell data analytics, and configuring of the results for chart input. It also dramatically simplifies changes in the chart (e.g., changing the data filters or changing the calculations being charted) as we will now example.

Our technology gives spreadsheet users the ability to do in spreadsheet visualizer data set joins of any particular type (e.g., inner or full outer) with an analytically validated (e.g., same data type, overlapping values) or not validated (user specified with no automated validation) join, for two or more data sets, using in-spreadsheet cell or external (e.g., NSC) data. Embodiments can allow any data modelling cardinality or limit the type of joins to combinations that are unique to unique, unique to non-unique (“many”) or more limiting variants like referential integrity joins. Embodiments of our technology can then present those joinable field options in a selector list (e.g., hint) for easy selection by the spreadsheet user in creating a join before the spreadsheet, in the spreadsheet but before the visualizer or in the visualizer. We will start exampling embodiments with extensive joining validation/limitation and selector lists, move to examples with less of each, and then move to examples with no validation/limitations and no selector lists. In doing so we will also example joins of two data sets, multiple joins between two data sets and chained/sequenced joins of three or more data sets. All of our examples could be done using in-cell, external (NSC) or combinations of both.

The one aspect we will not really example because of the limitations of making examples simple is the complexity reduction with typical real-world situations. For it would not be unusual to have tables with thirty to fifty columns/fields which makes it incredibly difficult to deal with without intelligent selection lists. Think of the complexity of joining two tables with fifty fields/columns each if you have to then look at one hundred fields/columns in a data set within a normal spreadsheet. Let alone if there are four sequence/chain joinable data sets of size, our technology presents the information in much more manageable chunks with intelligent screening for the user. We will example that with the very small data sets, but retaining the data set structure and intelligently screening options in intelligent selection list drives important simplicity for the user in what is otherwise a complex go of joining data sets and then using the joined data.

In the interest of conciseness, the combinations of features disclosed in this application are not individually enumerated and are not repeated for each type of formula, function, join type, et cetera used in the visualizer inputs. We have also exampled our technology in a single visualizer type recognizing that our data visualizer data set joining technology work in all the types of spreadsheet visualizers in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021. Our description here is for two panel visualizer with one panel for the inputs used to generate the visualizer chart and the other panel for the output of the visualizer chart. The input panel can be multiple different UIs and parts of it can be super imposed on the chart out as per our previous filing. The output panel can be various sizes and various locations within the spreadsheet as exampled in U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021. To focus on the joining features and functionality we have used a single side bar as the input panel recognizing the reader can translate that into input panels combining ribbons, popups, on chart inputs, and other UIs with mix and match combination. We have also exampled the chart output in a spreadsheet tab recognizing it could easily be in spreadsheet worksheet cells, spreadsheet chart tabs, spreadsheet slides, spreadsheet decks and spreadsheet dashboards. The reader will also understand how features identified in each section can readily be combined with features in the other sections.

### Join Qualification

Our visualizer data set joining technology works in two very different ways as well as hybrids of the two. One way is the joinable data is qualified for use before the user starts the setup of their visualizer chart. In that mode the user simply has the joinable data there and available for their use. Something of great value for many of the typical spreadsheet users who has no idea how to join data sets and are not interested in trying to learn it. At the other end of the spectrum, you have the small but important set of sophisticated users who want the flexibility that SQL like joins give and do not need the guard rails frequently applied to spreadsheet joins (e.g., not allowing many to many data modelling cardinality). Variants of our hybrid approach combines the two approaches and gives the unsophisticated user the more limited joinable data requiring no work on their part and gives the sophisticated user the ability to go beyond that to all the joins that they want. We will now briefly example the different approaches and some of the many variants within those approaches.

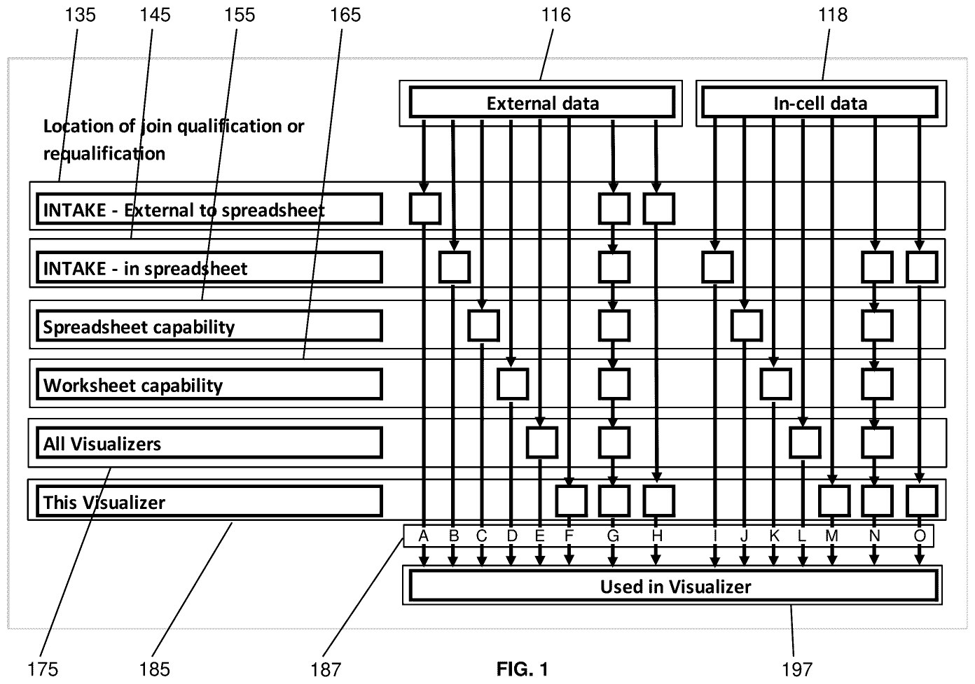

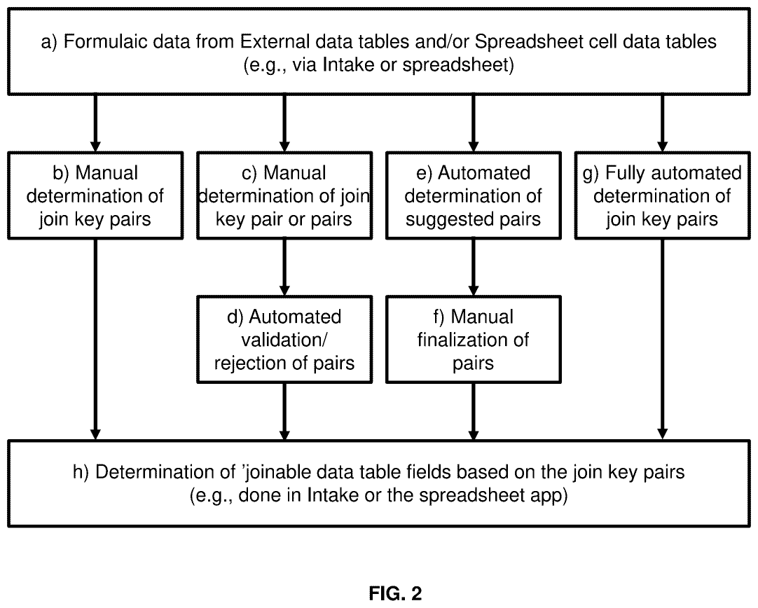

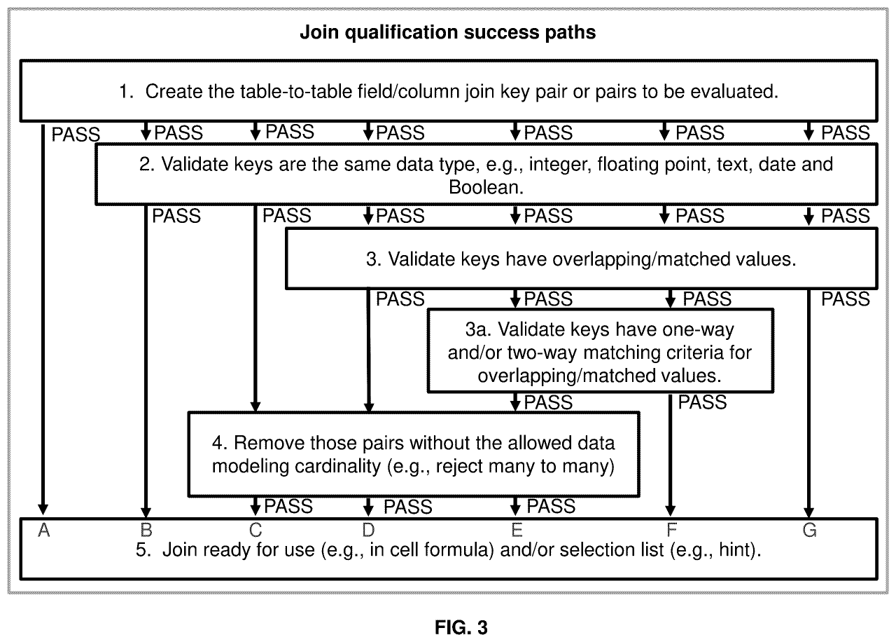

A join prequalified before the user starts their inputs into the visualizer chart being created (i.e., ‘This Visualizer’ 185 chart), can be done in many different locations (135, 145, 155, 165, and 175) or combination of locations (as exampled in scenarios ‘G’, ‘H’, ‘N’ and ‘O’ 187) before ‘Used in Visualizer’ 197 in our technology as exampled in FIG. 1. These qualifications can be done in many different manual and/or automated ways as exampled in FIG. 2. Our data joining technology supports a broad range of data set joining qualification (validation), from no validation (exampled in FIG. 3 path ‘A’) to extensive join key pair validation (exampled in FIG. 3 path ‘E’). Embodiments of our disclosed technology support the same or different qualification (e.g., path in FIG. 3) used for joins setup in different locations (e.g., an embodiment where joins set up in ‘This Visualizer’ 185 FIG. 1 chart input allow all data modelling cardinalities while joins set up before ‘this Visualizer’, e.g., 135, 145, 155, 165, and 175 FIG. 1, only accept unique to unique and unique to non-unique but not non-unique to non-unique).

Our technology supports these different combinations to potentially protect less sophisticated users from creating complicated joins that they are unlikely to understand, e.g., non-unique (“many”) to non-unique (“many”) joins and compound key joins, while still giving the sophisticated user the full set of join capabilities. Our technology also supports different levels of validation, including tests that can be helpful to everyone eliminating joins that will generate a null set (e.g., not passing ‘2’ and ‘3’ in FIG. 3) and tests that are more situationally valuable (e.g., ‘3a’ or ‘4’ in FIG. 3) but not always definitively correct. Many embodiments of our technology also stops or alerts users who have mistakenly specified joins that do not work (e.g., inconsistent data types or no shared key values) before they try to generate the visualizer chart.

We will start exampling embodiments employing extensive join key qualification validation tests for both the selection list availability and the visualizer chart use.

### Extensive Join Qualification Validation Tests

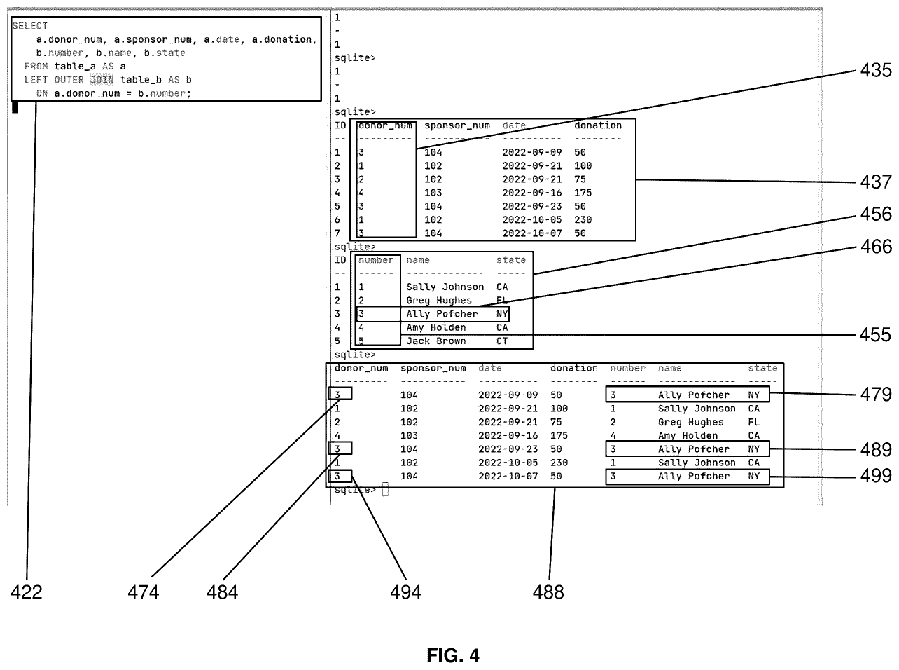

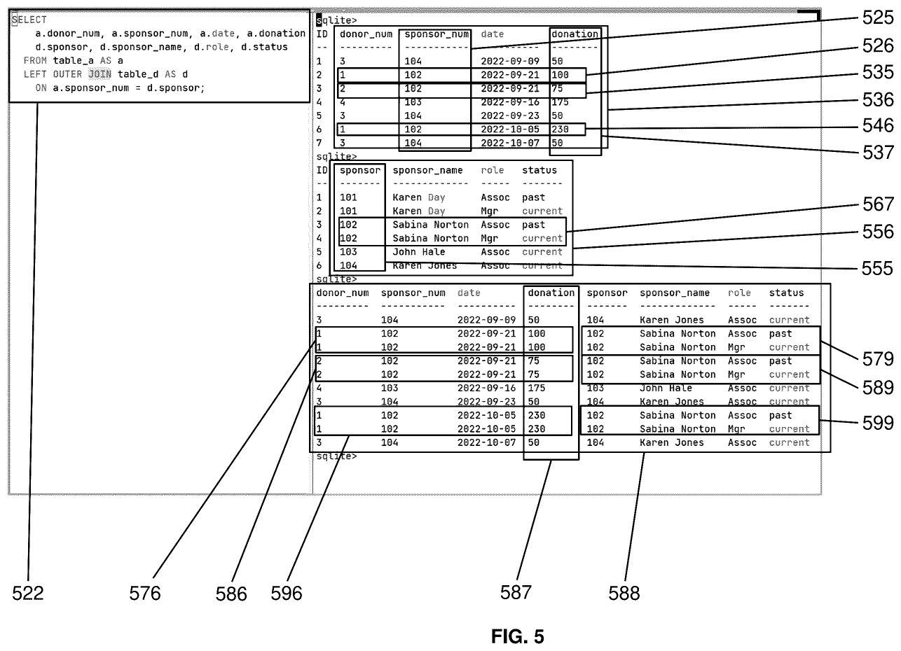

We will example path ‘E’ in FIG. 3 for a charity user who has two data sets they need joined to create the chart they desire. One data set holds the donor donations (e.g., a donor identification number, donation amount, and donation date) and the second data set holds information on each donor (e.g., their donor identification number, name, and state of residence). The charity user wants to create a chart using data from both data sets and therefore wants to effectively join the data in doing the chart. However, depending upon their sophistication it may be desirable to protect users from some more complicated joins which result in changes to the data they may not realize and understand. Our technology's join qualification capabilities can do that. FIG. 4 and FIG. 5 example two data joins done in SQL, one with an easily understandable outcome in FIG. 4 and one with a more complicated outcome (limited Cartesian Product) in FIG. 5 that a user not experienced in SQL data joins is likely to not anticipate or understand. This is particularly true when the join is done in a creating a chart where they don't see the joining of the data but instead see only a chart using that joined data. Therefore, in this extensive validation test embodiment example our technology will only use those joins that pass all the qualification validation tests in FIG. 3 path ‘E’. In process it will eliminate joins that SQL supports (e.g., joins failing the one-way or two-way matches of step ‘3a’ if both criteria are a set at requiring a 50% row value match to the other key or the many to many joins that fail step ‘4’ when the allowed data modelling cardinalities are accepting only unique to unique and unique to non-unique).

FIG. 4 examples a data join that many people would call a lookup. Where the join is looking up the ‘name’ and ‘state’ (of residence) from the ‘table_b’ 456 for each row in the ‘table_a’ 437 using the join key ‘donor_num’ 435 in the ‘table_a’ 437 and the join key ‘number’ 455 in the ‘table_b’ 456. The SQL code 422 does that using a ‘LEFT OUTER JOIN’ delivering the joined table 488. That outcome appends the ‘number’, ‘name’ and ‘state’ from ‘table_b’ 456 to each row of ‘table_a’ 437. It has successfully created a table from which a user can specify donations (joined field ‘donation’) by donor name (field ‘name’) from the joined table 488 as exampled by the appending of the ‘Ally Pofcher’ information 466 to the three rows in the joined data 479/489/499 which share the ‘donor_num’ value of ‘3’ 474/484/494. This joined data 488 would allow users to do calculations to sum the donations by each person's name, find the name of the person with largest donation, sum donations by state of donor residence and more, as we will example later. However, in our spreadsheet cell technology the joining of the data is not visible like in this SQL example but happens within the visualizer to deliver the visualizer chart outcome. It therefore lacks the transparency on what the joined data looks like which becomes important in FIG. 5 when what the join delivers is not a unique to unique or unique to non-unique join but instead is non-unique to non-unique (‘many to many”) limited Cartesian Product join outcome (what we call the duplication of non-unique cardinality data set rows). This outcome requires the user to be much more knowledgeable in how they write their formulas to avoid outcomes that are misleading (some would say incorrect). A level of SQL sophistication that many spreadsheet users lack because they do not know SQL and therefore do not how the different SQL joins work (e.g., left outer, right outer, inner, full outer, cross, and self), let alone more complicated Cartesian Product situations.

FIG. 5 examples a limited Cartesian Product data join that for the non-knowledgeable SQL users would have a totally unexpected outcome. That is because they would not realize that the data they want appended, the ‘sponsor_name’ is not unique and therefore rather than being appended is added via a limited Cartesian Product. That limited Cartesian Product then results in the duplication of some of the ‘table_a’ 536 rows, e.g., 526/535/546 which are duplicated 576/586/596 in the join table 588. This is caused by the non-unique join keys ‘sponsor_num’ 525 and ‘sponsor’ 555 where, because both are non-unique, rather than appending values they are combined in a limited Cartesian Product. This gives a situation where if a user is not careful using the joined data they can arrive at some wrong answers. For example, if the user sums ‘donation’ 587 in the joined data 588 they get ‘1135’ instead of the actual total of ‘donation’ 537 in the original data 536 of ‘750’. This is driven by the duplication of the ‘sponsor_num’ ’102’ 567 rows in the joined data 579/589/599 duplicating the rows 576/586/596 relative to those rows 526/535/546 in the original data 536. Thus, making use of the non-unique to non-unique joined data (“many to many”) can potentially give erroneous results (e.g., donations of ‘1135’ 587 instead of the actual donations of ‘750’ 537). However, for someone sophisticated who really understands the join they can get the correct result by filtering out the duplicated rows, in this example by limiting (filtering) the donations to only those for ‘status’ ‘current’. Something a user without in-depth knowledge of the data and the joins is unlikely to realize.

So, our technology allows many paths of qualification validation tests (as exampled in FIG. 3) and degrees of validation which can be used for the joinable data selection list selectors and error free chart usage. It supports using the same or different qualification validation for the joinable data selector lists and the error free charts as we will example. Embodiments of our technology also support many different ways for that qualification validation process to take place as will also be exampled.

### Data Join Qualification Steps/Tests

Our disclosed technology supports many different combinations of qualification tests (see FIG. 3) for validating which data joins are doable without an error message and which are presentable in selectable list for use in a spreadsheet visualizer chart. It also supports many different acceptable test criteria for the steps ‘3a’ and’4’ in FIG. 3. Those outcomes can be situational in our technology, working in some situations and not working in others. For example, a combination of joins (chained/sequenced) may make two individual one to many joins an invalid non-unique to non-unique (“many to many”) join when they are chained/sequenced together and face a data modelling cardinality test rejecting non-unique to non-unique joins.

FIG. 2 examples different ways of qualifying the potential for joinability in our visualizer. A spectrum of those ways are exampled in FIG. 2 ranging from a completely manual set up to a fully automated set up and verification. FIG. 2 examples a range of the ways the qualification is done with FIG. 3 exampling types of qualification tests and FIG. 1, to be discussed further later, exampling the different locations of the qualification (e.g., from data intake to within the visualizer).

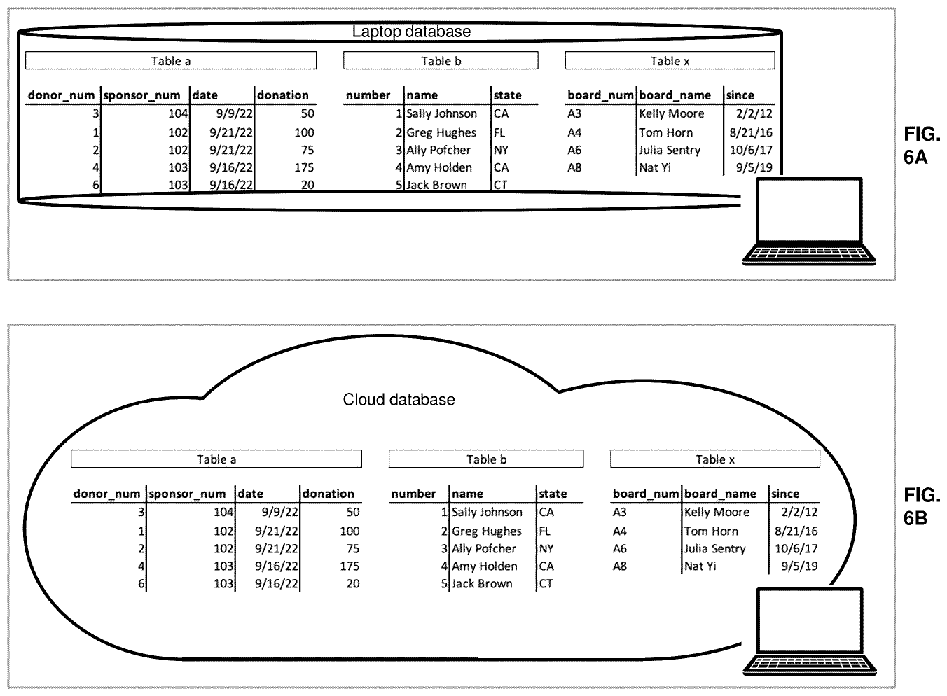

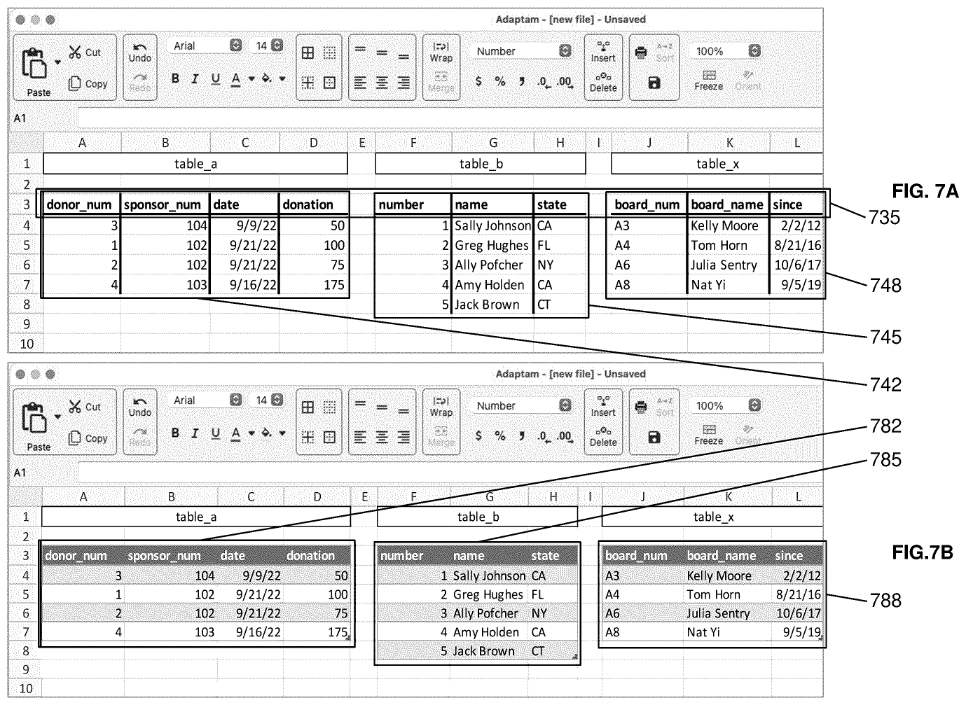

FIG. 2 starts with step ‘a’ accessing the data which can reside in spreadsheet cells (in-cell as exampled in FIG. 7A and FIG. 7B) or can reside in non-spreadsheet cells (NSC) external data sources (e.g., databases on the same computer as the application or elsewhere in servers or other accessible storage devices as exampled in FIG. 6A and FIG. 6B respectively). This can be done by an Intake capability (as described in U.S. application Ser. No. 17/752,814 titled “Method And System for Spreadsheet Error Identification and Avoidance,”) within the spreadsheet application or separate from it. Path ‘a/b/h’ is the most manual method relying entirely on a user (e.g., Intake) user to set up and make correct joins. At the other end of the spectrum is path ‘a/g/h’ which is a fully automated determination by our application (i.e., Intake or the spreadsheet) of valid joins applying many or all of the qualification validation tests in FIG. 3.

FIG. 2 path ‘a/c/d/h’ is a combination of human join key pair specification and our application verification of the validity of those selections. The user selects one or more data set to data set join key pairs in step ‘c’ and then in step ‘d’ our technology automatically tests the validity of each of those pairs using any of the validation paths ‘B’ through ‘G’ in FIG. 3 passing the validated joins to step ‘g’ which then returns the joinable date fields passing all the tests. Note, in situations with multiple competing joins (versus the legitimate double/multiple joins we will discuss later) our automation would include a mode of selecting the best amongst the competing joins.

FIG. 2 path ‘a/e/f/h’ is a different combination of the user (human) and our technology automated specification/validation. In step ‘e’ our technology creates all the across data set field/column join key combinations and then automatically tests the validity of each of those pairs using any of the validation paths in FIG. 3 passing the validated joins to step ‘f where the user decides which should be used to create the joinable list in step ‘h’. The user therefore has the final decision on whether a join is or is not added to joinable list. That joinable list sets a join qualification flag in our technology that then is used to enable visibility of the joinable fields in our selection lists (e.g., hints) and/or enable the visualizer to join the data sets and use the joined data in executing the visualizer chart.

As mentioned previously, our technology has the ability to have different join qualification flag validation criteria for the selection lists and the formula error creation. As well as our technology can support different join qualification flag validation criteria for the selection lists based on changes in the qualification done in different locations within our technology. This will be exampled in detail later, for a situation where at Intake qualification selection list qualification flags supported data modelling cardinalities of unique to unique and unique to non-unique only while the error free joinability for the in visualizer specified join accepts all data modelling cardinalities. So, the user will see in selection lists the joinable data sets that are qualified with unique to unique and unique to non-unique (or non-unique to unique) joins but can manually populate joins and fields that are non-unique to non-unique in the visualizer joins specifier in the visualizer input panel and have them execute successfully. Our technology even has a capability that after the manual creation of that non-unique to non-unique join it can change the selection list flag so those joinable fields will become visible in the selection lists for that visualizer. Thus, our technology gives a breadth of flexibility in setting the qualification of joinable fields within the application.

FIG. 2 path ‘a/g/h’ is the most automated path where our Intake or spreadsheet application automatically creates all the across data set field/column join key combinations and then automatically tests the validity of each of those pairs using any of the validation paths in FIG. 3 passing the validated joins to step ‘h’ where all the validated join key joins are turned into joinable fields for use in the visualizer and joinable data selection lists (e.g., hints). Note, in situations with multiple competing joins (versus the legitimate double/multiple joins we will discuss later) our automation would include an automatic capability of selecting the best amongst the competing joins. This fully automated join qualification flag setting can be done within our spreadsheet application or prior to it in a data intake application.

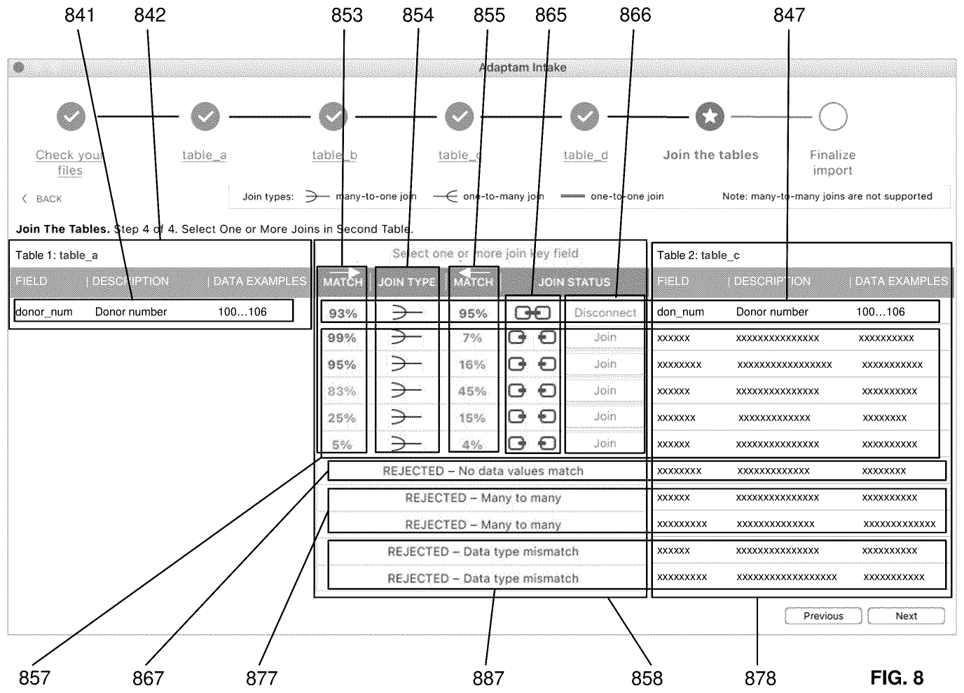

There are additional mix and match combinations of manual and automated join qualification such as that exampled in FIG. 8 where the user specifies the first data set and its join key and the second data set. Our technology then automatically screens all the fields in the second data set against the join validation criteria, in this example path ‘D’ in FIG. 3 with a data cardinality criteria of accepting only unique to unique and unique to non-unique (or vice a versa). Therefore, our technology rejects all the fields/columns that result in a many to many cardinality 877. It also rejects fields that result in a ‘Data type mismatch’ 887 and fields/columns with no value matches 867. The rest are presented with matching 853/855 and join cardinality type information 854 for the user to make the final decision on what field/column becomes the key (in this example ‘don_num’ 847). They are also presented additional field information like the ‘DESCRIPTION’ and ‘DATA EXAMPLES’ 878 for each field/column. Thereby exampling a manual then automated then manual way of arriving at the join keys that eliminates non applicable join key options and gives the user relevant information to make the final decision, or decisions in the situation of multiple joins (discussed later). Rather than continuing to discuss further options, for brevity's sake we will move on to exampling some of the UIs employed in the process.

### Example qualification Intake UIs

FIG. 8 also examples one join qualification UI which is shown here as an external or within the spreadsheet Intake tool. However, its elements can be utilized in other situations (e.g., spreadsheet or worksheet join set up) and with different qualification validation tests. In this example the user has specified a data set ‘table_a’ 842 and join key field/column ‘donor_num’ and the second join key data set ‘table_c’ 878 and our application populates all the additional information. This examples is a UI for FIG. 3 path ‘D’ validating every field (FIG. 3 step ‘1.’) in data set ‘table_c’ 878 relative to the field ‘donor_num’ 841 in ‘table_a’ 842, Fields/columns in ‘table_c’ are rejected based on data type mismatches 887 (FIG. 3 step ‘2.’). Fields/columns in ‘table_c’ are rejected based on no overlapping/match values 867 (FIG. 3 step ‘3.’). Fields/columns in ‘table_c’ are rejected based on a data modelling cardinality rule 877 (FIG. 3 step ‘4.’) which in this example is rejecting many to many. Finally, users are given color coded one-way 853 and two-way 855 match values as there is no FIG. 3 step ‘3a.’ rejection criteria. Users are also automatically given helpful information such as the field/column data descriptions and data examples 841 and 847 and the data modelling cardinality of the potential join 854. The UI also makes it easy for users to make a selection with join/disconnect buttons 866 and easy to see status icons 865. We provide to users the information they need to make a join decision and/or to understand an automated decision or suggestion.

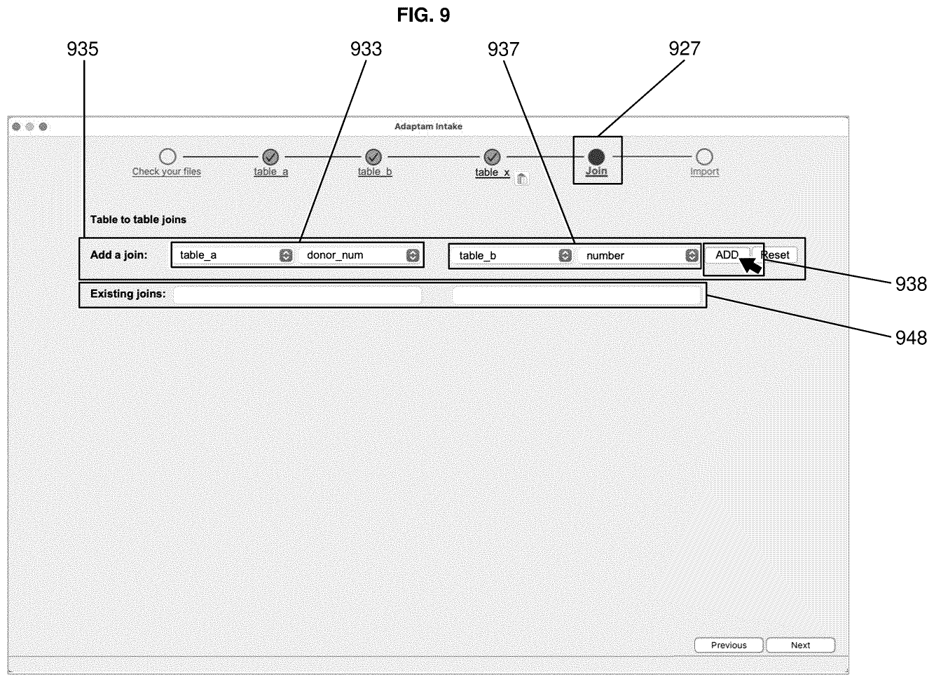

FIG. 9 examples a different join setup UI where the user specifies the pair of data sets and join keys 933/937 in the ‘Add a join’ line 935 which in this embodiment has ‘ADD’ 938 or ‘Reset’ (reject) buttons for the user to confirm their selection. In FIG. 2 path ‘a/b/h’ when the user hits ‘ADD’ 938 the join is simply added to the ‘Existing joins’ 948 with no other qualification validation tests. These ‘Existing joins’ 948 then have a qualification flag (which can be done in many different ways) telling the spreadsheet that these data sets are joinable to each other for selection list availability and/or error free formula evaluation. The qualification flag is a method for communicating joinability to the spreadsheet formulas and can be done many ways such as an internal table used by our technology to determine which data sets are joinable.

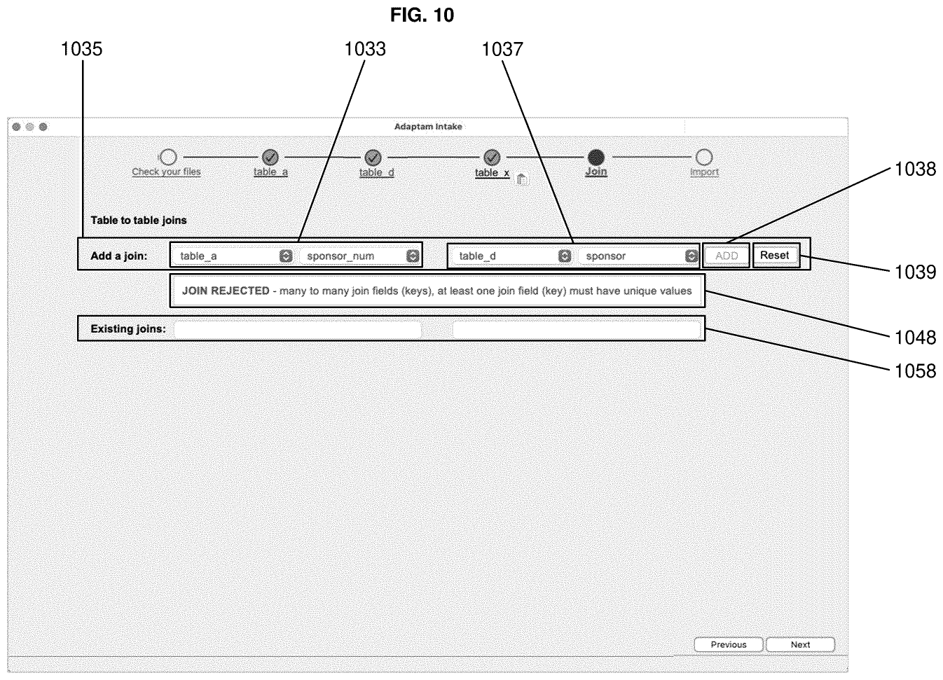

In the FIG. 1 path ‘a/c/d/h’ the difference is our technology then validates the join before accepting it and if it fails gives the user an error message and/or failure explanation and does not move it to ‘Existing joins’ 948 as is exampled in FIG. 10. FIG. 10 examples our technology rejecting this join because the in this example the key relationship is unacceptable in this embodiment—because it is not a “unique” to “unique” key join or a “unique” to “non-unique” (or vice a versa) key join. Instead, being a “non-unique” to “non-unique” (many to many) key join it is rejected in this embodiment to protect the unsophisticated users inadvertently using it without understanding how it changes the joined data (e.g., partial Cartesian Product). This embodiment shows the user a ‘JOIN REJECTED’ message 1048 and gives the user the option to alter one or both of the tables and join keys 1033/1037 or ‘Reset’ 1039 the ‘Add Join:’ 1035. The ‘ADD’ 1038 join button is disabled and the join was not added to the ‘Existing joins:’ 1058. It has exampled a UI for the FIG. 1 pathway ‘a/c/d/h not passing a potential join. The validation checks used for the rejection could be any of FIG. 3 paths ‘C’, ‘D’, or ‘E’, as this example fails on the many to many data modelling cardinality test in step ‘4’. As we will later example this rejection of the join may be for the selection list but not a manually specified in-visualizer join or it could be for both the selection list and the in-visualizer manual join. Note, the example in FIG. 9 is for a ‘Join’ step 927 in an ‘Adaptam Intake’ tool that is in the spreadsheet or a tool before the spreadsheet. However, the UI elements 935/948 could be used elsewhere (e.g., FIGS. 1 155, 165, 175, and 185) in the spreadsheet for setting up joins.

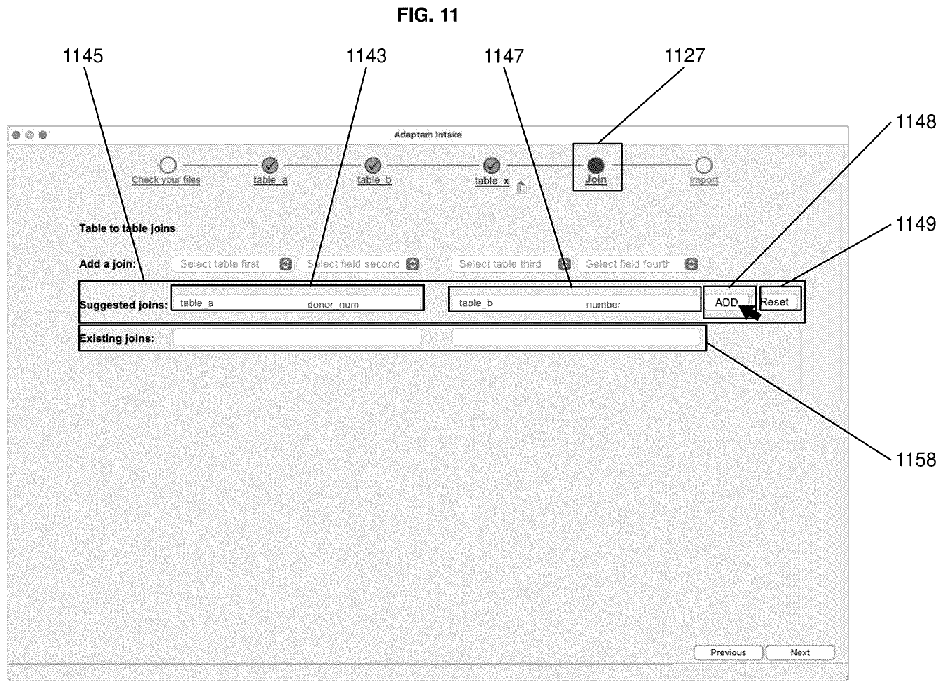

FIG. 11 examples a UI where the pair of data sets and join keys 1143/1147 are presented as ‘Suggested joins’ 1145 giving the user the final say as to whether to ‘ADD’ 1148 or ‘Reset’ (reject) 1149 that suggest join (exampling FIG. 2 path ‘a/e/f/h’). Thus, after the automated join qualification/validation tests giving the user the final say as to whether the join gets a qualified join flag supporting its usage in selectable lists and/or visualizer charts (i.e., moved to the ‘Existing joins’ 1158). Note, the example in FIG. 11 is for a ‘Join’ step 1127 in an ‘Adaptam Intake’ tool that is in the spreadsheet or a tool before the spreadsheet. However, the UI elements 1145/1158 could be used elsewhere (e.g., FIGS. 1 155, 165, 175, and 185) in the spreadsheet for setting up joins.

While we could example more potential UIs that could be used by to set up joins in the data intake from external or in-cell data sets, we will move to exampling UIs used elsewhere in our spreadsheet application. It is also worth noting that elements of these UIs could be utilized in those other locations.

### Other Example Qualification UIs

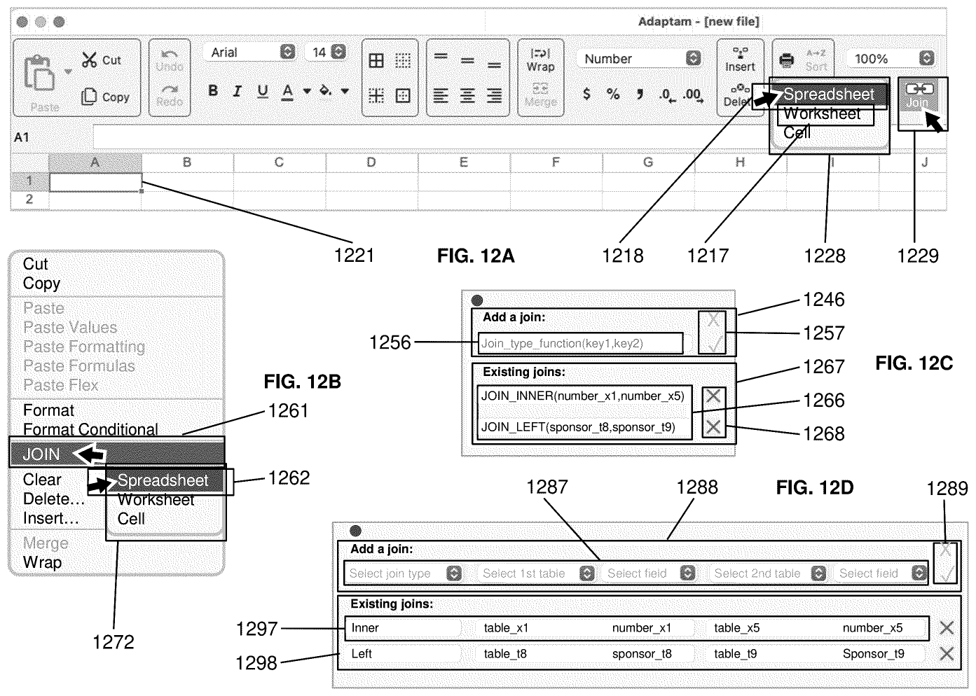

FIG. 12A through FIG. 12D example two of many different modes of accessing join setup and setting up joins for a spreadsheet. Note, this is within a spreadsheet app which has a join capability for spreadsheet formulas as per U.S. Provisional Patent Application No. 63/525,138, which is incorporated by reference above. The spreadsheet wide setup of joins would apply to all the visualizers within the spreadsheet while any worksheet or cell specific joins would not. FIG. 12A examples accessing join setup through a spreadsheet ribbon button 1229 which when clicked in this embodiment opens a selection popup 1218 where the user can specify the applicability location of the join or joins. In this example the user has selected ‘Spreadsheet’ 1218 which applies to all the visualizers since it is doing everything in the spreadsheet. However, had the user selected the ‘Worksheet’ 1217 option (e.g., ‘Worksheet capability’ 165 in FIG. 1), then any of the selections set up in FIG. 12C or FIG. 12D would apply to all the visualizers within that worksheet but not visualizers in other tabs. Once the selection is made our technology opens a UI to specify the join like either FIG. 12C or FIG. 12D. FIG. 12B examples another way to accesses the join setup through a spreadsheet menu with the ‘Join’ option 1261 which when clicked in this embodiment opens a selection popup 1272 where the user can specify the applicability location of the join or joins. In this example the user has selected ‘Spreadsheet’ 1262. Once the selection is made our technology opens a UI to specify the join like either FIG. 12C or FIG. 12D. The menu could have been a right click menu in a cell, one from the application overall menu, or another spreadsheet menu. FIG. 12C examples a fairly manual UI setup approach where the user effectively constructs a join type function formula with arguments of ‘key1,key2’ like they might in a regular formula following the input syntax in the entry box 1256. Once they have made an input the disabled ‘check’ and ‘X’ 1257 become live for the user to ‘Add a join:’ 1246 to the ‘Existing joins:’ 1267. In this example to add to the two joins 1266 already there. If the user wants to get rid of one of those existing joins, they simply click its corresponding ‘X’ (e.g., 1268). These joins could have any path of qualification validation testing exampled in FIG. 3. FIG. 12D examples a somewhat less manual join UI with dropdown selection lists to help in the ‘Add a join:’ 1288 setup. Each input 1287 tells the user what to select and the screening of the values in the second table ‘Select field’ could have any qualification validation testing exampled in FIG. 3. Once the user has completed an input the disabled ‘check; and ‘X’ 1289 become live for the user to ‘Add a join:’ 1288 to the ‘Existing joins:’ 1298. If the user wants to get rid of one of the existing joins 1297, they simply click its corresponding ‘X’. For brevity purposes we did not example the spectrum of qualification validation test results for these UIs recognizing they can display capabilities across the spectrum including more informative information such as that displayed in FIG. 8. These UIs (FIG. 12C or FIG. 12D) could also be used within the visualizer for setting up joins (e.g., ‘All Visualizers’ 175 or ‘This Visualizer’ 185 in FIG. 1).

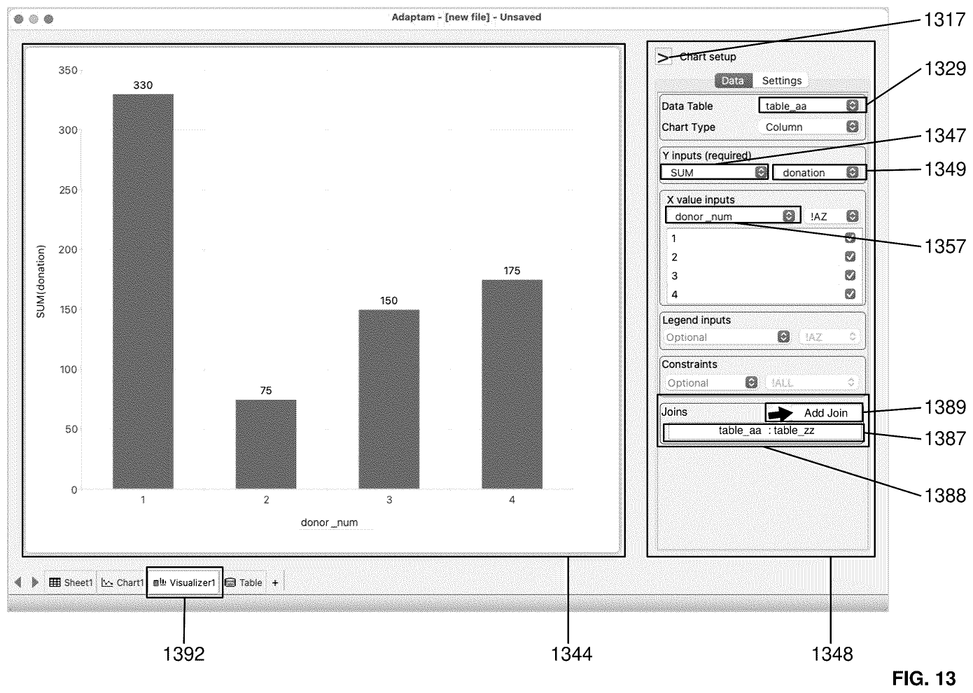

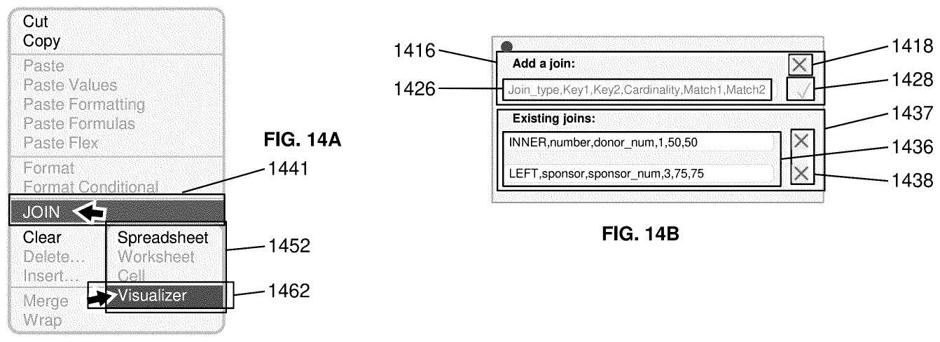

FIG. 13 examples a spreadsheet visualizer tab 1392 displaying a bar chart for the “SUM’ 1347 of ‘donation’ 1349 by ‘donor_num’ 1357. The user wanted to see the total donations per each donor (in this example their donor identification number). This data all resides in the data set ‘table_aa’ 1329 which in this example has another data set ‘table_zz’ joined to it as shown in ‘table_aa:table_zz’ 1387. All these inputs were done in the visualizer input panel which in this example is the sidebar 1348. The join was setup in the join specifier 1388 which resides within the join input panel 1348 in this embodiment. The input panel 1348 can be made to disappear to maximize the chart 1344 in this embodiment by clicking the arrow ‘>’ 1317. In this embodiment the user can add an additional join by clicking the ‘Add Join’ button 1389. That would take them to the popup UI exampled in FIG. 14B, which is one of the many different ways our spreadsheet users can add a join from the visualizer. They equally could have accessed that UI in FIG. 14A through a menu by clicking the ‘Join’ option 1441 and then clicking ‘Visualizer’ option 1462. This menu examples being accessed from the visualizer tab with its very limited applicable options which does include setting a join option ‘Spreadsheet’ in 1452 which works for the visualizer and the rest of the spreadsheet (e.g., all worksheets, all visualizers within worksheets, and all visualizer tabs).

FIG. 14B examples a fairly manual UI setup approach where the user effectively constructs the arguments specifying the join 1426. The first argument ‘Join type’ is where the user specifies the type of join they want employed, e.g., inner, and full outer with the appropriate abbreviation for the argument. The next two arguments of ‘Key1,Key2’ in this example define both the data set and the join key field, as the fields/columns have unique names that therefore identify the data set. Had that not been the situation, then the arguments would have had some table identifier. After that comes a data modelling cardinality input where in this example the user inputs a number identifying the accepted cardinality or cardinalities. For example, ‘1’ would be accepting one to one (a very limiting situation). The ‘2’ would be accepting unique to unique cardinalities, which would of course include accepting one to one. The ‘3’ would be accepting unique to unique and unique to non-unique (and vice a versa, which is true implicitly when mentioning one herein) cardinalities. The ‘4’ would be accepting unique to unique, unique to non-unique and non-unique to non-unique cardinalities. Thus, with the four options, giving the user many different cardinality options. The next two arguments of ‘Match1,Match2’ in this example set the minimum match percentages of the values in the two join keys found in the other join key. Those could be weighted in different way, e.g., by rows of the keys or by distinct values. Note, these match arguments could be optional criteria where the default is ensuring at least one matching values between the keys. With these criteria our spreadsheet application will then validate an input then asking the user to finalize the selection by enabling the check 1428 to become live for the user to ‘Add a join:’ 1416 to the ‘Existing joins:’ 1437. In this example to add to the two joins 1436 already there. If the join fails the qualification tests the ‘X’ 1418 goes live to allow the user to remove the input and start again (alternatively they can edit the inputs until they get a check). If the user wants to get rid of one of the existing joins 1436, they simply click its corresponding ‘X’ (e.g., 1438). These joins could have any ‘B’ through ‘G’ path of qualification validation testing exampled in FIG. 3 with more or less qualification test inputs. The information given back to the user could be less like this of pass fail or more like that shown in FIGS. 8 (887, 877, 867, 853, 855, and 854). While we could example many more UI variants with different information and qualification tests and screening, we will instead describe the potential interactions of the different join qualification locations.

### Join Qualification Locations

FIG. 1 examples some of the endpoints of the spectrums and some of the more midpoints of join setup and resetting supported by our visualizer chart data set joining technology. We example six different locations where a user, using one of the UIs exampled herein, can setup data set join(s).

The first location exampled is the ‘INTAKE—external to spreadsheet’ 135 in FIG. 1 which has the advantage of setting up joins for any user using that external data and any tab within their spreadsheets, thus setting up joins for many users and use situations at one time. It can use many different types of UIs including the ones exampled in FIG. 8, FIG. 9, FIG. 10, and FIG. 11. The next location exampled is the ‘INTAKE—in spreadsheet’ 145 which works similarly to the external intake but is within a single spreadsheet frequently used to setup data from in-cells as described in our U.S. application Ser. No. 17/752,814 titled “Method And System for Spreadsheet Error Identification and Avoidance,”. It allows a user to do a one-time setup for all the tabs within a spreadsheet using many different types of UIs including the ones exampled in FIG. 8, FIG. 9, FIG. 10, and FIG. 11. Embodiments could then alter qualifications done by the previous location 135 in FIG. 1 for either selection lists and/or visualizer charts. The next location example is the ‘Spreadsheet capability’ 155 which can be as simple as our technology allowing any join setup in any tab within the spreadsheet to apply to all the tabs in the spreadsheet. It could have many UI configurations including those exampled in FIG. 12C and FIG. 12D, where a user can specify joins (e.g., join type and join keys) for all tabs (e.g., worksheet tabs, chart tabs, and visualizer tabs) within the spreadsheet. It could also have more extensive inputs and auto generated information or qualification screening as exampled in the other join input UIs exampled herein (e.g. FIG. 8, FIG. 9, FIG. 10, and FIG. 11). Embodiments could then alter qualifications done by the previous locations for either selection lists and/or visualizer charts.

The next location example is the ‘Worksheet’ 165 where our technology allows any join setup in any argument within any cell within the worksheet for purposes of joining visualizers as per U.S. Provisional Patent Application No. 63/525,138, which is incorporated by reference above, to propagate to all the visualizers within the worksheet. It also propagates any qualified joins set within a visualizer in the worksheet to any other visualizer or visualizer within the worksheet tab. The next location example is ‘All Visualizers’ 175, where a join qualified in any other visualizer (e.g. visualizer tab or visualizer within a worksheet tab) can propagate to all the visualizers setting the visualizer join flag supporting selection lists and/or visualizer chart usage. Finally, the last location exampled in FIG. 1 is ‘This Visualizer’ 185 where the user is creating the join within the visualizer input (e.g. visualizer tab or visualizer within a worksheet tab), such as in FIG. 13. All these locations (135, 145, 155, 165, 175, and 185 in FIG. 1) can be supported by the different join qualification flag setting tests exampled in FIG. 3 via the range of ways to decide the join qualification exampled in FIG. 2 and further mix and match combinations of those ways (e.g., FIG. 2 path ‘a/c/d/h’ altered to be ‘a/c/d/f/h’ as is exampled in FIG. 8). Each one can make use of the applicable join setup UIs exampled herein and UIs resulting in the same inputs.

Embodiments support altering qualifications done by the previous locations for either selection lists and/or formulas. The previously described join setup locations are exampled as singular locations of joins in the pathways’ ‘A’ through ‘F’ and ‘I’ through ‘M’ in FIG. 1 187. There are advantages and disadvantages to setting joins in any one of the locations (135, 145, 155, 165, 175, and 185) so our technology also allows resetting of joins at most locations as exampled in the pathways’ ‘G’ and ‘N’. Those two pathways example the extreme situation with our technology supporting resetting of the joins at each of the subsequent locations. Our join technology supports any of the applicable mix and match combinations of locations as exampled in ‘H’ and ‘O’. Pathways ‘H’ and ‘O’ 187 example two such pathways where a previously setup join is revised within the visualizer. For brevity we did not diagram out all the different combinations of the locations resetting the join setup of a previous location and we also did not diagram out joining data across external and in-cell data sets (which is supported as has been described herein). Instead of continuing to example more locations, rests, and validation tests for qualifying a join flag, we will move on to example its use in our spreadsheet chart.

Creating a Visualizer Chart Employing a Join with Two Unique Join Keys

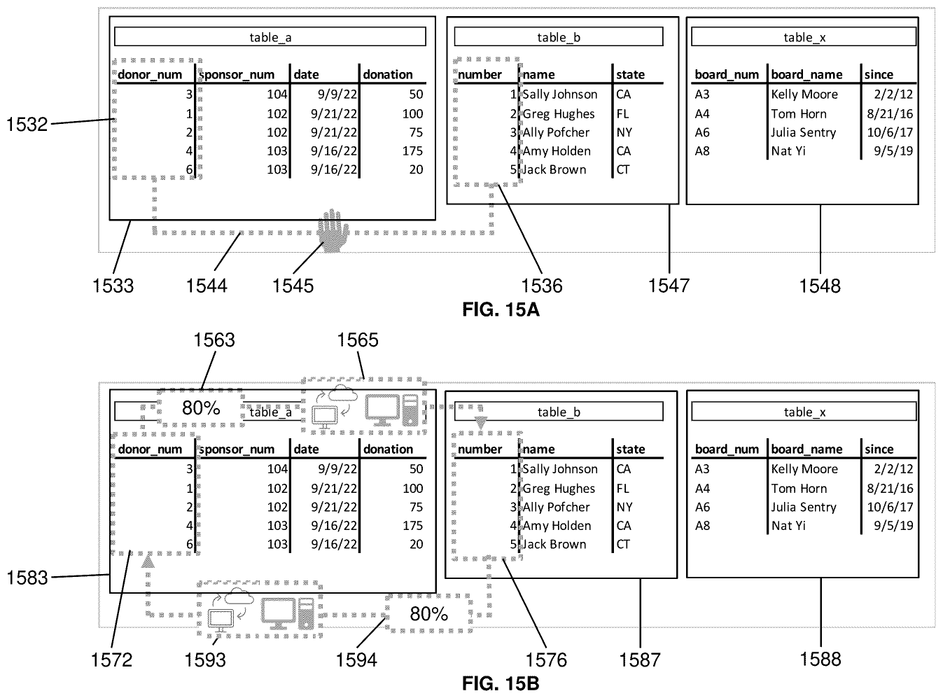

We will start exampling the spreadsheet visualizer use of one of the simplest data set joining situations, two data sets joined via unique join keys. FIG. 15A examples a spreadsheet with availability to three small data sets 1533, 1547, and 1548. Those data sets could be non-spreadsheet cell (NSC) external data sets residing in a database on the device (e.g., laptop) running the spreadsheet application as exampled in FIG. 6A. Or they could in a database somewhere in the cloud which the device running the spreadsheet application can access, as exampled in FIG. 6B. Alternatively, those data sets could be in the spreadsheet cells as cell data, as exampled in FIG. 7A 742/745/748 (note while this example the data has headings 735 used as the field/column names although the data could be without those headings instead using the cell ranges as the field/column names) or as data sets within spreadsheet cell tables, as exampled in FIG. 7B 782/785/788. They could also be combinations of in-cell data sets and data sets sourced from NSC external data sources. Any of our following examples could have data from the different data sources.

FIG. 15A illustratively examples a user specifying the data sets which are joinable and their join keys. In this example the two data sets ‘table_a’ 1533 and ‘table_b’ 1547 are joinable. Each of those data sets has column headings which will become the field/column names (e.g., donor_num) for the values below (e.g., ‘3’,‘1’,‘2’,‘4’,‘6’ for donor_num). In this example the user has manually 1545 specified that ‘donor_num’ 1532 and ‘number’ 1536 are the join keys 1544 used for joining the data sets. This manual determination of the joinable data set pairs examples FIG. 2 path ‘a/b/h’. It could also FIG. 2 path ‘a/c/d/h’ where the user makes one or more manual determination of join keys and then our technology does an automated qualification validation (any of the paths ‘B’ through ‘G’ in FIG. 3) of the paired data sets and their join keys.

FIG. 15B illustratively examples our technology automatically (algorithmically) determining the join keys and therefore the joinable data sets. In one such embodiment the first step is to determine all the fields/columns across three data sets 1583/1587/1588 which are the same data types. Next is testing the overlap of the values with could start with a simple test of is there any overlap of values between the two keys 1572/1576. Having passed that test the next test could be achieving a minimum percentage of value overlap, such as the calculation that ‘80%’ 1563 of the values in ‘donor_num’ 1572 are contained in ‘number’ 1576. And the reciprocal calculation that that ‘80%’ 1594 of the values in ‘number’ 1576 are contained in ‘donor_num’ 1572. High percentages one-way is a pretty good sign and high percentages both ways is an even better sign. These value determinations could be done at the row level within the data set or at the distinct values contained within those rows. The fields/columns that pass those criteria are then tested for data modelling cardinality, such as passing “unique” to “unique” or “unique” to “non-unique” and eliminating any “non-unique” to “non-unique” (many to many) pairs. Additional tests may be added in embodiments, e.g., weighing in fields that have the same or similar field/column names/headings, deciding multiple keys that could be used to join two data sets, and deciding which pair of keys to use (e.g., the pair that results in the most rows appended) when more than one pass all the tests. After doing these tests for the three data sets 1583/1587/1588 no join was found between ‘table x’ 1588 and either of the other data sets. The join between ‘table_a’ 1583 and ‘table_b’ 1587 was accomplished through the keys ‘donor_num’ 1572 and ‘number’ 1576. Therefore, in the fully automated pathway 1565/1593 in FIG. 8 steps ‘a/g/h’ all the fields in ‘table_a’ 1583 and ‘table b’ 1587 would be added to the joinable list for the other data set. Likewise in the semi-automated path, that potential join would be qualified by FIG. 2 step ‘e’ (employing tests in FIG. 3) and presented to the user for step ‘f’ in a UI, such as the one exampled in FIG. 11.

Note, for brevity's sake we have not attempted to example all the different combinations of manual and automated join qualification flag setting discussed herein for the three data sets in FIG. 15A and FIG. 15B. However, our technology supports those for the purposes of these and the other join examples presented herein.

The user is now ready to use our technology to create a spreadsheet visualizer chart and, in this embodiment, do it with curated selectable lists which present the joinable field options when they are applicable.

### Unique to Unique Joined Data Visualizer Chart

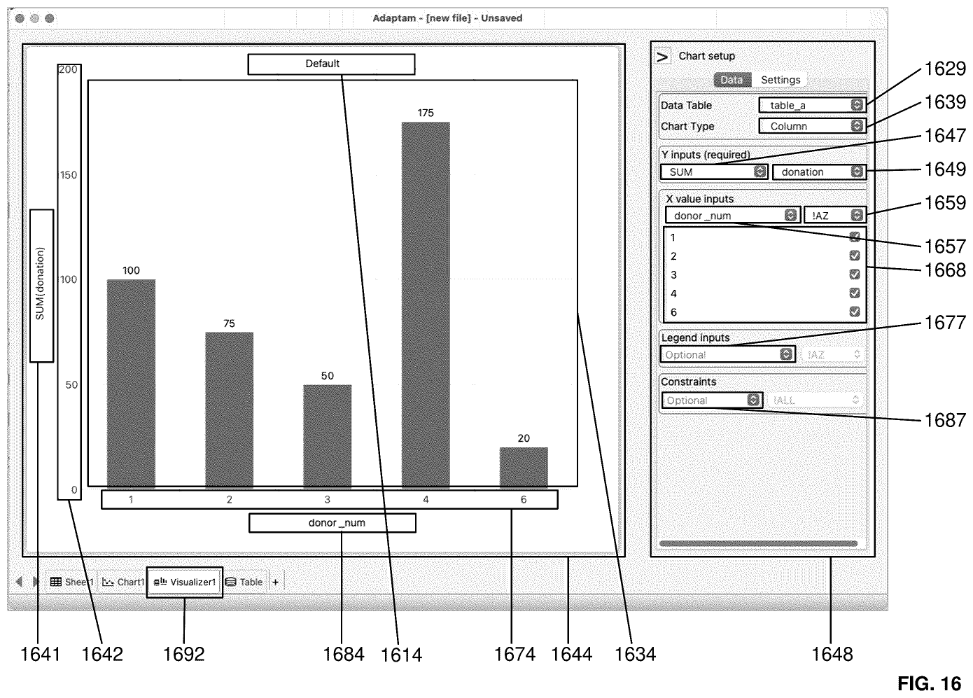

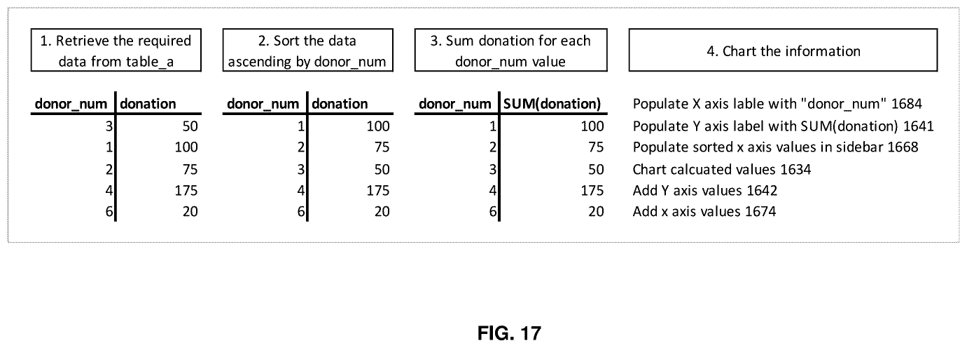

Before we example our data visualizer joining data, we will example its basic operation per our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021 on chart preceding one using the joined data. FIG. 16 examples our spreadsheet data visualizer creating a chart employing the data in ‘table_a’ 1523 in FIG. 15. The user has opened the ‘Visualizer1’ 1692 tab in FIG. 16 within their spreadsheet and would like to create a visualizer chart of the total donations for each donor. They know that donations data is in ‘table_a’ so they start in the visualizer input panel which in this embodiment is a sidebar 1648 and select ‘table_a’ for the ‘Data Table’ input 1629. This automatically populates the smart dropdown selectors with the data fields/columns from ‘table_a’ and with our new technology any fields/columns from other data sets joinable to ‘table_a’. They next select a ‘Chart Type’ of ‘Column’ 1639 and then move on to specifying the chart content. For the ‘Y inputs’ they specify ‘SUM’ 1647 and ‘donation’ 1649 so as to chart the sum of the ‘donation’ values. For the ‘X value inputs’ they specify ‘donor_num’ 1657 and leave the default sort ‘!AZ’ 1659 so that the x axis will be sorted by ascending values of ‘donor_num’. With the minimum required inputs satisfied this automatically triggers generation of the chart 1644 and populates the x values 1668 in the sidebar 1648. Those visualizer chart generating automatic calculations and actions are illustratively exampled in FIG. 17. Our visualizer retrieves the fields/columns required by the visualizer inputs from the data source, in-cell or external, as exampled in step ‘1’ in FIG. 17. Then it sorts the data by ascending values of ‘donor_num’ in step’2’. In step ‘3’ our spreadsheet visualizer does the summation of the ‘donation’ values for each ‘donor_num’ values, which in this example there is only one per but in other situations would sum all the values. Then in step ‘4’ it uses the inputs, the sorted and calculated values to populate the visualizer chart including the axes titles as described in the population of 1684/1641/1668/1634/1642/1674. Note, at this point they have not used data from more than one data set and did nothing to change the chart title from the placeholder ‘Default’ 1614.

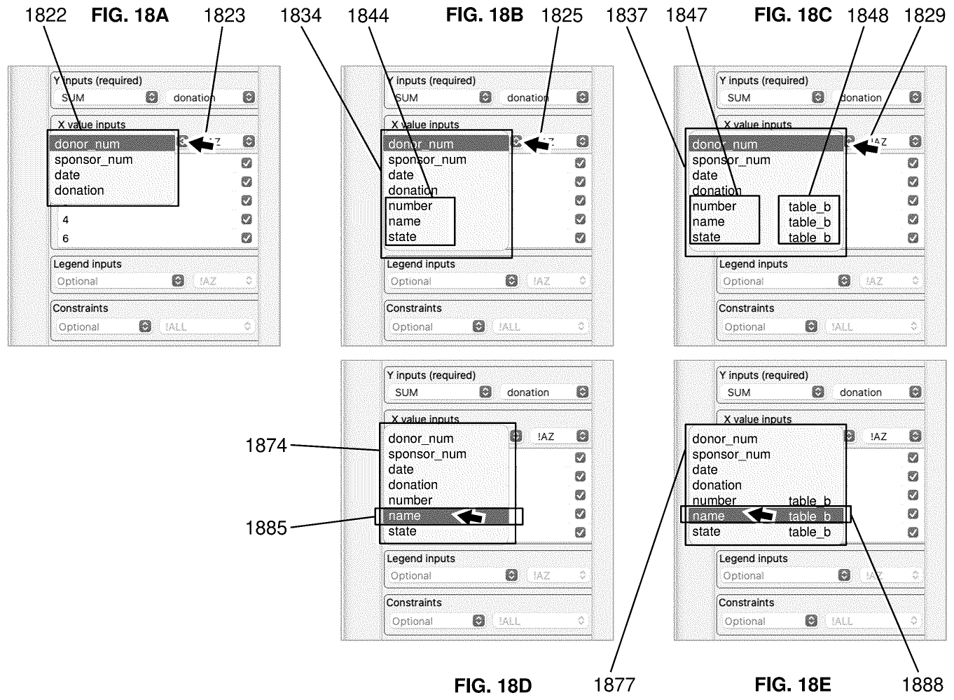

However, at this point the user realizes that they would like the names of the donors rather than their donor id number (‘donor_num’). Because the donor names are in ‘table_b’, that requires the visualizer to join the data of ‘table_a’ and ‘table b’ which we will now example. In this embodiment those two tables have been qualified for a join flag prior to this visualizer in one of the locations through one of the ways and qualification tests described herein. Therefore, the selection lists used to populate data fields/columns (1649, 1657, 1677, and 1687) into the visualizer automatically display and populate based on user selection the joinable fields from ‘table_b’ when’table_a’ (1629 in FIG. 16) is used as exampled in FIG. 18B through FIG. 19E and FIG. 20B through FIG. 21E.

### Different Joinable Data Selection Lists

FIG. 18A examples the selection list 1822 triggered by clicking the dropdown button 1823 in a visualizer without our joining technology. It therefore only shows the fields/columns 1822 in ‘table_a’. FIG. 18B examples the selection list 1834 triggered by clicking the dropdown button 1825 in a visualizer with our joining technology with a prequalified join of ‘table_b’. It not only shows the fields/columns 1822 in ‘table_a’, but also the joinable fields/columns 1844 of ‘table_b’ in the selection list 1834. The user can join the two tables they desire by clicking the field/column ‘name’ 1855 in the selection list 1874 in FIG. 18D. Another UI variant of this embodiment is exampled in FIG. 18C where the selection list 1837 triggered by clicking the dropdown button 1829 in a visualizer input with our joining technology also contains the ‘table_b’ listing 1848 beside each field/column 1847 from ‘table_b’. As in the previous example, the user can cause the join of the two tables they desired by clicking the field/column ‘name’ 1888 in the selection list 1877 in FIG. 18E.

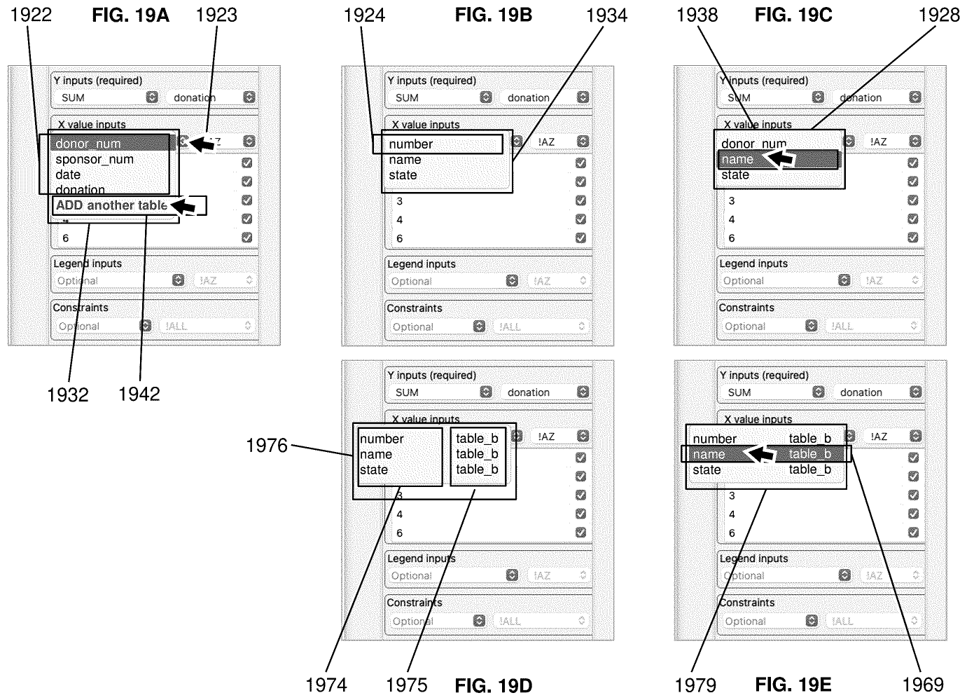

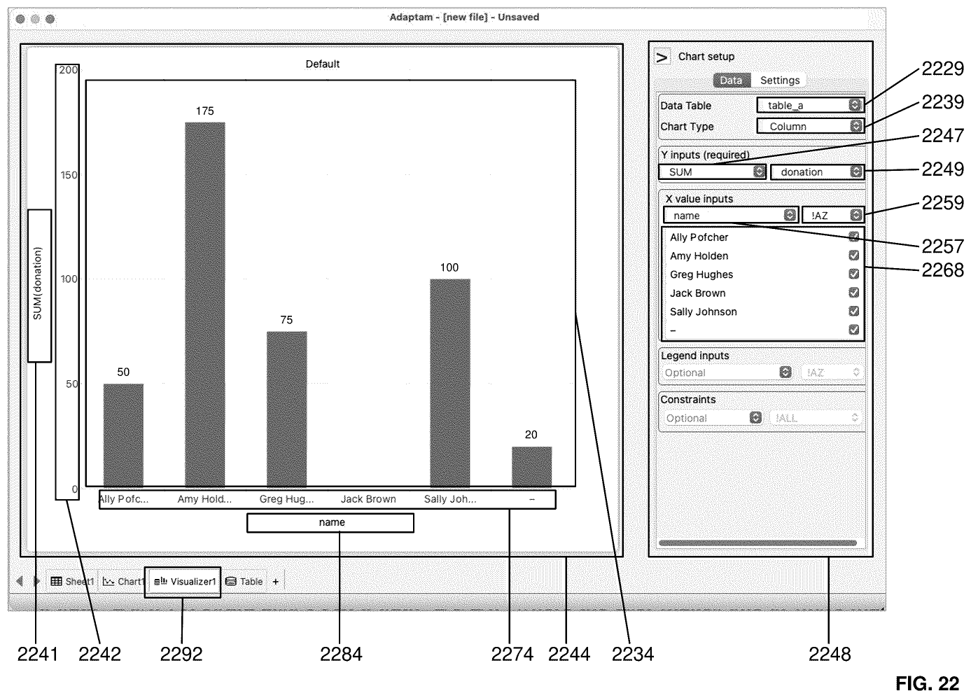

FIG. 19A through FIG. 19E examples another two variants of our technology where the first dropdown gives access to the joinable data via a second dropdown. FIG. 19A examples the selection list 1932 triggered by clicking the dropdown button 1923 in a visualizer with our joining technology. It not only shows the fields/columns 1922 in ‘table_a’ (with the currently selected field/column ‘donor_num’ highlighted), but also a selection ‘ADD another table’ 1942 that gives access to any joinable fields in this situation the applicable fields in ‘table_b’. Note, this embodiment like the others says applicable fields/columns because depending on the selection used the fields/columns can be limited (e.g., for example not allowing reuse of previous selections or data type limited by use within a function). Returning to this specific example, the user then clicks the ‘ADD another table’ 1942 selection which then automatically opens the selection list 1934 in FIG. 19B. That selection list 1934 displays all the fields/columns in ‘table_b’, which are all usable in this input. The user then sees the field/column ‘name’ 1938 that they want and clicks it 1938 in the selection list 1928 in FIG. 19C to join the data and deliver the chart in FIG. 22, which we will discuss later. Another UI variant of this embodiment is exampled in FIG. 19D where the selection list 1976 was triggered by clicking the ‘ADD another table’ 1942 in FIG. 19A. This selection list 1976 also contains the ‘table_b’ listing 1975 beside each field/column 1974. As in the previous example, the user can cause the join of the two tables they desired by clicking the field/column ‘name’ 1969 in the selection list 1979 in FIG. 19E.

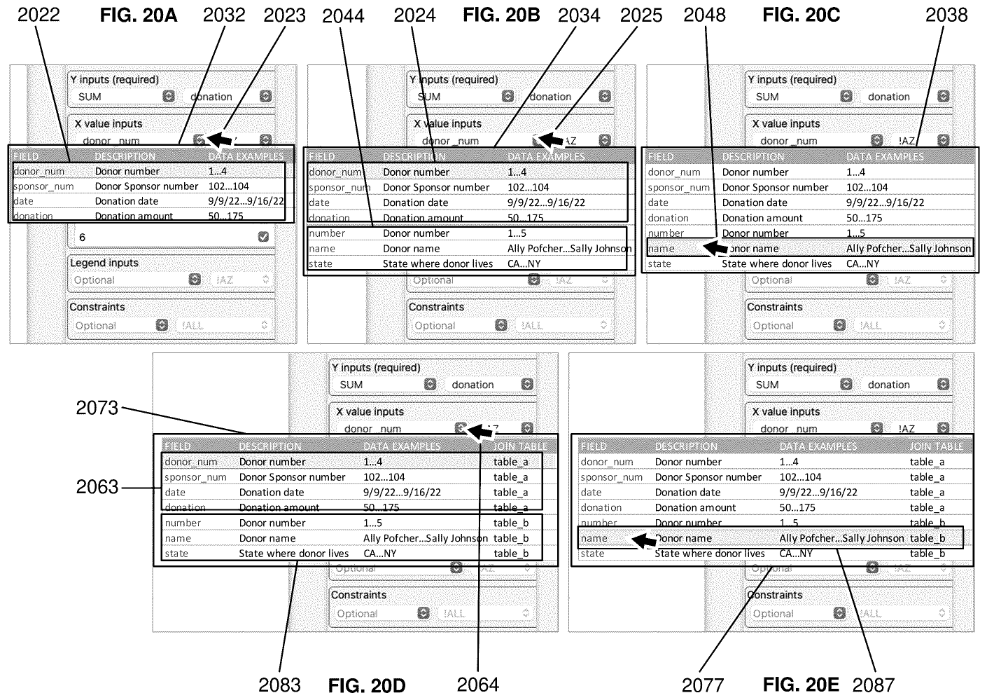

Two more variants of the UIs for selecting the joinable data are exampled in FIG. 20B through FIG. 20E. FIG. 20A examples the selection list 2032 triggered by clicking the popup button 2023 in a visualizer without our joining technology. It therefore only shows the fields/columns 2022 in ‘table_a’. FIG. 20B examples the selection list 2034 triggered by clicking the popup button 2025 in a visualizer with our joining technology with a prequalified join of ‘table_b’. It not only shows the fields/columns 2024 in ‘table_a’, but also the joinable fields/columns 2044 of ‘table_b’. The popup also gives the user further information (‘DESCRIPTION’ and ‘DATA EXAMPLES’) about each field/column displayed to make it easier for the user to confidently make their selection. In this example the user clicks the field/column ‘name’ 2048 in the selection list 2038 in FIG. 20C to then join the data and deliver the visualizer chart in FIG. 22, which we will discuss later. Another UI variant of this embodiment is exampled in FIG. 20D where the selection list 2073 triggered by clicking the popup button 2064 in a visualizer input displays the ‘table_a’ fields/columns 2063 each with ‘JOIN TABLE’ ‘table a’ beside the ‘DESCRIPTION’ and ‘DATA EXAMPLES’ information. It also displays the ‘table_b’ fields/columns 2083 allowing the user to select the field/column ‘name’ 2078 in the selection list 2077 in FIG. 20E thereby automatically joining data from ‘table_b’ with’table_a’ in the visualizer chart in FIG. 22, which we will discuss later.

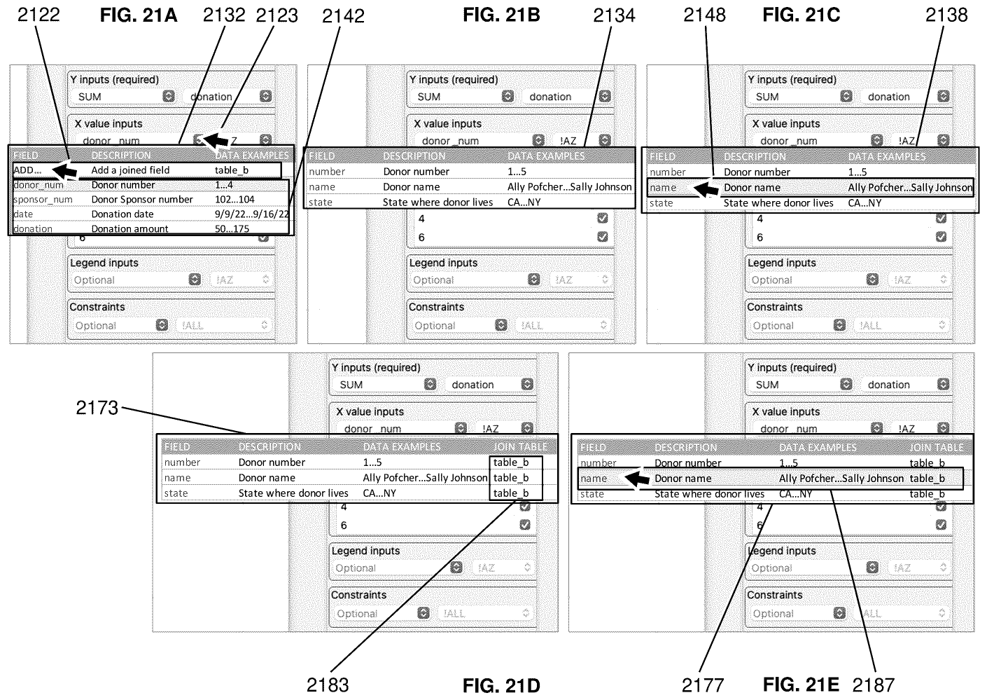

FIG. 21A through FIG. 21E examples two more variants of our technology where the first popup gives access to the joinable data through a second popup. FIG. 21A examples the selection list 2132 triggered by clicking the popup button 2123 in a visualizer with our joining technology. It not only shows the fields/columns 2142 in ‘table_a’ (with the currently selected field/column ‘donor_num’ highlighted), but also a selection ‘ADD another table’ 2122 that gives access to the applicable joined fields in ‘table_b’. Note, this embodiment like the others says applicable fields/columns because depending on the selection used the fields/columns can be limited (e.g., field reuse in other inputs limited or data type limited by use within a function). Returning to this specific example, the user then clicks the ‘ADD another table’ 2122 selection which then automatically opens the selection list 2134 in FIG. 21B. That selection list 2134 displays all the fields/columns in ‘table_b’, which are all usable in this input. The user then sees the field/column ‘name’ 2148 in the selection popup 2136 in FIG. 21C that they want and clicks it to join the data and deliver the chart in FIG. 22, which we will discuss later. This set of selection list popups displays the ‘DESCRIPTION’ and ‘DATA EXAMPLES’ information to help inform the user in their field/column selections. Another UI variant of this embodiment is exampled in FIG. 21D where the selection list 2173 was triggered by clicking the ‘ADD another table’ 2122 in FIG. 21A. This selection list 2173 also contains the ‘JOIN TABLE’ ‘table_b’ listing 2183 beside each ‘FIELD’. ‘DESCRIPTION’ and ‘DATA EXAMPLES’. With this additional information supplied to better inform the user in their field/column selection. As in the previous example, the user can cause the join of the two tables they desired by clicking the field/column ‘name’ 2187 in the selection list 2177 in FIG. 21E as exampled in FIG. 22.

We could continue to example different selection lists and ways for the user to make the selections as well as exampling them for all the different visualizer chart UIs exampled in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021, but for brevity's sake we will instead move onto the generation of outcome from each of these as exampled in FIG. 22.

### Unique to Unique Joined Data Visualizer Chart Result

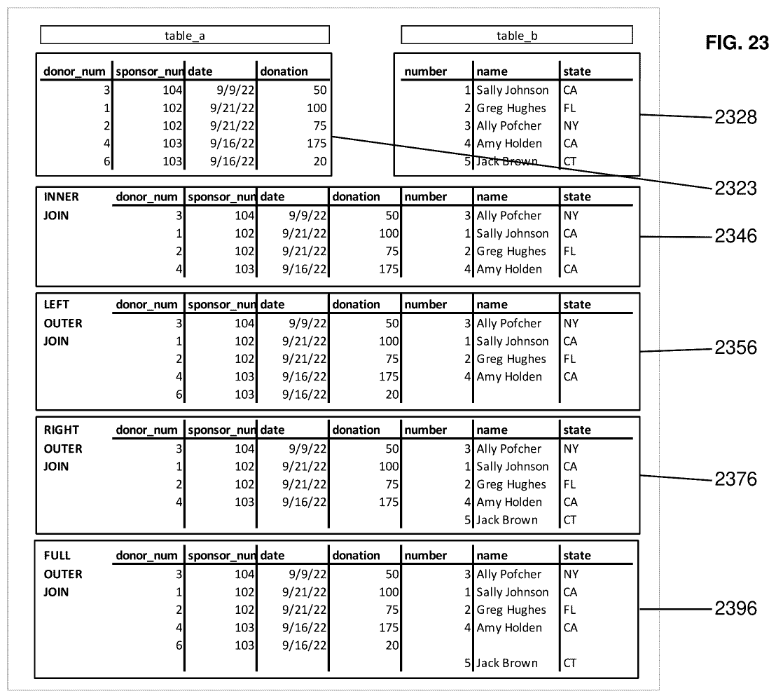

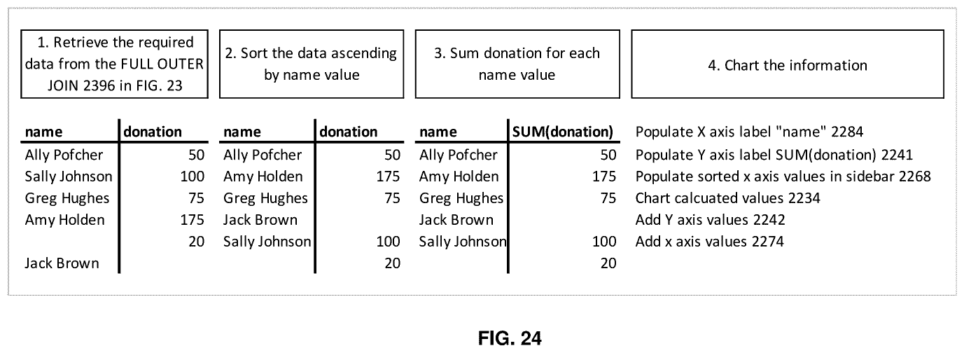

Any of the selections in FIG. 18D, FIG. 18E, FIG. 19C, FIG. 19E, FIG. 20C, FIG. 20E, FIG. 21C, and FIG. 21E result in FIG. 22 as our visualizer automatically regenerates with a changed input once the minimum inputs are fulfilled. In this example that regeneration starts with joining the data as illustratively exampled in FIG. 23. Our technology supports these 2346/2356/2376/2396 and more SQL joins (e.g., cross and self joins) and for this embodiment uses the ‘FULL OUTER JOIN’ 2396 of dataset ‘table_a’ 2323 and data set ‘table_b’ 2328. After which our technology automatically executes the four steps in FIG. 24. In step ‘1’ retrieving the two fields ‘name’ and ‘donation’ from the joined data. Then, as before in FIG. 17 pre the join, our technology sorts the data by ascending values of ‘name’ (rather than ‘donor_num’) in step ‘2’. In step ‘3’ our spreadsheet visualizer does the summation of the ‘donation’ values for each ‘name’ value, which in this example there is only one per but in other situations would sum all the values. Then in step ‘4’ it uses the inputs, the sorted, and calculated values to populate the visualizer chart including the axes titles, Thus, automatically changing the x axis values in the sidebar 2268 and in the chart 2274, populating the donation sums displayed in the chart 2234, populating the y axis values 2242 and changing the x axis label to ‘name’ 2284. Thereby giving this spreadsheet user the ability to see joinable data and effect a join in their visualizer chart without the complexity of having to set up a join and without having to see join arguments (i.e., no visible joining argument or joining function in the visualizer inputs panel) displaying the keys and any other qualification parameters. The joined data is available similarly to the data from the original data set, ‘table_a’ 2229 in this example. Note this was all done with only one visualizer input 2248 change of the value ‘name’ 2277. None of the other inputs 2229/2239/2247/2249/2259 were changed. Also note, that while this example was done for a visualizer chart in a visualizer tab it is equally applicable to a visualizer chart generated in a worksheet tab.

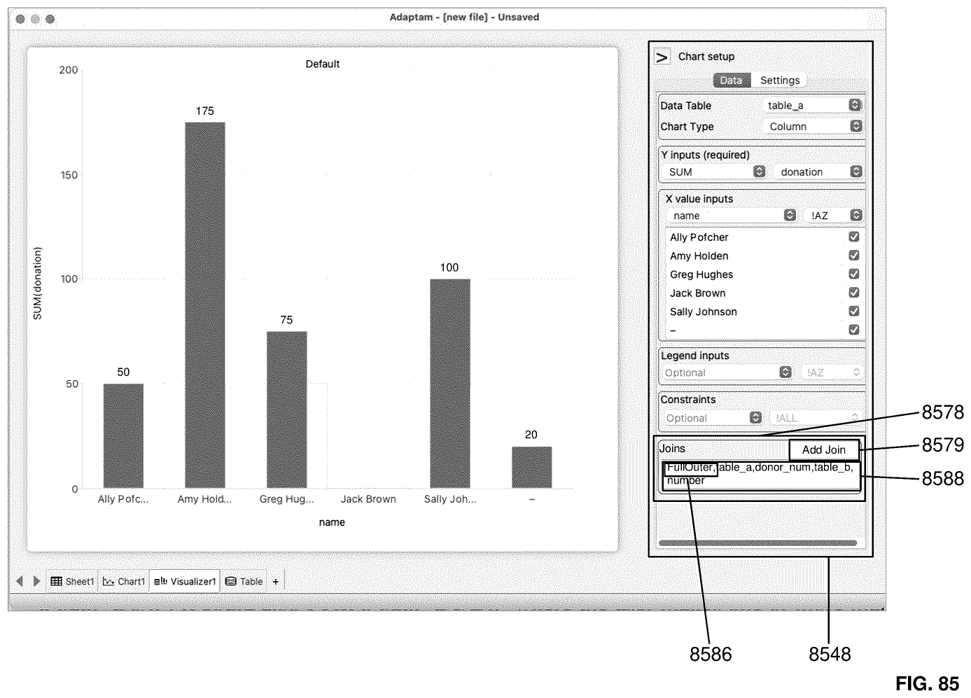

In a different embodiment that accomplishes the same result as FIG. 22 our technology automatically populates the preset join(s) in the visualizer input panel 8548 in FIG. 85 a ‘Joins’ specifier 8578 so the user is aware of any join(s). In this embodiment that “joins’ specifier arguments 8588 display the join type, the data sets, and join keys so the user is fully informed the join particulars. This embodiment also has an ‘Add Join’ button 8579 that allows a user to add a join within this visualizer which could apply only to this visualizer chart or with a selection of applicability as extensive as the user would like (e.g., all visualizers, all worksheets, or all tabs within the spreadsheet).

### Types of Joins

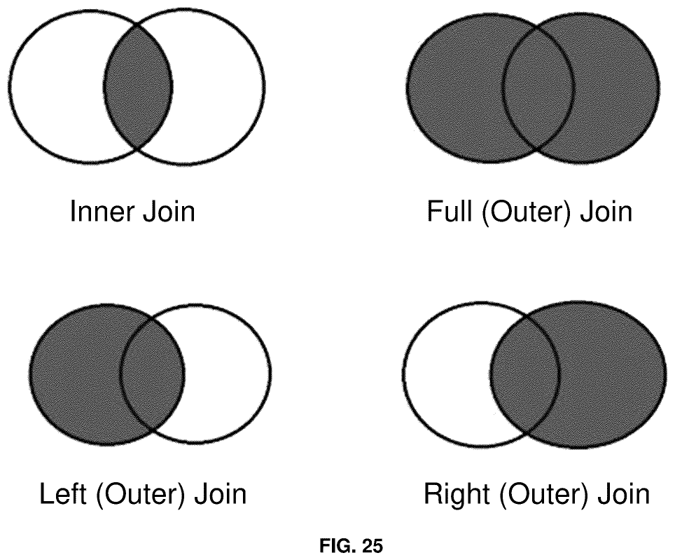

Our technology supports the full range of data set joins (e.g., inner, full outer, left outer, right outer, self, and cross) with our exampling more focused on the joins pictorially illustrated in FIG. 25. Our joins use any of the data types or combinations of data set types in FIG. 6A through FIG. 7B. FIG. 25 visually examples pictorially in the red-colored space the join results for the inner, left outer join, right outer, and full outer joins. FIG. 23 examples those different joins for the joining of ‘table_a’ 2323 and ‘table_b’ 2328 with unique join keys (as exampled in FIG. 15A and FIG. 15B) in each data set. The ‘inner join’ joins 2346 only rows with the intersecting key values in ‘table_a’ 2323 and in ‘table_b’ 2328 and therefore has the least rows. The ‘left outer join’ 2356 joins all the rows in ‘table_a’ 2323 with any of the intersecting rows (rows having the same key value) in ‘table_b’ 2328. The ‘right outer join’ 2376 joins all the rows in ‘table_b’ 2328 with any of the intersecting rows (rows having the same key value) in ‘table_a’ 2323. The ‘full outer join’ joins 2396 all the rows in ‘table_a’ 2323 and all the rows in ‘table b’ 2328. These joined table data sets are exampled here to give a visual illustration of the type of data joins being executed as part of the visualizer chart exampled in FIG. 22. Our technology automatically joins the data required as part of executing the visualizer chart. There are many variants of the types of inputs and formulas used in our visualizer charts, as well as different types of data sets supported by our joinable data technology as we will now further example.

### Unique to Non-Unique Joined Data Visualizer Chart

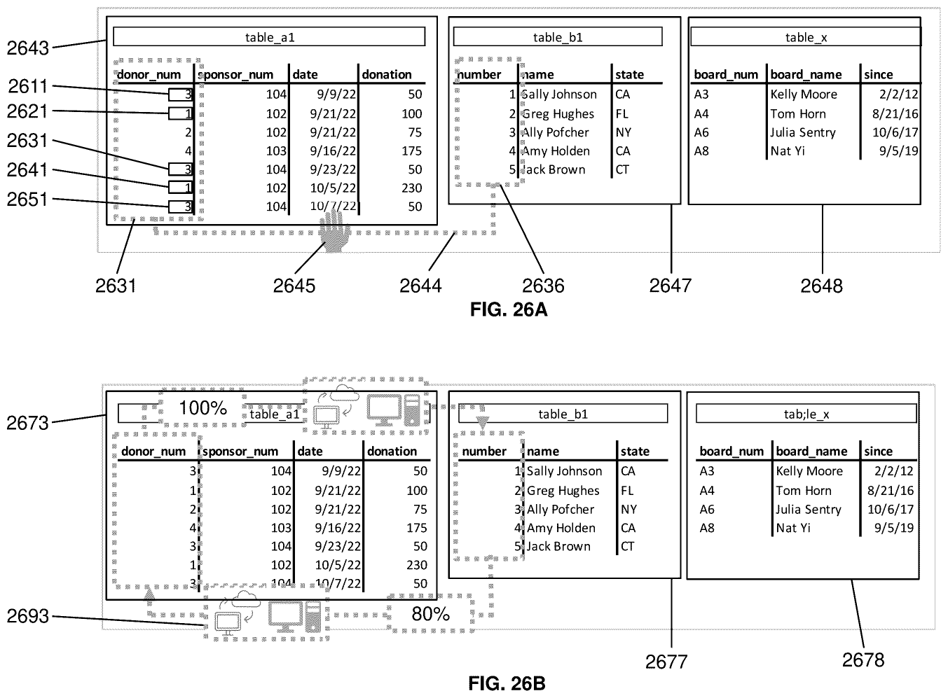

Our unique to non-unique join key joinable technology works very similarly to our previously exampled unique-to-unique technology with the only difference being in the table joins themselves, where the unique table rows can be appended to more than one of the non-unique table rows. FIG. 26A examples a ‘table_a1’ 2643 which is different than the previously exampled ‘table_a’ 1533 in FIG. 15A because ‘table a1’ 2643 is non-unique for the join key ‘donor_num’ 2631 while ‘table_a’ in FIG. 15A is unique for the join key ‘donor_num’ 1532. The ‘table a1’ 2643 is a non-unique because the join key ‘donor_num’ 2631 has duplicate values. In this example three rows with the value ‘3’ 2611/2631/2651 and two rows 2621/2641 with value ‘1’ The ‘table_b1’ 2647 FIG. 26A, like the previous ‘table_b’ 1547 in FIG. 15A is unique for the join key ‘number 2636/1536’. Therefore, the ‘table_a1’ 2643 join to ‘table_b1 2647’ has a data modelling cardinality of non-unique to unique. FIG. 26A through FIG. 30B examples the use of those non-unique to unique joins in our joinable visualizer selectable list and joined chart technologies.

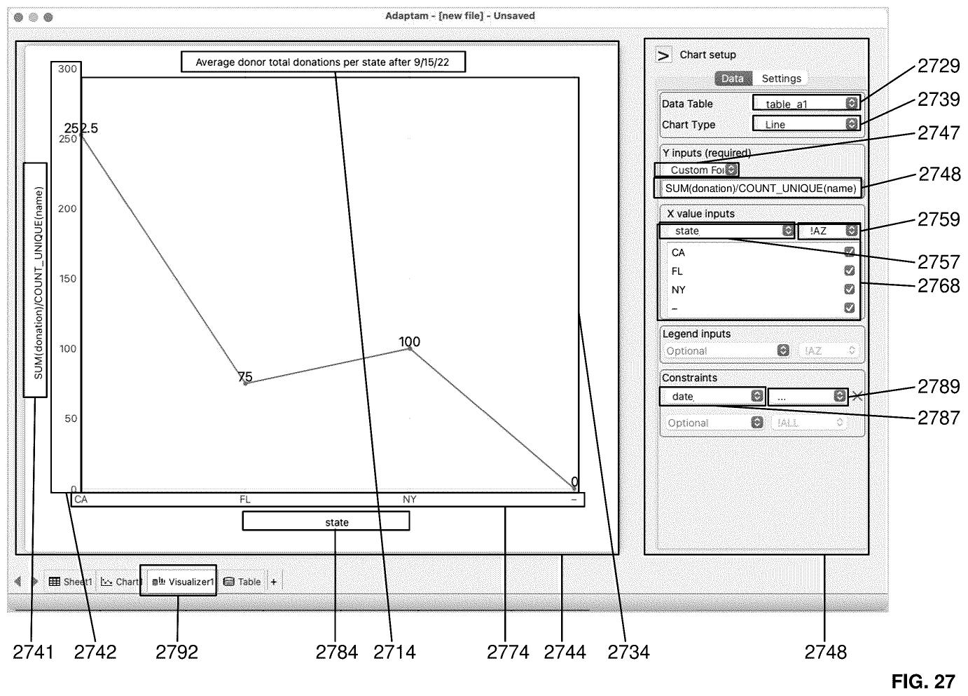

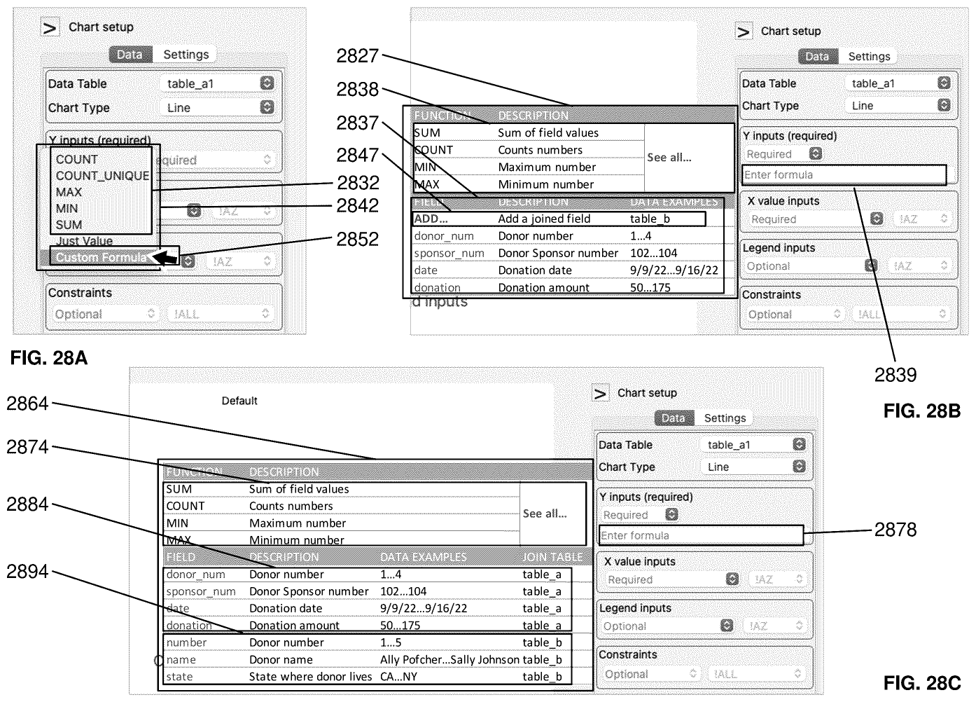

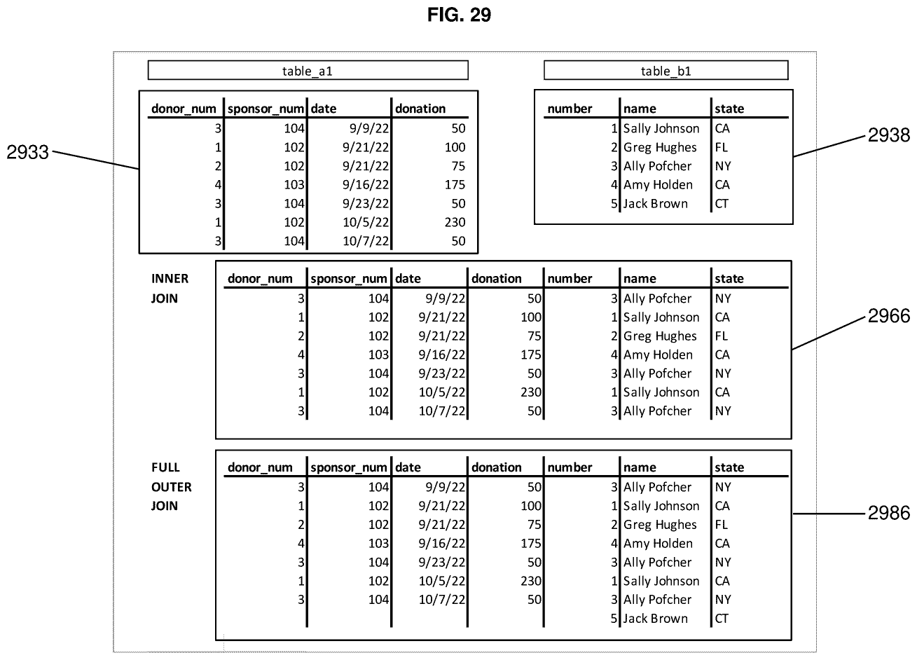

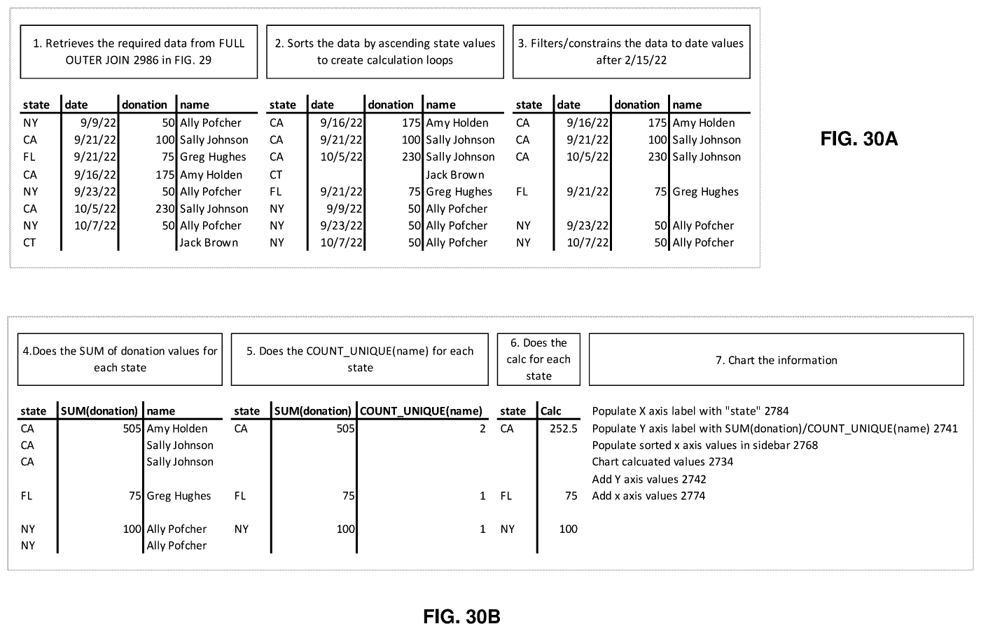

We are continuing our examples with the charity user who this time wants to see a chart of average donations per donor in each state for the states in the first half of the alphabet. As described previously and pictorially exampled in FIG. 26A and FIG. 26B the qualified join flags could have been set by any of the locations before this visualizer (e.g., FIGS. 1 135, 145, 155, 165, and 175) the ways (e.g., in FIG. 2) using any of the qualification validation approaches (e.g., in FIG. 3) exampled herein. FIG. 26A examples the join 2644 being set manually 2645 while FIG. 26B examples the join being set automatically 2665/2693. In each setting the user also has access to a third data set ‘table_x’ 2648 in FIGS. 26A and 2678 in FIG. 26B which is not joinable to either of the data sets ‘table_a1’ 2643/2673 or ‘table_b1’ 2647/2677. They also could have been set by a combination of manual and automatic key selection and/or key qualification validation testing. The user sets up the visualizer chart exampled in FIG. 27 using any of the appropriate types of selection lists (e.g., FIG. 18B through FIG. 19E and FIG. 20B through FIG. 21E) described herein. As well as the different selection lists employed by our technology for the ‘Custom Formula as exampled in FIG. 28A through FIG. 28C. In this example, after the user selects the ‘Data Table’ ‘table_a1’ 2729 and the ‘Chart type’ ‘Line’ 2739 in the visualizer chart input 2748 (in the ‘Visualizer1’ tab 2792 although it could have also been in a visualizer setup in a worksheet), the user selects to build a custom formula which they can do if they want to go beyond the short list of commonly used functions 2832 in the selection list 2842 in FIG. 28A. This allows the user to build formulas employing multiple functions with algebraic operators and beyond as described in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021. Therefore, the ‘Custom Formula’ 2852 selection delivers aa selection list populated with functions, fields/columns, and in this embodiment the access to joined fields/columns as exampled in FIG. 28B. This example employs a ‘ADD . . . ’ 2847 selection line giving access to the joinable data as exampled in FIG. 21A/FIG. 21B and FIG. 21A/FIG. 21D. That part of the selection list 2837 that holds the ‘ADD . . . ’ 2847 also holds the fields/columns in ‘table_a’. The other part of the selection 2838 contains the most frequently used functions and a ‘See all . . . ’ way to access all the others. So, the selection list 2837 gives the user function and formulaic data field/column options to start building the custom formula. Different variants work in our technology as exampled in FIG. 28C where the ‘Custom Formula’ selection 2852 in the selection list 2842 in FIG. 28A alternatively opens the selection list 2827 in FIG. 28C. That selection list 2864 displays the joinable fields 2894 in ‘table_b’ as well as the fields 2884 in ‘table_a’ and a selection list 2874 with the most frequently used functions and a ‘See all . . . ’ way to access all the others. Using the selection lists in either FIG. 28B or FIG. 28C and the ones that follow the user can construct the custom formula 2748 in FIG. 27. More variants of these selection lists are exampled in our U.S. Provisional Patent Application No. 63/525,138, which is incorporated by reference above, as this strongly parallels many of its examples of building a formula. The user then uses our joinable selection lists to populate ‘state’ 2757 in the x axis input 2768 and to populate ‘date’ 2787 in the ‘Constraints’ input. They then set the date constraint (after) 2/15/22 into the second ‘Constraints’ input 2789 which is a multi-select of the dates. Note, the user did not change the ‘!AZ’ 2759 ascending sorting of the ‘X value inputs’ but could have changed them to ‘!ZA’ descending or custom. At that point they get the visualizer chart 2744 with the ‘state’ values populated in the chart 2744 and the sidebar 2768 for the x axis values (‘X value inputs’). The calculated values for the formula SUM(donation)/COUNT_UNIQUE(name) 2748 are then populated in the body of the chart 2734 as well as the corresponding vertical scale 2742. In this embodiment our visualizer chart automatically populates the calculated formula 2748 as the vertical axis label 2741. It also automatically populates the x axis input ‘state’ 2757 as the x axis label in the chart 2784. In FIG. 27 the user has replaced the ‘Default’ placeholder chart title with their title 2714 to finish the visualizer chart. The join 2986 in FIG. 29 and seven steps in FIG. 30A and FIG. 30B illustratively example the automatically executed actions by our technology creating the chart (realizing the actual actions employed by our application may be different to achieve the same results).

In this example the user has created a visualizer chart with a multi-function algebraic operator formula utilizing four different joined fields, two in the calculated formula 2748, one in the x axis input 2757, and one in the constraint 2787. This was accomplished using join with a qualification flag setup prior to this visualizer chart and where the chart inputs contain no visible join arguments. The ‘Custom Formula’ selection 2747 triggers selection lists which combine access to the joined data with access to populating prebuilt spreadsheet functions. All of this can be executed by a spreadsheet visualizer user who has no knowledge of SQL and data set joins but simply follows the selection lists to populate the chart they desire.

While we could continue to example different two data set join visualizer charts using our technology with more complicated calculations (e.g., more prebuilt functions, prebuilt functions within prebuilt functions, and numerous algebraic operators) and different input setups and UIs, we will instead example why some of our embodiments block non-unique to non-unique data modelling cardinality joins. After which we will example multiple joins supported in our technology.

### Non-Unique to Non-Unique Joins Handling

While “many” (non-unique) to “many” (non-unique) data table joins are supported in SQL they frequently generate results that require some expertise to deal with to not generate erroneous calculational answers. And therefore, many embodiments of our data joining technology do not present those options in our selectable lists (e.g., hints) and some generate an error should a user attempt usage in a visualizer chart.

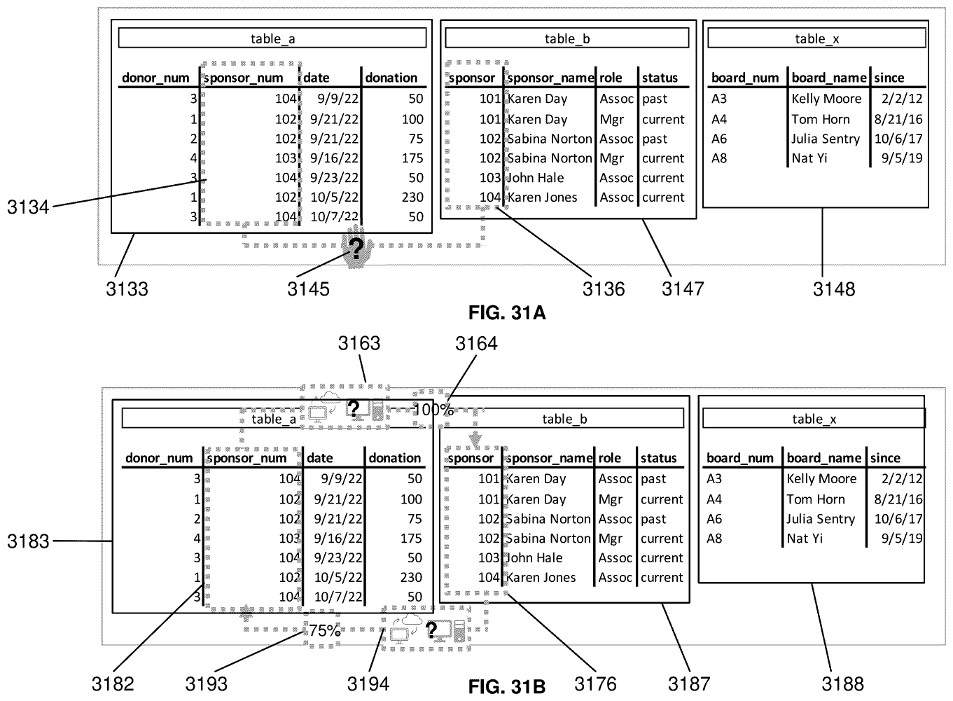

FIG. 31A and FIG. 31B example three data tables for potential joining. ‘Table a’ 3133 and ‘Table b’ 3147 in FIG. 31A example two data tables with potentially joinable data based on the key columns/fields of ‘sponsor_num’ 3134 and ‘sponsor’ 3136. However, neither of those data columns has unique (distinct) values and therefore when joined, as exampled using SQL in FIG. 5, do not append values from a “unique” table to rows in the “many” table. Instead, because there is no “unique” data table key, i.e., both are “many” data table keys, the result is a limited (partial) Cartesian Product of the table rows. That partial Cartesian Product in this example duplicates the rows 526/535/546 in ‘table a’ 536 to deliver the duplicated rows 576/586/596 for the joined data 588 in FIG. 5. Thus, having doubled some of the ‘donor_num’, ‘sponsor_num’, ‘date’ and ‘donation’ rows (as shown in 576/586/596 versus 526/535/546 in FIG. 5). This results in any count (e.g., COUNT, COUNT_TEXT, and COUNT_DATE) of those fields in the joined data not arriving at the correct original table 536 totals. It also means a sum of the field ‘donation’ 587 using the joined data 588 will not arrive at the correct total for donations (because of the duplicated values). For those reasons many embodiments of our technology do not present those options, as exampled in FIG. 8 877 and FIG. 10/FIG. 11, in our joinable data selectable lists (e.g., hints) and some options generate an error should a user attempt usage in a chart visualizer input. That said, a sophisticated user can navigate the data challenges presented by these joins and therefore embodiments of our technology support using these joins as exampled in FIG. 31 through FIG. 37.

### Partial Cartesian Product Problem and Fix

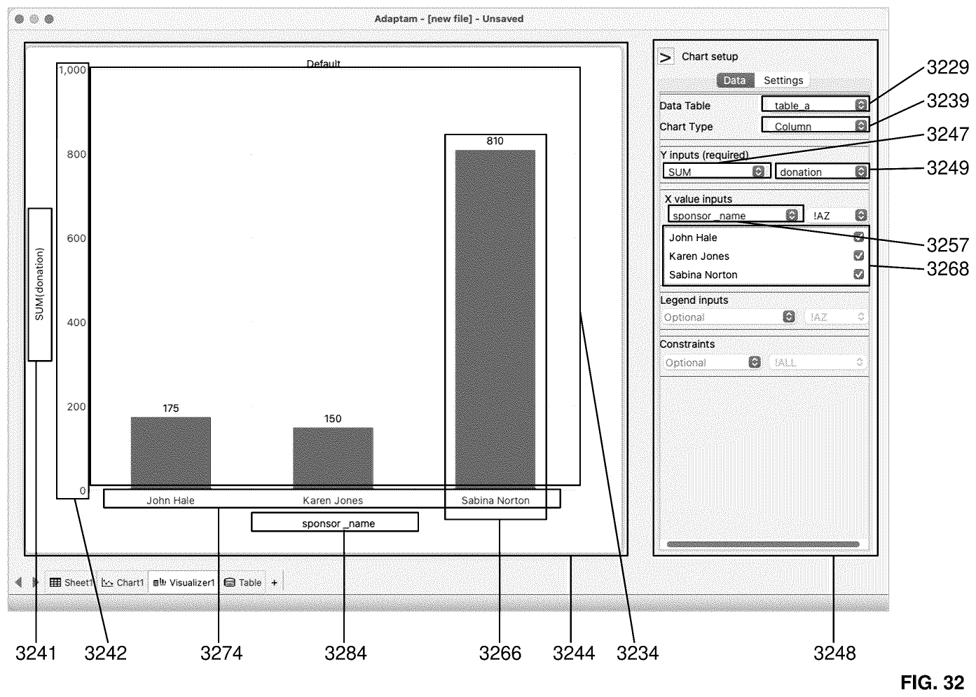

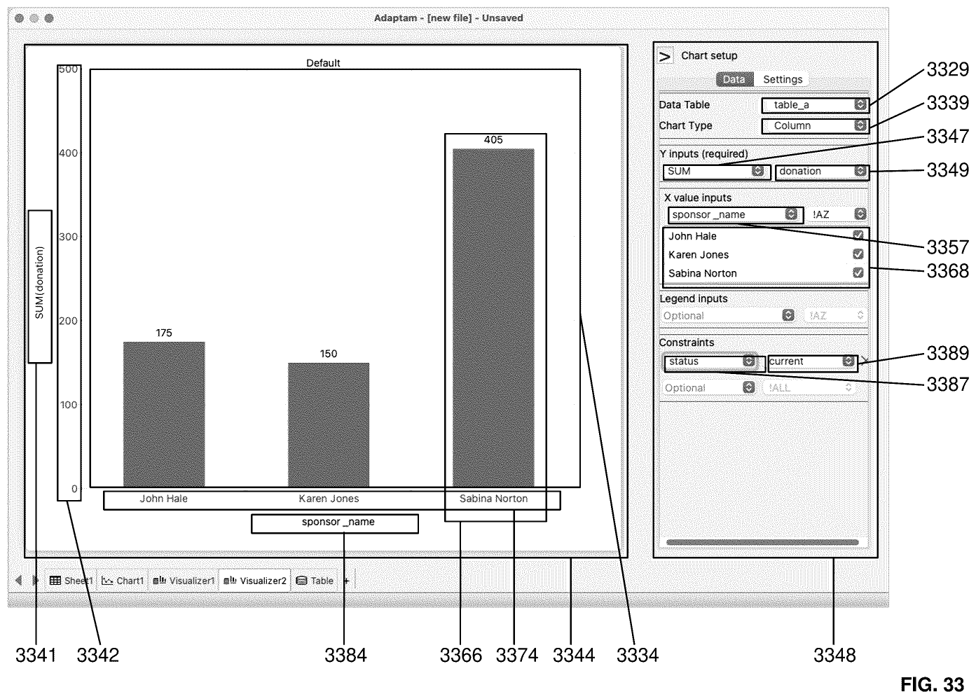

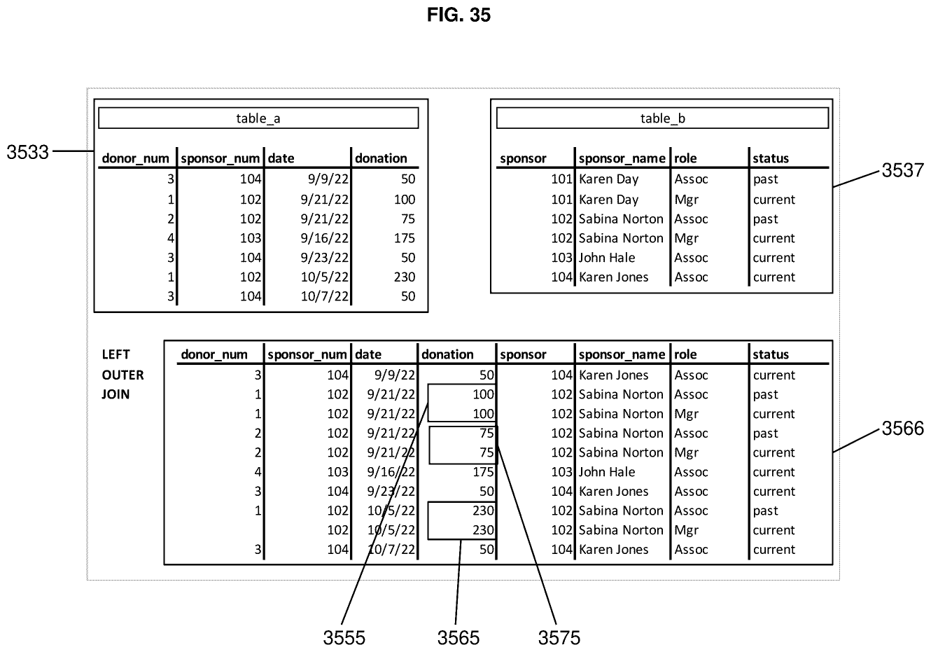

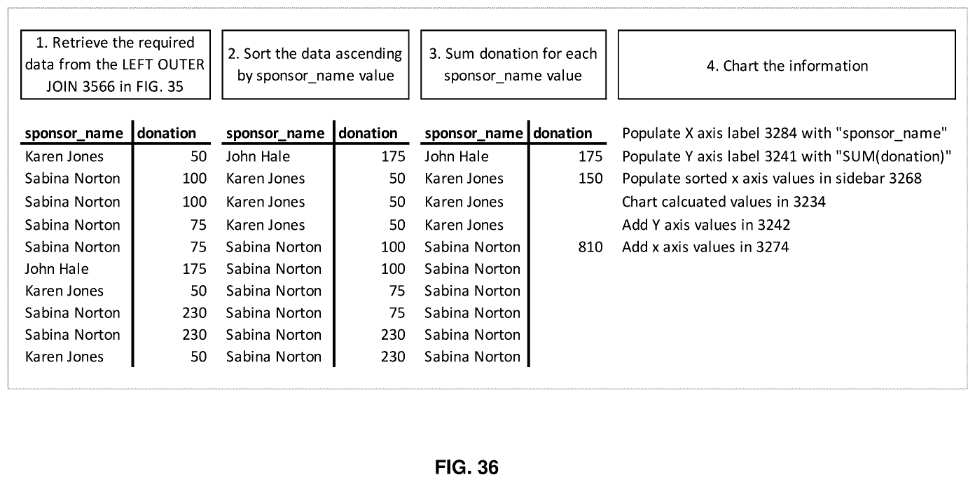

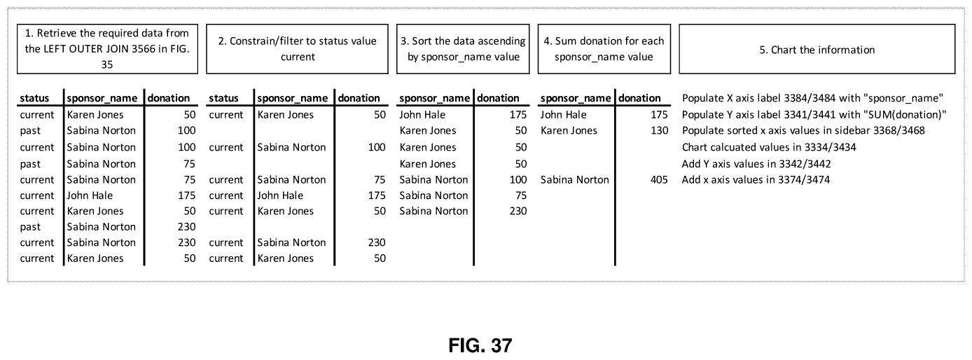

As mentioned before FIG. 31A and FIG. 31B examples three data sets (3133/3183, 3147/3187, and 3148/3188) where two of the data sets (‘table_a’ 3133/3183 and ‘table_b’ 3147/3187) are joinable via a non-unique to non-unique (many to many) data modelling cardinality join (3145 between keys ‘sponsor_num’ 3134 and ‘sponsor’ 3136, and 3164, and 3193 between keys ‘sponsor_num’ 3182 and ‘sponsor’ 3176). Where FIG. 31A examples a manual join 3145 and FIG. 31B examples more automated join 3163/3194. If that join is done before the visualizer chart, then an unsophisticated user is likely to generate the visualizer chart in FIG. 32 likely unknowingly encountering the partial Cartesian Product problem. This user wants a ‘Chart Type’ ‘column’ 3239 that totals donations by sponsor name and does so using ‘SUM’ 3247 ‘donation’ 3249 from ‘table_a’ 3229 and the joinable data field ‘sponsor_name’ 3257 from ‘table_b’ as visualizer ‘chart setup’ 3248 for ‘Visualizer2’ 3393. Note, like the preceding example this was exampled in a visualizer tab but could have been done populating a visualizer chart into a worksheet tab or other type of our spreadsheet tabs, as exampled in our previous filings. Our technology automatically then generates the chart 3244 employing the “LEFT OUTER JOIN’ 3566 in FIG. 35 duplicating the ‘donation’ values (3555, 3565, and 3575) creating the partial Cartesian Product problem. Therefore, generating a total ‘donation’ sum of ‘810’ 3266 in FIG. 32 for ‘Sabina Norton’, shown in the automatically executed illustrative steps in FIG. 36, that is twice the actual total for ‘Sabina Norton’. Now a more sophisticated user who understands SQL joins and well understands the data could instead add a constraint/filter limiting the ‘status’ 3387 to ‘current’ 3389 as exampled in FIG. 33, to a Visualizer input 3348 that otherwise has the same inputs (3329/3229, 3339/3239, 3347/3247, 3349/3249, and 3357/3257) as in FIG. 32, to eliminate the partial Cartesian Product created by the join (as shown in the illustrative automatically done actions by our app in in FIG. 37). In FIG. 33 the ‘Sabina Norton’ ‘SUM of ‘donation’ values totals the correct ‘405’ 3366 not the ‘810’ 3266 in FIG. 32. Therefore, there is value to giving the sophisticated users the ability to do these many to many joins but ideally without the risk of unsophisticated users doing them.

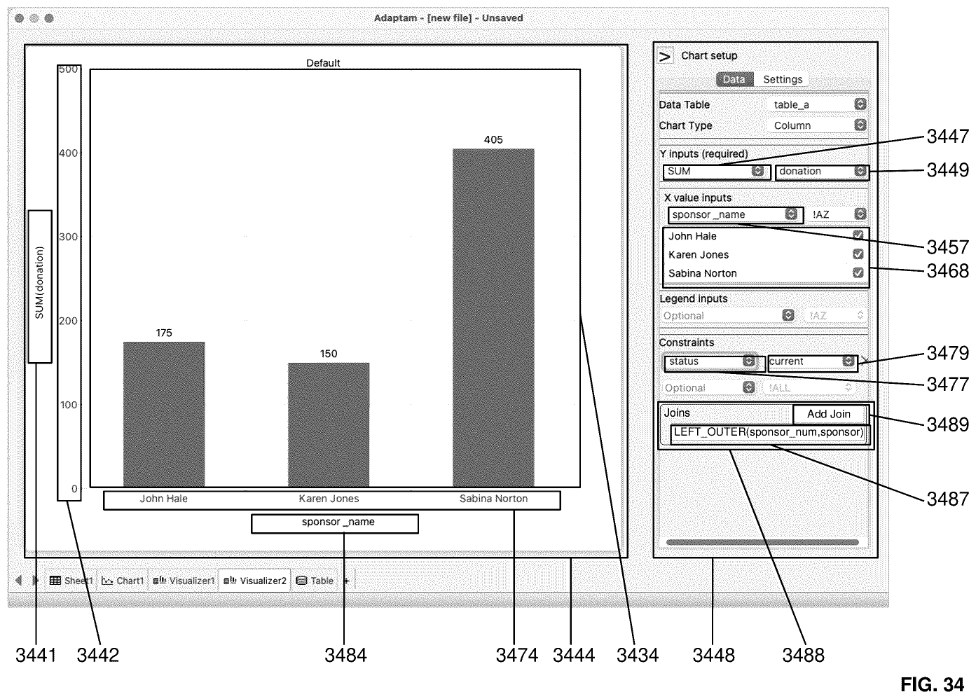

FIG. 34 examples one embodiment that solves that problem in our technology. Specifically, the validation tests blocks creating the joining flag prior to the visualizer chart, as described previously. Then in the visualizer chart input 3448 there is a way to add a join as exampled in FIG. 34 where the user can click the ‘Add Join’ button 3489 in the join specifier 3488 to add a join using UIs like the one exampled in FIG. 14B or some variation of those exampled in FIG. 12C, FIG. 12D, and FIG. 8. As the user has done here to record the join between ‘table_a’ 3533 and ‘table_b’ 3537 in FIG. 35 employing a left outer join using the join keys ‘sponsor_num’ in ‘table a’ and the join key ‘sponsor’ in ‘table b’ as detailed in the ‘Joins’ input 3488 via the join prebuilt function formula ‘LEFT_OUTER(sponsor_num,sponsor)’ 3487 (which also could be considered on argument in the ‘Joins’ input 3488). In this embodiment once that join is recorded then the joinable fields display in the selection lists like those exampled in FIG. 18B through FIG. 19E and FIG. 20B through FIG. 21E and the user then populates the joined fields ‘sponsor_name’ 3457, and ‘status’ 3477, with the status constraint of ‘current’ 3479. Then the visualizer successfully uses the join to deliver the chart 3444 via the automatically done join 3566 in FIG. 35 and steps in FIG. 37.

While we could do further examples single joins or multiple instances of single joins within a larger group of data sets, we will instead move to multiple joins that chain/sequence. We will start with the chain/cascade joining of three data sets, then more than three before returning to the special case of multiple joins between two data sets that chain/sequence and those that do not.

### Unique to Unique and Unique to Non-Unique Data Set Joins

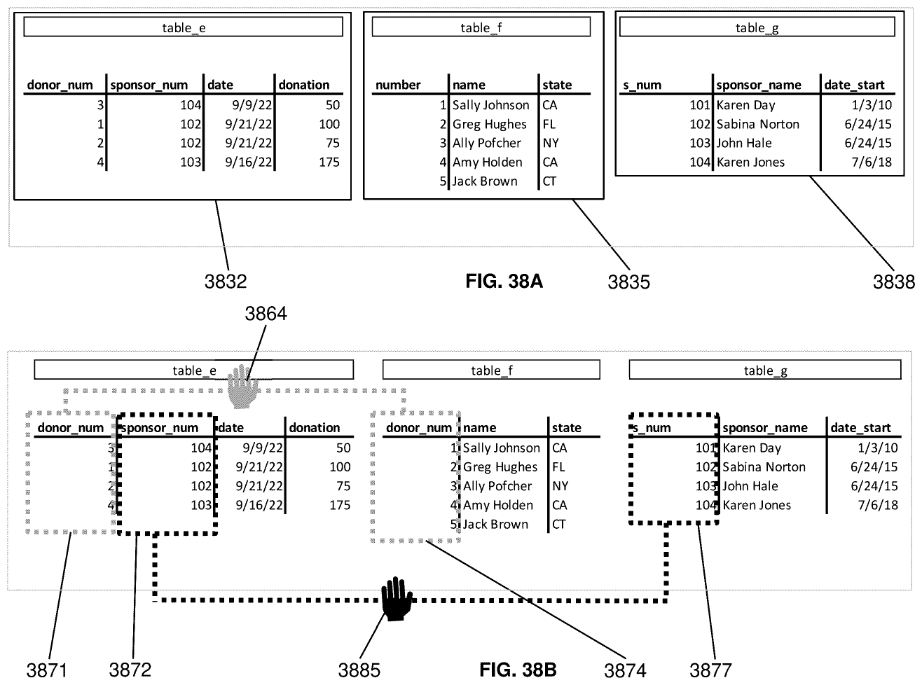

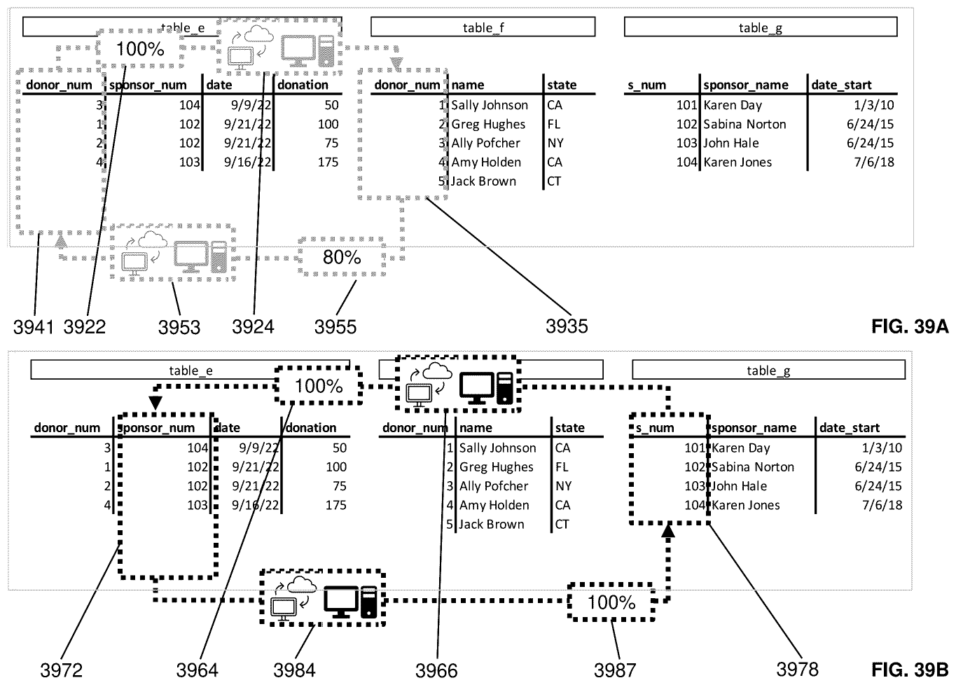

FIGS. 38A through 42B examples our technology chain/sequence joining three data sets within a visualizer chart. FIG. 38A examples three data sets ‘table_e’ 3832, ‘table_f’ 3835, and ‘table_g’ 3838. There could be more data sets, but we example these three because they are joinable and to keep it simple. Data sets ‘table_e’ 3832 and ‘table_f’ 3835 have potential join keys 3871/3874 and ‘table_e’ 3832 and ‘table_g’ 3838 have potential join keys 3872/3877 which are manually specified by the user 3864/3885 as exampled in FIG. 38B. That manual specification could then be qualification verified by our technology in one or more different embodiments along the lines previously discussed and exampled in FIG. 3. FIG. 39A and FIG. 39B illustratively examples those same two potential joins 3941/3935 and 3972/3978 being automatically generated, and qualification validated 3922/3955 and 3964/3987 on the user's computer, in the cloud or some combination of the two 3924/3953 and 3984/3966. The data types are the same for each join key pair, three of the four join keys are unique, and the values matches are all ‘80%’ or higher (as shown in 3922/3955/3964/3987), thus passing the one-way and two-way match requirements set for this embodiment (e.g., 75%). The auto started join flag qualification could be followed by a manual step or steps or be fully automated as previously described herein. Those setup and qualification validation actions could be done using any of the previously exampled appropriate UIs or other alternatives fulfilling the required actions.

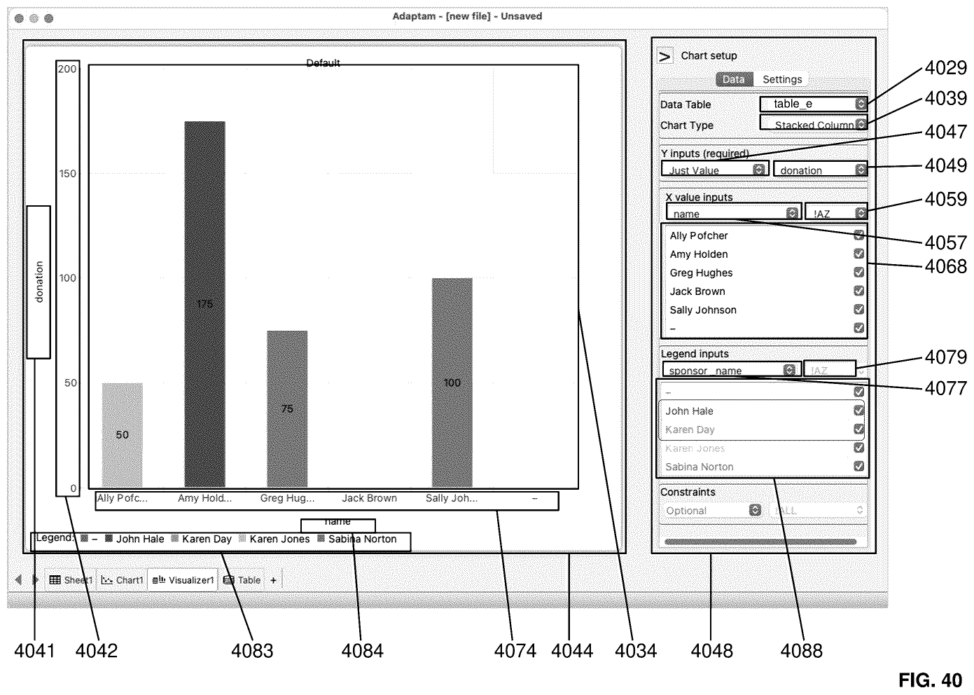

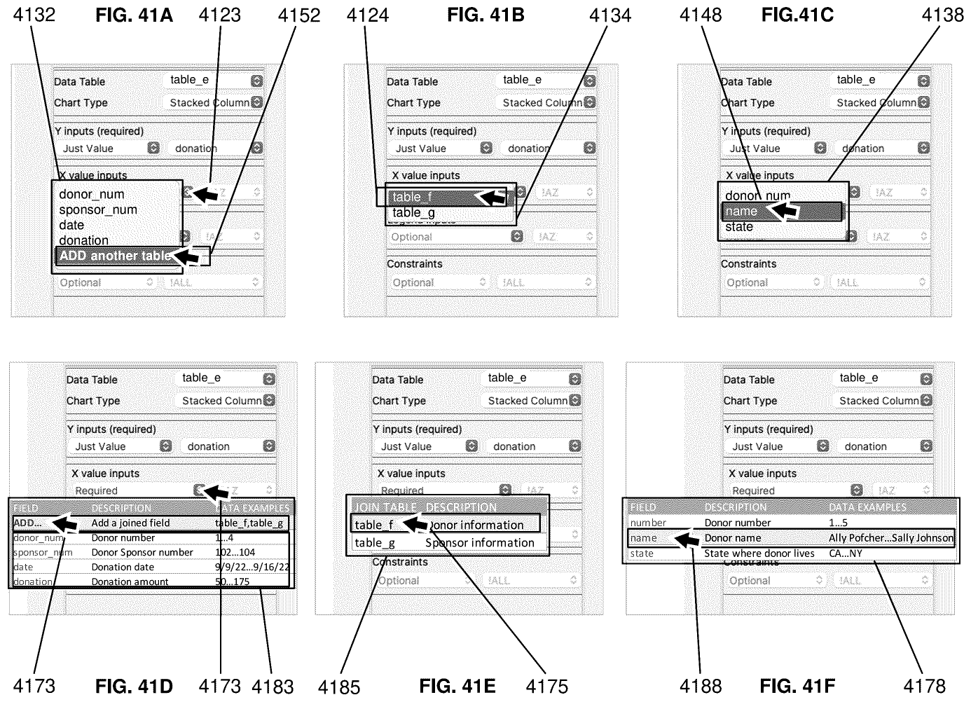

Using these data sets, our charity user would like to see a chart displaying the donations (i.e., the field ‘donation’ in ‘table_e’) by donor (i.e., the field/column ‘name’ in ‘table_f’) and by sponsor (i.e., the field/column ‘sponsor_name’ in’table_g’). To do so in this embodiment they start by selecting ‘Data Table’ ‘table_e’ 4029 in the visualizer inputs 4048 in FIG. 40. Then they would populate the ‘Chart Type’ in this example selecting ‘Stacked Columns’ 4039. Because they just want to see the donation values they then select ‘Just Value’ 4047 in the ‘Y inputs’. After that they populate ‘donation’ 4049 from ‘table_e’ 4029 and then they populate the ‘X value inputs’ with the field/column ‘name’ as shown in FIG. 40 4057. Because the data set joins illustratively exampled in FIG. 38B through FIG. 39B have set the join qualification flag before the visualizer chart (as previously exampled), in this embodiment they have access to all the joinable fields in the selection lists as exampled in FIG. 18B through FIG. 19E and FIG. 29B through FIG. 21E altered for displaying two joinable data sets. Alternatively, the selection lists can operate as exampled in FIG. 41A through FIG. 41F where there are intermediate table selections when accessing the joinable data sets. While the value of this is not apparent with these really small data sets, consider data sets with forty or more fields/columns at which point loading selection lists with over eighty or over one hundred and twenty fields/columns will make selection challenging. Therefore, the need for an interim table selection.

FIG. 41A through FIG. 41C example a joinable field sequence of selection dropdowns started by clicking the selection access button 4123 in FIG. 41A. That opens the dropdown 4132 which holds the appropriate fields/columns from ‘table_e’ and an ‘ADD another table’ 4152 selection. Which the user clicks to automatically open the table selection dropdown 4134 in FIG. 41B. There the user sees both data sets;‘table_f’ and ‘table_g’ that are joinable to ‘table_e’. The user selects ‘table_f’ 4124 to automatically open the dropdown 4138 in FIG. 41C. Here the user selects the field/column ‘name’ 4148 to populate a joined field/column into 4057 in FIG. 40. Another embodiment is exampled in FIG. 41D through FIG. 41F exampling the use of popups with more descriptive information to accomplish the same end result. The user starts again clicking the selection access button 4173 in FIG. 41D. That opens the popup 4183 which holds the appropriate fields/columns from ‘table_e’ and an’ADD . . . ’ line 4173 selection list with ‘DESCRIPTION’ and ‘DATA EXAMPLE’ information including the add tables ‘table_f’, table_g’. The user clicks that ‘ADD . . . ’ line 4173 to automatically open the table selection popup 4185 in FIG. 41E. There the user sees both data sets; ‘table_f’ and ‘table_g’ that are joinable to ‘table_e’ with a table’DESCRIPTION’. The user selects ‘table_f’ 4175 to automatically open the popup 4178 in FIG. 41F. Here the user selects the field/column ‘name’ 4188 to populate a joined field/column into 4057 in FIG. 40. While we could example other UI variations, in the interest of brevity we will return to finishing the exampling of FIG. 40.

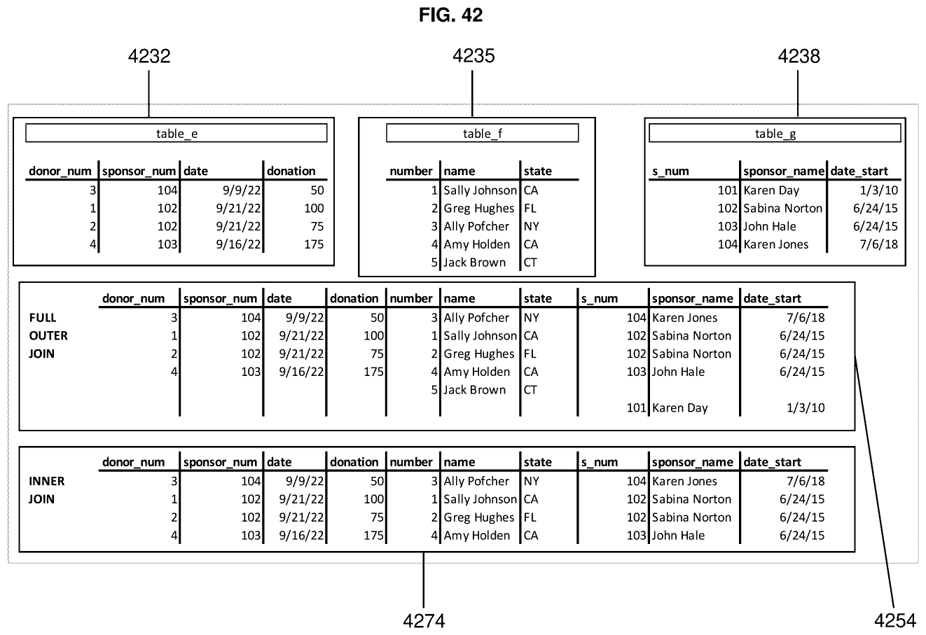

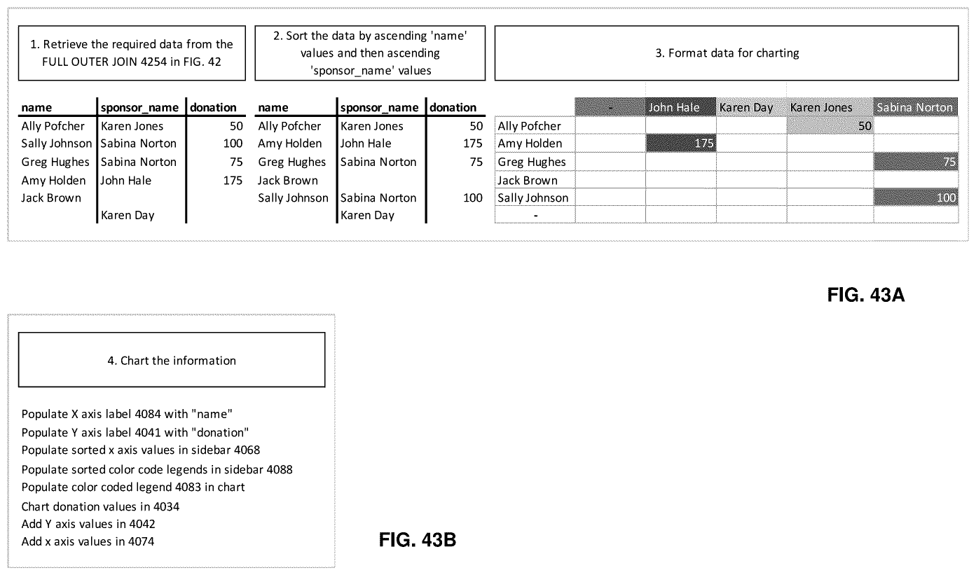

The user then specifies the legend input, ‘sponsor_name’ 4077, again using a joinable data selection list. For both the ‘X axis input’ and the ‘Legend inputs’ the user did not change the default ‘!AZ’ ascending sorts 4059 and 4079. Thus, the spreadsheet visualizer automatically generates the chart 4044 as exampled in the illustrative actions in FIG. 42 through FIG. 43B. Where in FIG. 42 our technology chain/sequence joins the three data sets ‘table_e’ 4232, ‘table_f’ 4235, and ‘table_g’ 4238 using a ‘FULL OUTER JOIN’ 4254 (although we could have used the ‘INNER JOIN’ 4274 or some other applicable SQL join). Then the joined data is used in the actions in FIG. 43A and FIG. 43B to generate the chart 4044 in FIG. 40.

In this embodiment the visualizer chart was generated without the user needing to set up any joins within the visualizer chart because of the pre-qualified join flag (and the capabilities it supports) providing the user with joinable data selection lists. The use of those lists, or the user typing the joinable fields, results in the chain/sequence joining of data from three data sets to generate the visualizer chart. This embodiment has no visible join arguments in the chart inputs, although another embodiment of our technology automatically provides visible arguments as described later herein. This example used a ‘Stacked Column’ 4039 chart, although our technology supports all types of spreadsheet charts. For ease of understanding and brevity's sake we are using a sidebar 4038 input Visualizer chart in a visualizer tab although our technology supports the broad spectrum of chart input approaches and locations of the visualizer charts such as those in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021. We will not example our technology supporting chain/sequence joins involving data sets joined with other data modelling cardinalities.

### Three or More Data Set Joins Involving all Unique to Non-Unique Joins

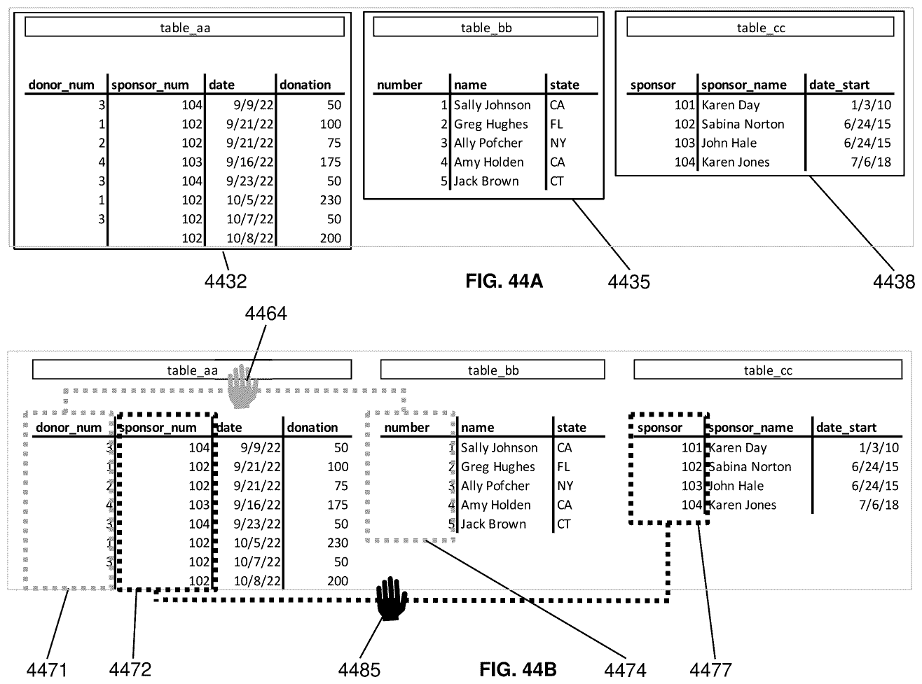

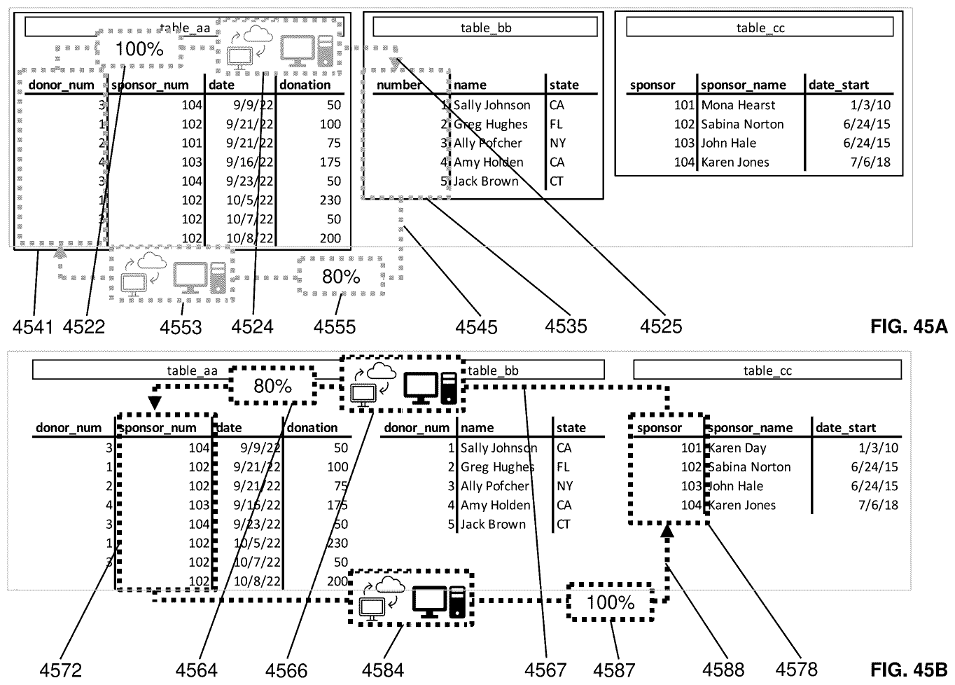

FIG. 44A examples three data sets ‘table_aa’ 4432, ‘table_bb’ 4435, and ‘table_cc’ 4438. There could be more data sets available to the user, but we example these three because they are joinable. Tables ‘table_aa’ 4432 and ‘table_bb’ 4435 have potential join keys 4471/4474 in FIG. 44B where join key ‘donor_num’ 4471 is non-unique and ‘number’ 4474 is unique. Tables ‘table_aa’ 4432 and ‘table_cc’ 4438 have potential join keys 4472/4477 in FIG. 44B where join key ‘sponsor_num’ 4472 is non-unique and ‘sponsor’ 4477 is unique. In FIG. 44B these join key pairs are manually specified by the user 4464/4485. That manual specification could then be verified by our technology in one or more different embodiments along the lines previously discussed and exampled in FIG. 3. FIG. 45A and FIG. 45B illustratively examples those same two potential joins 4541/4535 and 4572/4578 being automatically generated, and qualification validated (4522/4555 and 4564/4587) on the user's computer, in the cloud or some combination of the two as illustrated in 4524/4553 and 4584/4566. The data types are the same for each join key pair, all the join key pairs are data modelling cardinality unique to non-unique, and the values matches are all ‘80%’ or higher (as shown in 4522/4555/4564/4587), thus passing the data type match, data modelling cardinality, one-way and two-way data values match (e.g., 75%) requirements set for this embodiment. Those setup and validation actions could be done using any of the previously exampled appropriate UIs or alternatives and could be fully automatic or semi-automatic with a last qualification by a user or our automated validation.

With the qualification flags set prior to the visualizer chart, the user now has data sets with the potential for multiple unique to non-unique data set chained/sequences joins. The user would like to chart the total donations (‘SUM(donation)’ for each sponsor (‘sponsor_name’) and by which state the donor was from (‘state). They are going to do this using a FULL OUTER JOIN so that no data is eliminated in the process of the joins, which is easily done in our technology as we support all the join types.

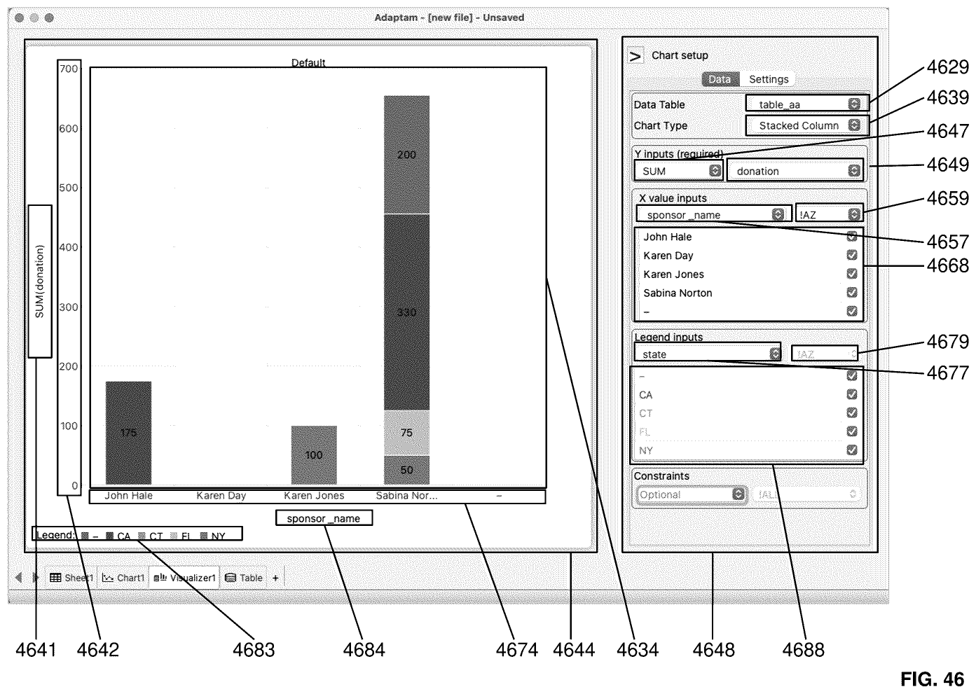

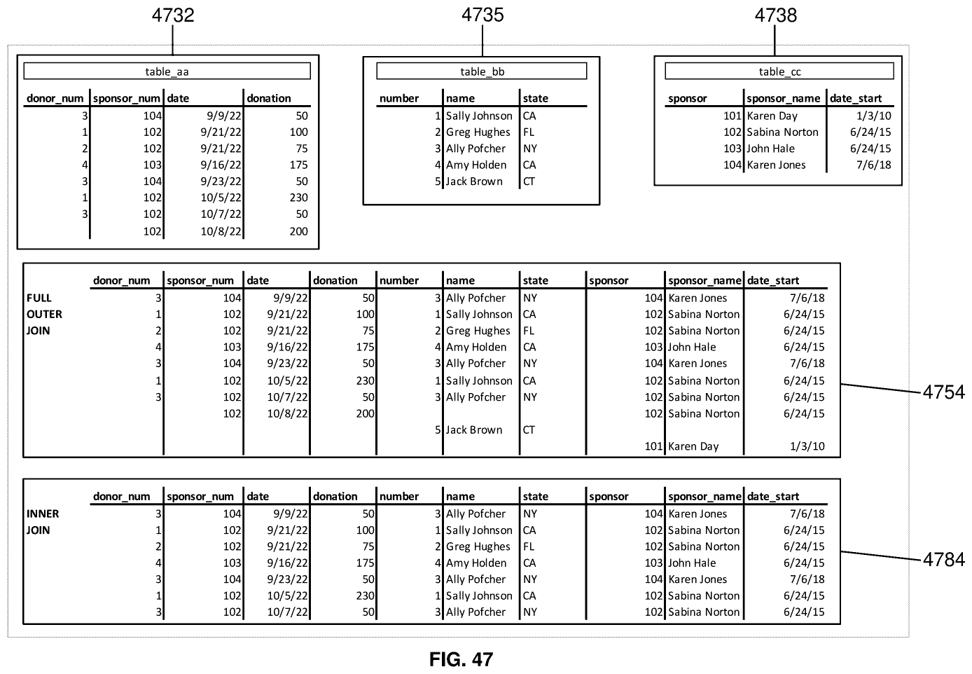

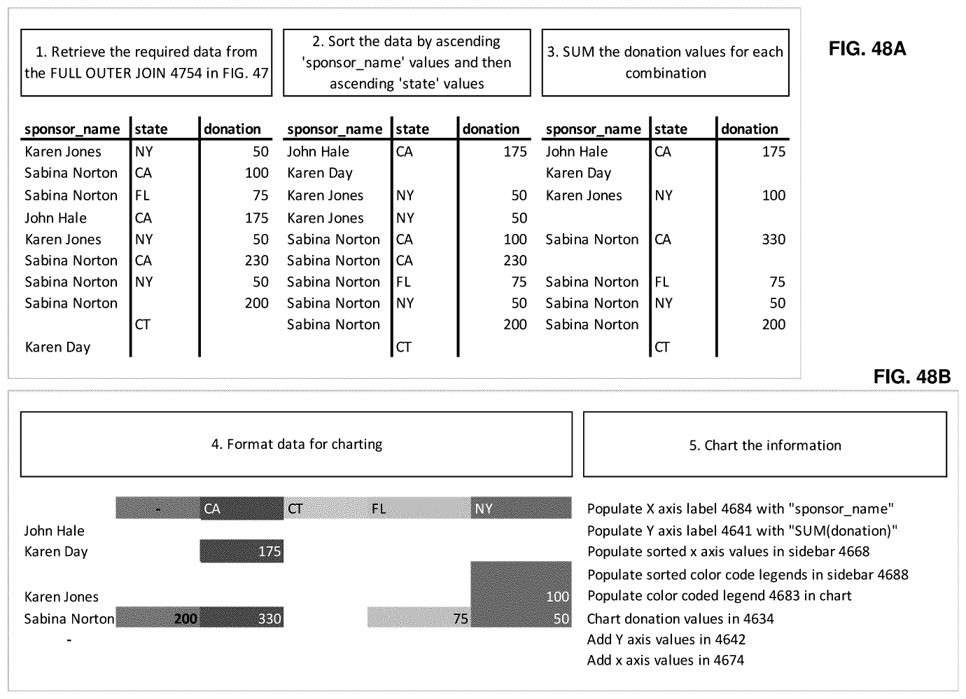

In FIG. 46 they start by selecting ‘Data Table’ ‘table_aa’ 4629 in the visualizer chart setup 4648. Next, they select a ‘Chart Type’ of ‘Stacked Column’ 4639. They then select the function ‘SUM’ 4647 in the ‘Y inputs’. When they open the field selector to populate ‘donation’ 4649 because the join qualification flags have been already set, they see the numeric fields (SUM limited) for ‘table_aa’ 4629 and the joinable numeric fields from data sets ‘table_bb’ and’table_cc’ in a selection list like any of the appropriate ones exampled in FIG. 41A through FIG. 41F, FIG. 18B through FIG. 19E, and FIG. 21B through FIG. 21E. In this situation they select or type the field/column ‘donation’ 4649 without needing to go to the joinable fields/columns. However, when the specify next the ‘X axis inputs’ of ‘sponsor_name’ 4657 they use the joinable data fields/columns in the selector lists, as they do when they specify the ‘Legend inputs’ of ‘state’ 4677 where they again use the joinable fields/columns in the selector lists. As they were fine with the default sort orders (4659 and 4679) for both the ‘X axis inputs’ and the ‘Legend inputs’ they are done and happy with the automatically generated chart 4644 and the ‘X axis’ values 4668 and the ‘Legend’ values 4688 populated in the sidebar Visualizer chart setup 4648. The chart and the values are automatically generated by our technology as illustratively exampled in FIG. 47 through FIG. 48B. Where in FIG. 47 our technology chain/sequence joins the three data sets ‘table_aa’ 4732, ‘table_bb’ 4735, and ‘table_cc’ 4738 using a ‘FULL OUTER JOIN’ 4754 (although we could have used the ‘INNER JOIN’ 4784 or some other applicable SQL join). Then the joined data is used in the actions in FIG. 48A and FIG. 48B to generate the chart 4644 in FIG. 46 and populate the ‘X axis’ values 4668 and the ‘Legend’ values 4688 in the sidebar 4648. This embodiment with its pre-qualified join flags executes the joins with no visible join arguments.

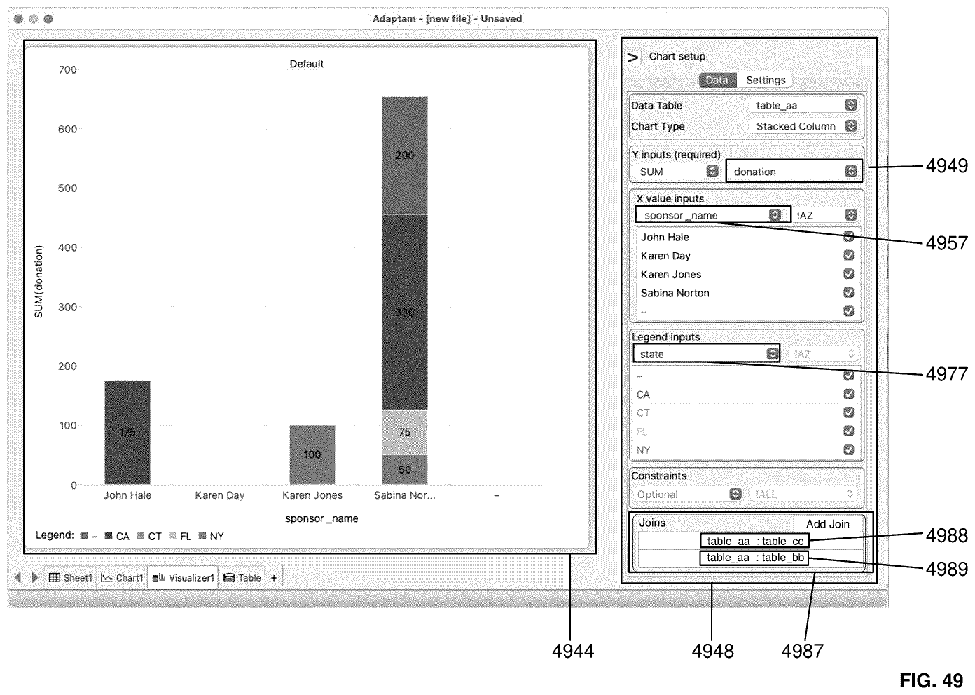

A slightly different embodiment exampled in FIG. 49 automatically populates a visible join argument for each join as it is used. The first join argument ‘table_aa:table_cc’ 4988 is populated with the specification of the ‘field/column’ ‘donation’ 4949 (which is in ‘table_aa’) followed by the ‘field/column’ ’sponsor_name’ 4957 (which is in ‘table_cc’). That triggers the first join. When the user then adds the ‘field/column’ ‘state’ 4977 (which is in ‘table bb’) that triggers the second join as well as the chained/sequence join of the three data sets and automatically populates the ‘table_aa:table_bb’ 4989 join argument in the ‘Join’ section 4987 of the sidebar 4948. In this embodiment the join argument is telling the user only of the join between the data sets although it could support a click open on each of the arguments (4988 and 4989) to show more detailed join information, as exampled in FIG. 14B, and/or the option to change the join. In that embodiment it could open a join UI like that in FIG. 8. Note, in this embodiment the join specifier panel is within the visualizer input panel but in other embodiments it could be situated elsewhere, for example within the chart panel or in a separate panel whose visibility is not tied to the visibility of the visualizer input panel.

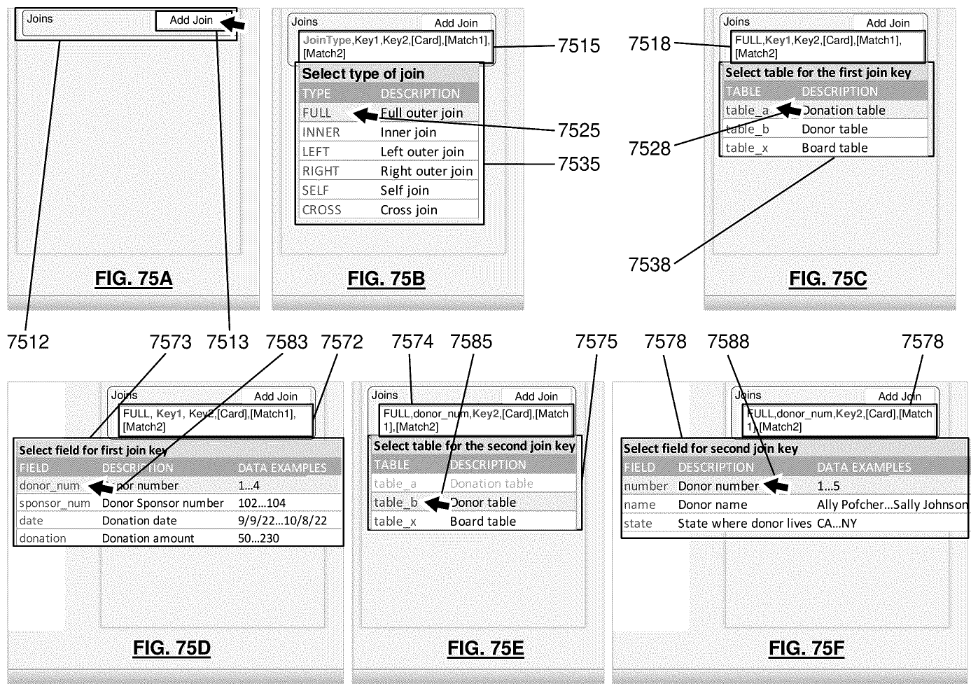

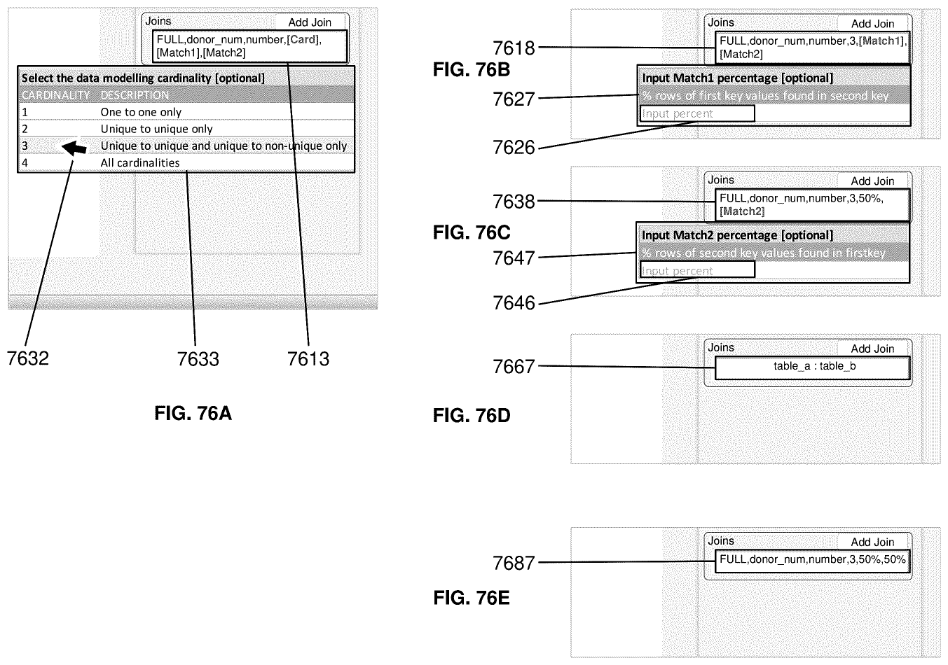

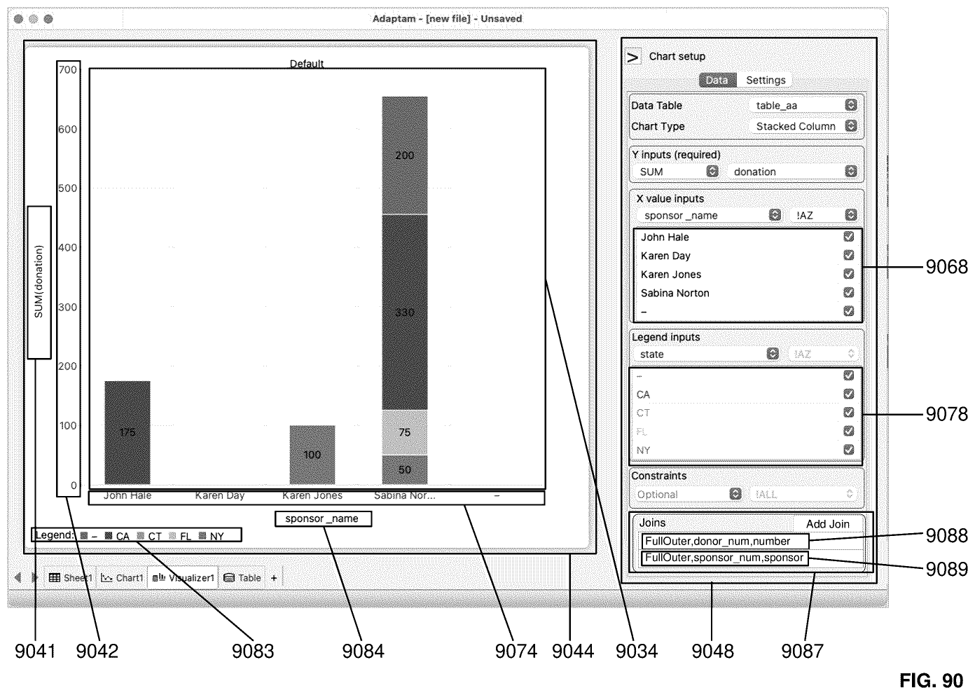

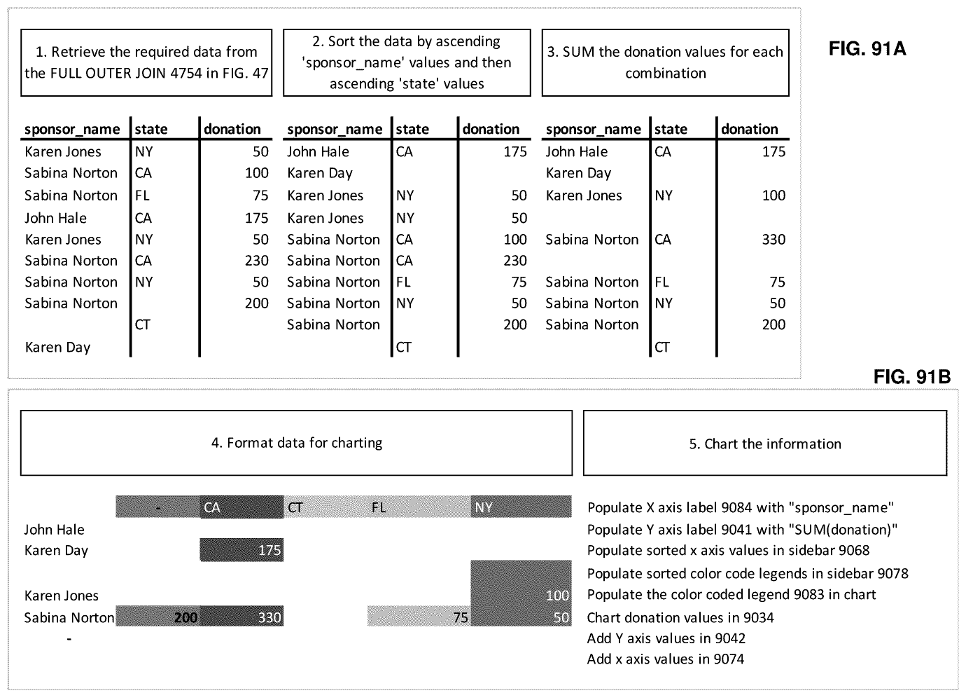

A substantially different embodiment delivering the same chart as FIG. 49 and FIG. 46 is exampled in FIG. 90. FIG. 90 examples a situation where the user has no joins qualified before the visualizer and instead sets up the joins in a join specifier 9087 within the visualizer input panel 9048. Those joins are setup with the assistance of data set, data set field and other join requirements selection lists (when applicable) exampled in FIG. 75B through FIG. 76C (described in detail later). In this example using them twice, one for each join, 9088 and 9089. FIG. 90 examples a very basic join specification for each join with a first argument that specifies the join type and a second and third argument that specifies the join keys (with no need for data set specifications because the join key fields are unique and therefore specify the data set). The specification of the two joins, 9088 and 9089, then automatically chains/sequences the joins as exampled in FIG. 47. In this embodiment, once the joins are specified in the join specifier the joinable fields, including the chain/sequence joined fields, are enabled in the table/field selection lists as exampled in FIG. 18B through FIG. 19E, FIG. 20B through FIG. 21E, and FIG. 41A through FIG. 41F. And once the minimum visualizer chart requirements are fulfilled or the user fills in further visualizer inputs the sequence/chain joined visualizer chart is automatically delivered by the illustrative actions exampled in FIG. 91A and FIG. 91B to deliver the chart 9044 in FIG. 90.

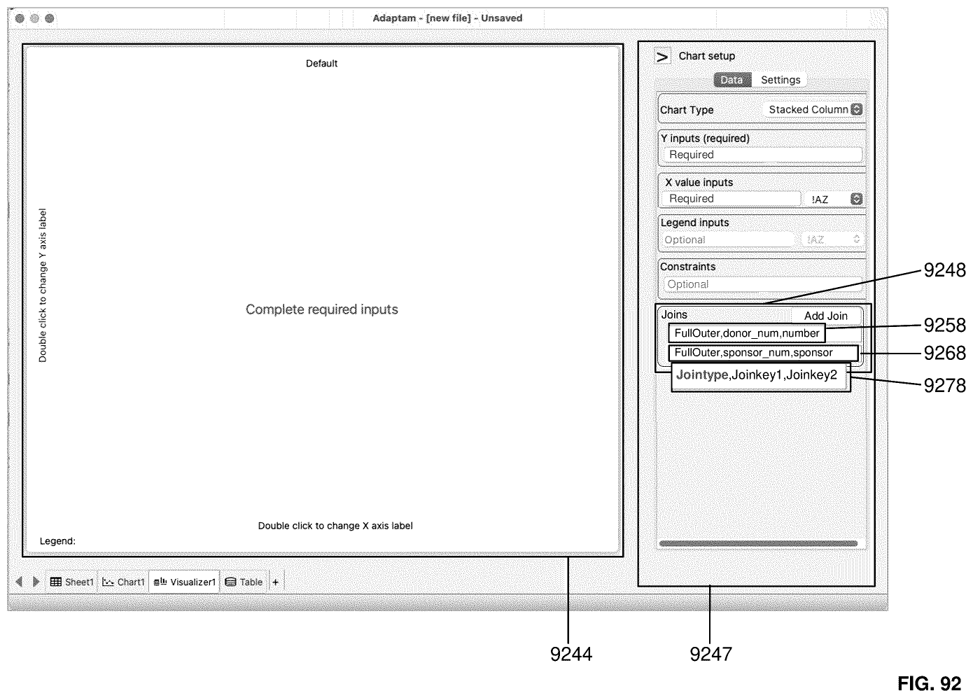

FIG. 92 through FIG. 94B example the even less selection list supported variant of our chained/sequenced join technology with no prequalified (before this visualizer) joins. In FIG. 92 the user knows that the chart they want will use data from using the three data sets ‘table_aa’ 4732, ‘table_bb’ 4735 and ‘table_cc’ 4738 in FIG. 47, and types the joins:
‘FullOuter,donor_num,number’ 9258
‘FullOuter,sponsor_num,sponsor’ 9258

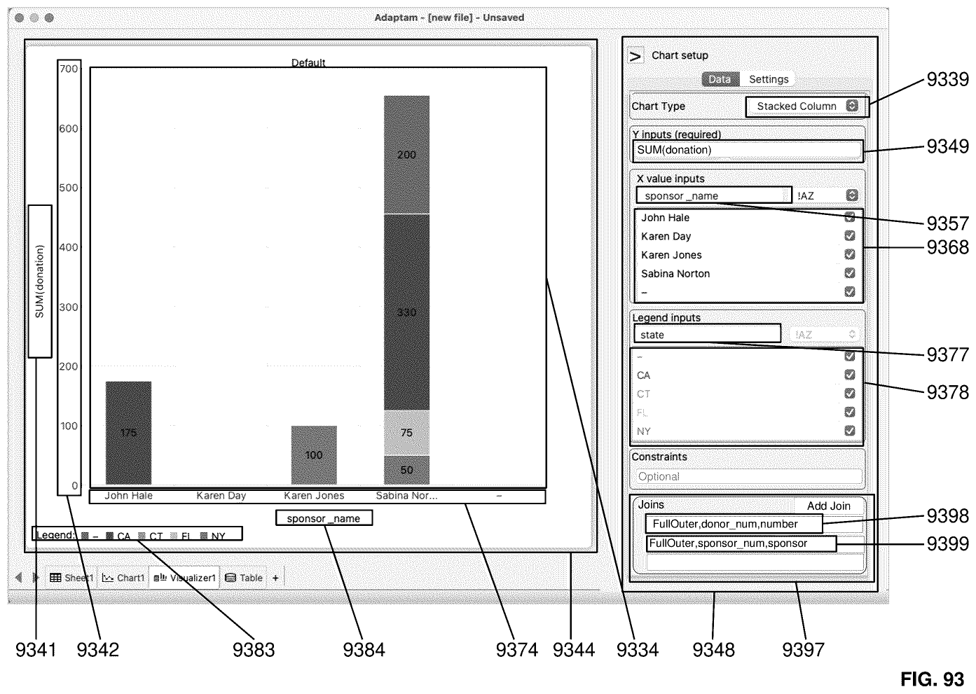

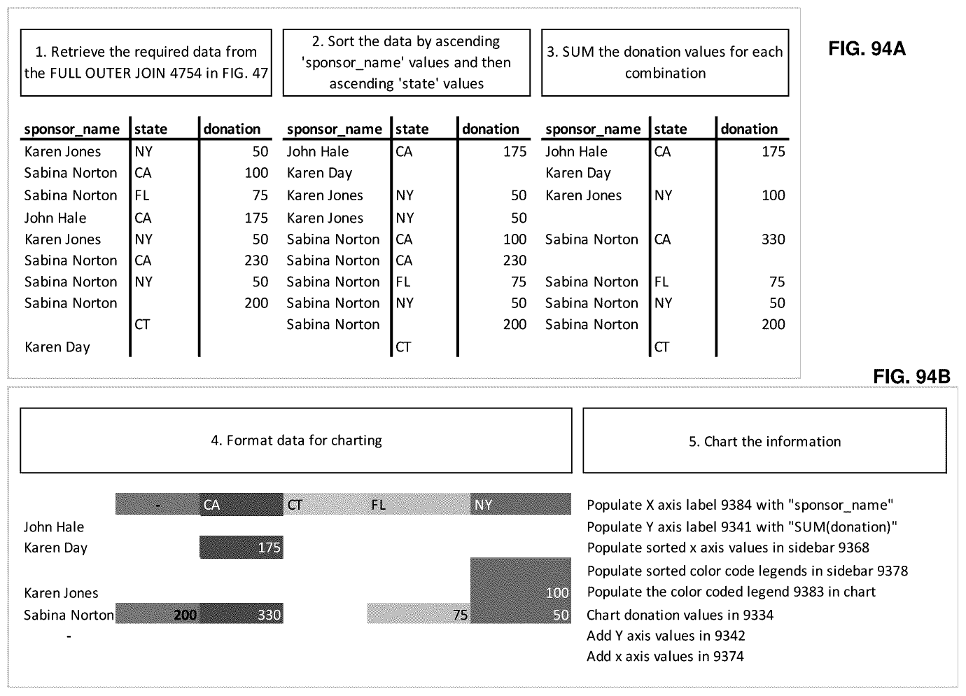

They do this following the typical spreadsheet syntax guide for populating arguments 9278 which tells them what they must input, the Join type, the first join key field/column and the second join key field/column. This is done in an embodiment with unique field/column names however if that were not the case then table name inputs or some other unique specifier would be added. It is done in an embodiment where the join specifier panel 9248 is within the visualizer input panel 9248. However, in different embodiments with different visualizer UIs, as exampled in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021 the different input panels could be in different places with different UIs. Once the user hits ENTER/RETURN our technology automatically supports both of the specified joins and the chained/sequenced join between the three tables. Thus. When the user types into the visualizer input panel 9348 the ‘Y inputs’ ‘SUM(donation)’ 9349, the ‘X value inputs’ ‘sponsor_name’ 9357 and the ‘Legend inputs’ ‘state’ 9377 our technology automatically executes the chained/sequenced ‘FullOuter’ join 4754 illustratively exampled in FIG. 47 but then does the actions illustratively exampled in FIG. 94A and FIG. 94B to generate the chart panel output 9344 in FIG. 93.

As exampled for two table joins, our three or more chained/sequenced data set joins can set qualification flags for the visualizer selection lists and charts for all the different data modelling cardinalities and combinations (e.g., one to one, unique to non-unique and non-unique to non-unique), as well as different value matches (e.g., one-way and/or two-way at different must exceed match percentages). Those qualification flags can differ for the selection lists and the charts, as discussed before. We have already exampled this limitation of selection lists to exclude non-unique to non-unique join key pair joins (i.e., accepting only unique to unique and unique to non-unique) and will now example a specialized situation of that qualification test that does not occur for a two dataset join but occurs in three or more data set chained/sequenced joins.

### Three or More Data Set Joins Situational Selection List Potential Joins

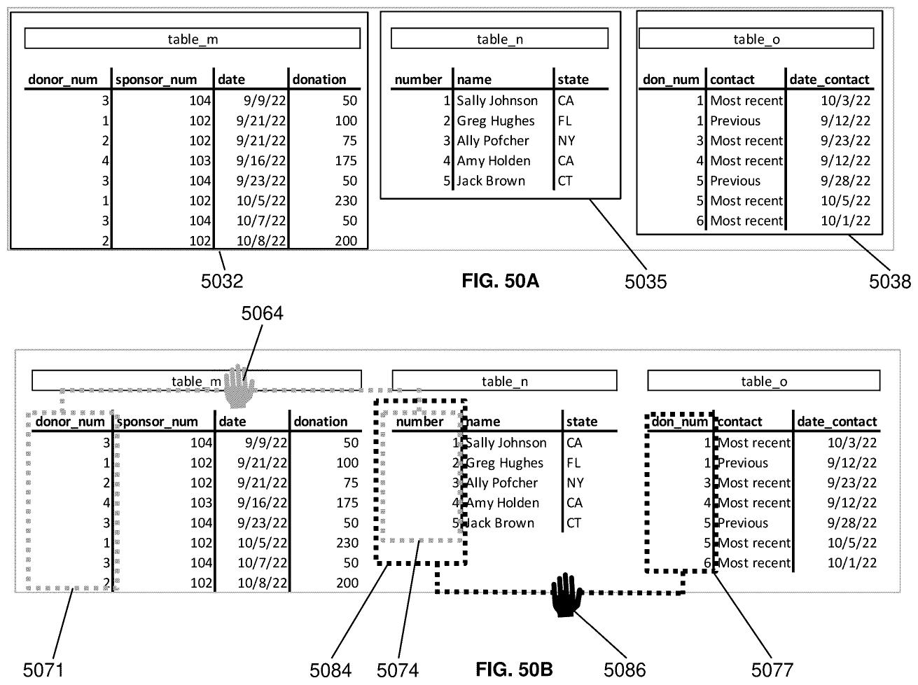

FIG. 50A through FIG. 54 examples a situation that does not occur in two data set joins but does occur in three or more data set chained/sequenced joins, where the combination turns unique to non-unique join key pair joins into chained/sequenced non-unique to non-unique join key pair joins. Therefore, an embodiment of our selection lists can initially offer two potential table joins for a data set but once one of the fields from one of the joins is populated in the visualizer the option to join the other data set goes away. Embodiments supported by our technology then can differ in what they do for example one can generate an error if the user goes ahead and populates a field from the third data set and another embodiment can allow the user to complete the chained/sequenced join and populate the field in the formula for a successful chained/sequenced join use. In the later embodiment making it such that a manual override by typing a field from the data set accesses the fact that the selection list and the visualizer chart creation have different qualification requirements, e.g., the selection list accepts only data modelling cardinalities of unique to unique and unique to non-unique, but the chart generation accepts all data modelling cardinalities therefore including non-unique to non-unique.

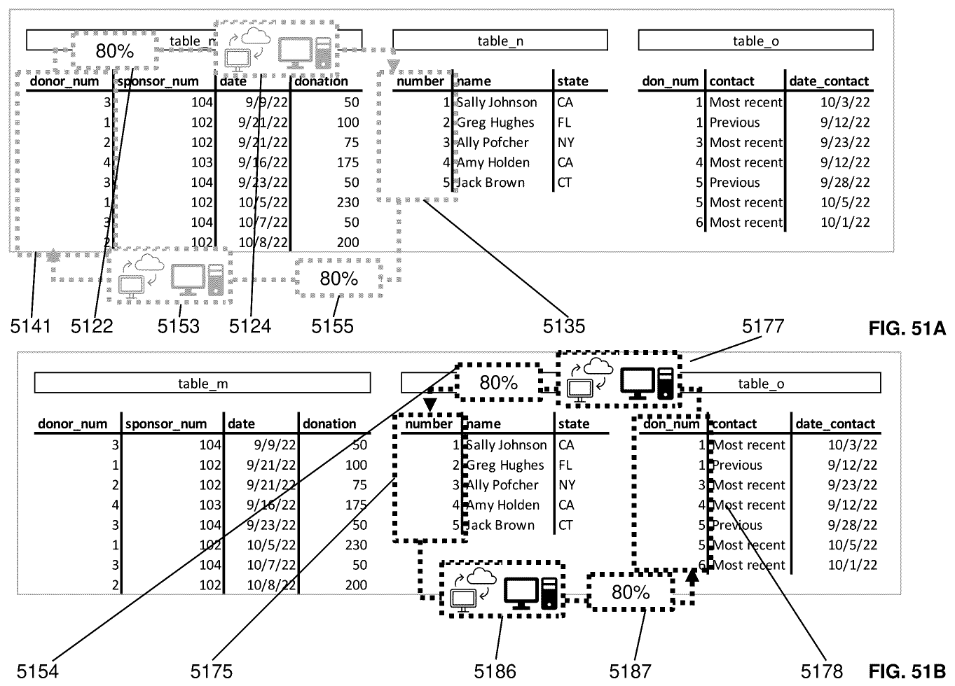

FIG. 50A examples three data sets ‘table_m’ 5032, ‘table_n’ 5035, and ‘table_o’ 5038. There could be more data sets available to the user, but we example these three because they are joinable to each other. The data sets ‘table_m’ 5032 and ‘table_n’ 5035 have potential join keys 5071/5074 in FIG. 50B where join key ‘donor_num’ 5071 is non-unique and ‘number’ 5074 is unique. The ‘table_n’ 5035 and ‘table_o’ 5038 have potential join keys 5084/5077 in FIG. 50B where join key ‘don_num’ 5077 is non-unique and ‘number’ 5084 is unique. In FIG. 50B these join key pairs are manually specified by the user 5064/5086. That manual specification could then be verified by our technology in one or more different embodiments along the lines previously discussed and exampled in FIG. 3. FIG. 51A and FIG. 51B illustratively examples those same two potential joins 5141/5135 and 5175/5178 being automatically generated, and qualification validated (5122/5155 and 5154/5187) on the user's computer, in the cloud or some combination of the two 5124/5153 and 5177/5186. The data types are the same for each join key pair, all the join key pairs are unique to non-unique, and the values matches are all ‘80%’ (as shown in 5122/5155/5154/5187), thus passing the one-way and two-way match requirements set for this embodiment (e.g., 75% but they could have been>0%). Those setup and qualification validation actions could be done using any of the previously exampled appropriate UIs or alternatives in our spreadsheet application or a separate data intake tool. They could be done fully automatic or semi-automatic or multiple combinations with a user or our application making the final determination on the joins.

The user now has qualification flag set for both unique to non-unique data set joins before the visualizer chart. In this embodiment that pre visualizer input qualification flag setting supports selection lists and charts that are unique to unique and unique to non-unique joins but not non-unique to non-unique joins. The situation in this example is while both individual joins are unique to non-unique when they are chained/sequenced that join is a non-unique to non-unique. Therefore, in this embodiment our technology does not support that chained/sequenced for either selection lists or successful chart generation. The rationale for this qualification setting is as previously stated, to protect the unsophisticated user from partial Cartesian Products created in the join as exampled in the duplication of some of the rows (e.g., FIG. 5) that can distort values such as the total amount of donations.

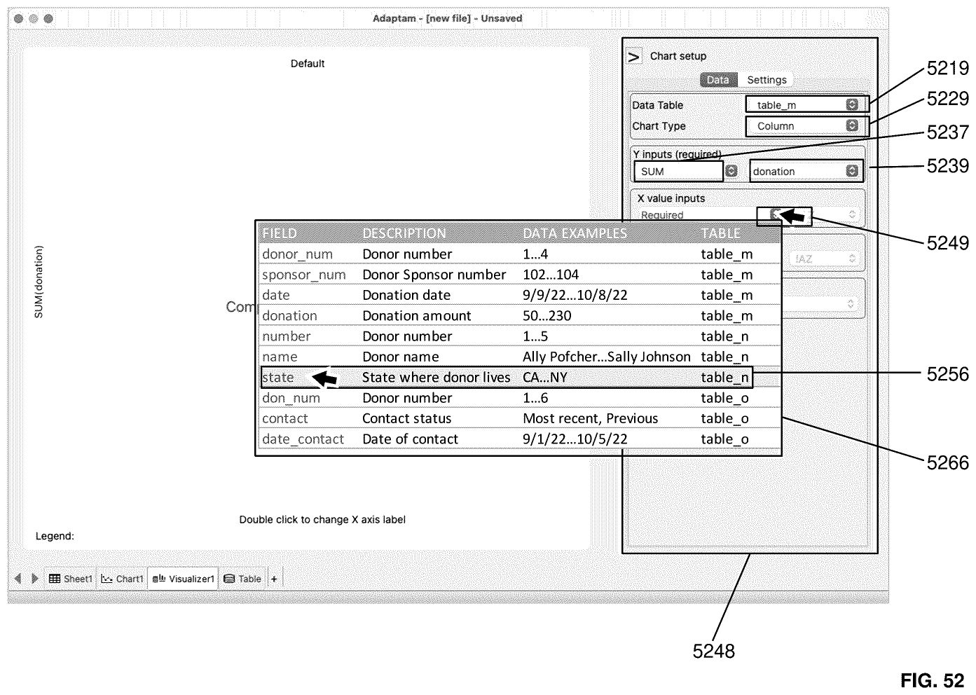

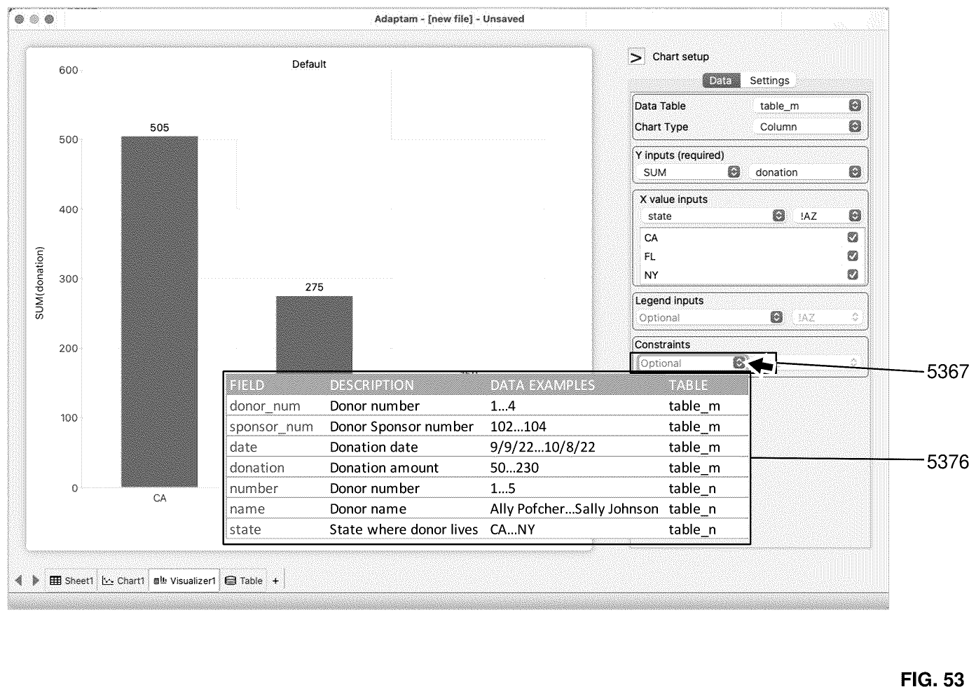

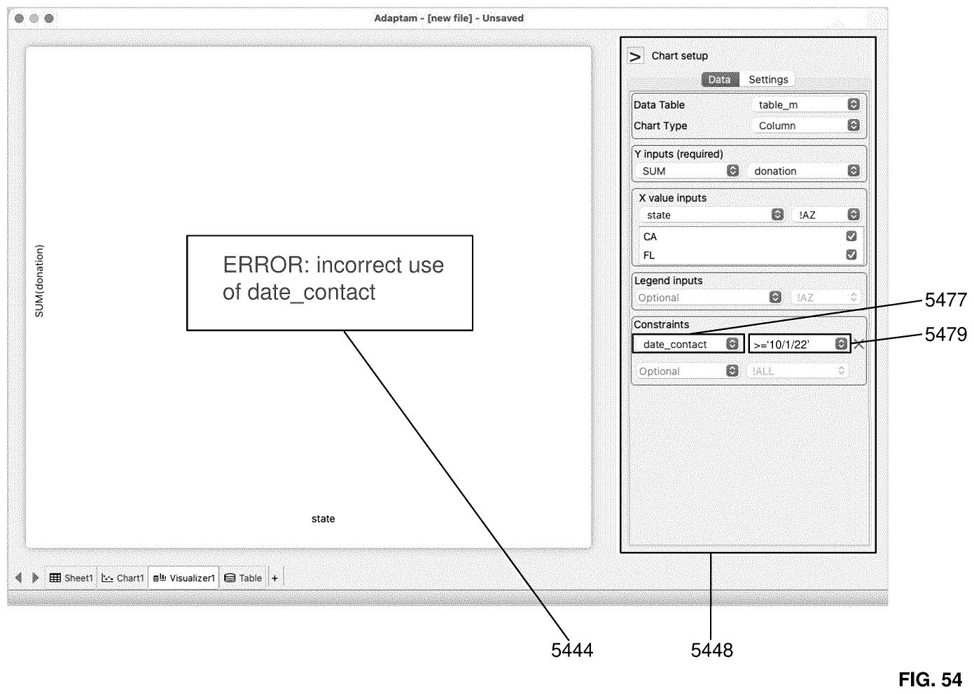

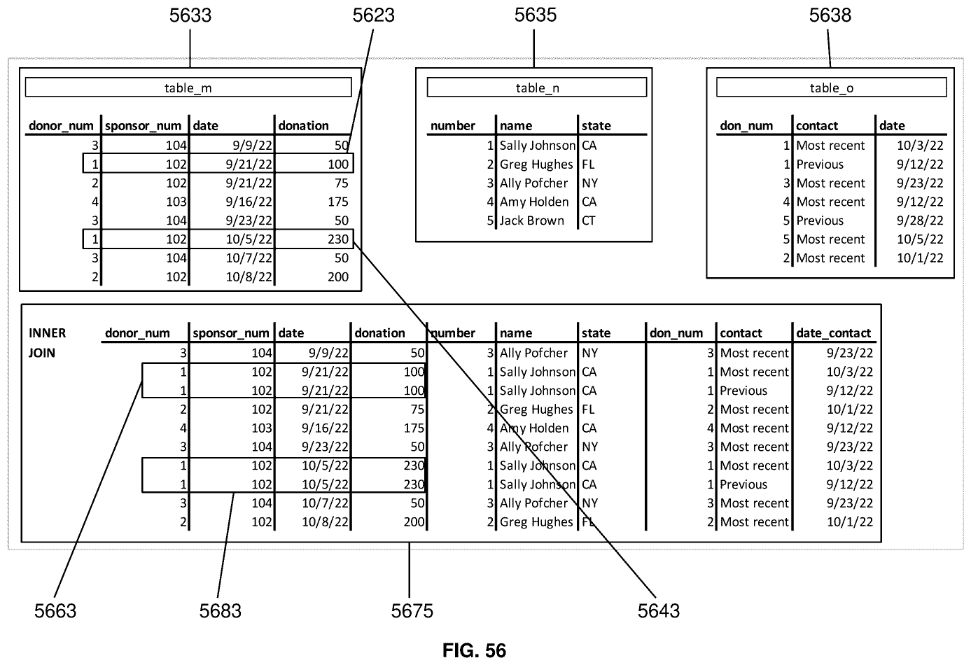

The way this works in our applications is exampled in FIG. 52 through FIG. 54 although the selection lists could have been any of the applicable ones described, exampled or referenced herein. The charity user wants to chart the total donations by state for each donor contacted on or after ‘10/1/22’. In FIG. 52 the user has started the process in the visualizer sidebar 5248 by selecting a ‘Data Table’ ‘table_m’ 5219 for a ‘Chart Type’ ‘Column’ 5229 with a ‘Y inputs’ of ‘SUM’ 5237 and ‘donation’ 5239. When the user clicks 5249 the ‘X value inputs’ they get in this embodiment a popup 5266 displaying all the joinable data fields/columns for ‘table_m’, ‘table_n’ and’table_o’. So, all three data sets. The user then selects (clicks) 5256 the field/column ‘state’ to populate the chart in FIG. 53. However, because of the qualification flag set limitation of no non-unique to non-unique cardinality joins (only unique to unique and unique to non-unique), when they open the next input 5367 (in this example a constraint) the selection list 5376 they get has only fields/columns from ‘table_m’ and’table_n’. There are no fields/columns from ‘table_o’ because the chained/sequenced join that would add ‘table_o’ creates a non-unique to non-unique cardinality (as exampled in FIG. 56 by the duplication of rows in 5663 and 5683 versus 5623 and 5643, respectively). Here our technology is protecting an unsophisticated user from a partial Cartesian Product join. And if in this embodiment they proceed to force in the usage of a field/column from ‘table_o’, as they did in the inputs 5477 and 5479 in FIG. 54, they are rewarded with an ‘ERROR; message 5444 instead of a chart. Note, that error message could have also explained that ‘date_contact’ is not joinable to ‘state’ and ‘donation’.

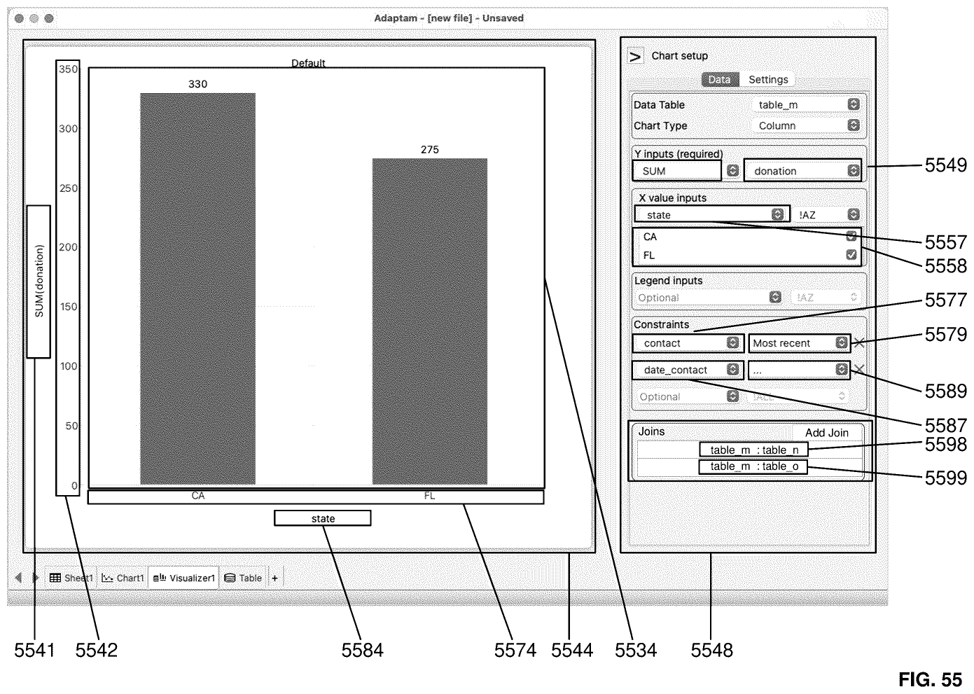

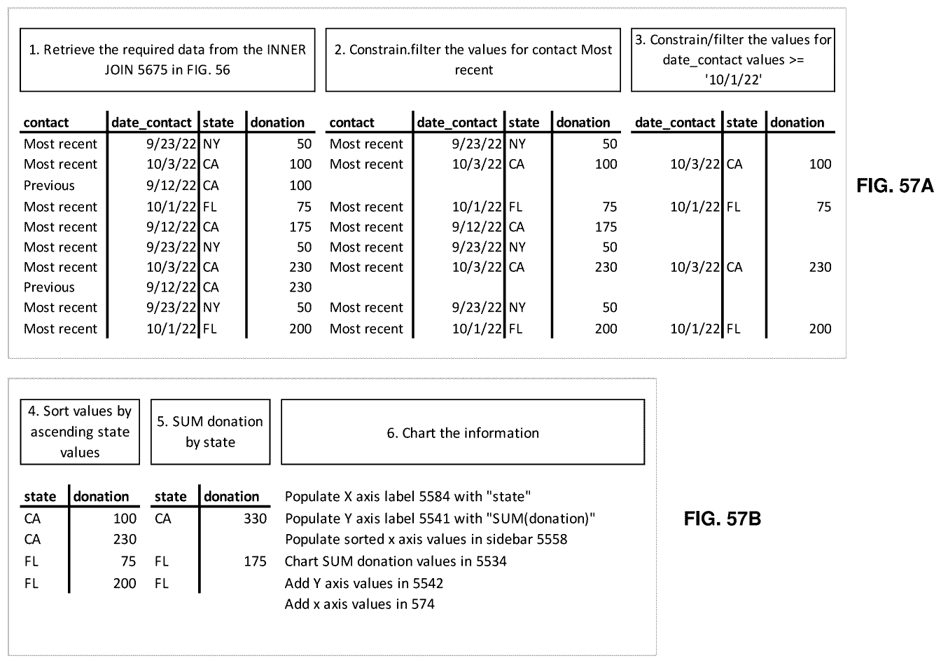

However, in another embodiment where the user is given a within the visualizer way to add or change a join then the user can alter the cardinality rule of the existing joins or add a new join using UIs like the ones exampled herein for setting joins and the cardinality rules (e.g., FIG. 14B). Thus, with a cardinality setting that accepts non-unique to non-unique joins, as was accomplished in FIG. 55 with the join add/change designators 5598 and 5599 in the visualizer input 5548 in this embodiment, the non-unique to non-unique chained/sequenced join works generating the visualizer chart 5544. Embodiments can also enable availability of the selection list like the list 5266 in FIG. 52 that includes ‘table_o’ fields/columns is enabled for populating inputs after 5549 and 5557 that would then create a non-unique to non-unique join with the inputs in 5577/5579 and 5587/5589. This enables the chained/sequenced join illustrated in FIG. 56 that then supports the actions in FIG. 57A and FIG. 57B to deliver the chart 5444 in FIG. 55.

These chain/sequenced join cardinality issues can occur in chains/sequences with more than two joins, but the principals of how our technology works remains the same. Therefore, for brevity's sake we will move on to exampling our technology charting substantially more complicated Y input calculations for more data sets chain/sequence joined.

### More Complicated Y Input Formula and More Joins

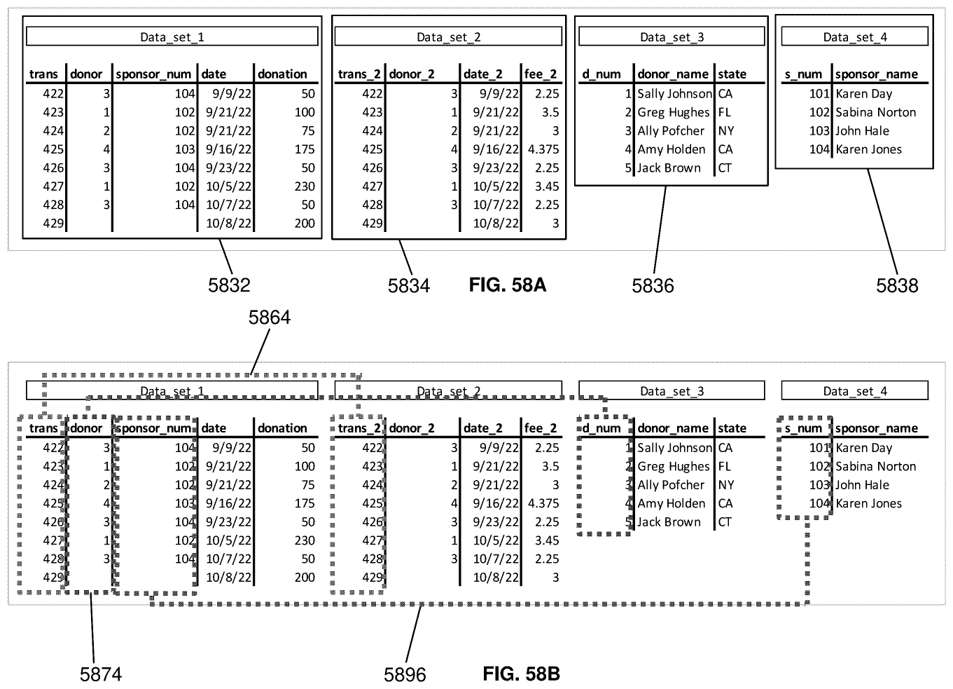

FIG. 58A through FIG. 62B examples our spreadsheet visualizer charting a more complicated formula with multiple functions and algebraic operators employing chained/sequenced joins of four different data sets, 5832, 5834, 5836, and 5838 in FIG. 58A, employing the join keys 5864, 5874, and 5896 illustratively exampled in FIG. 58B.

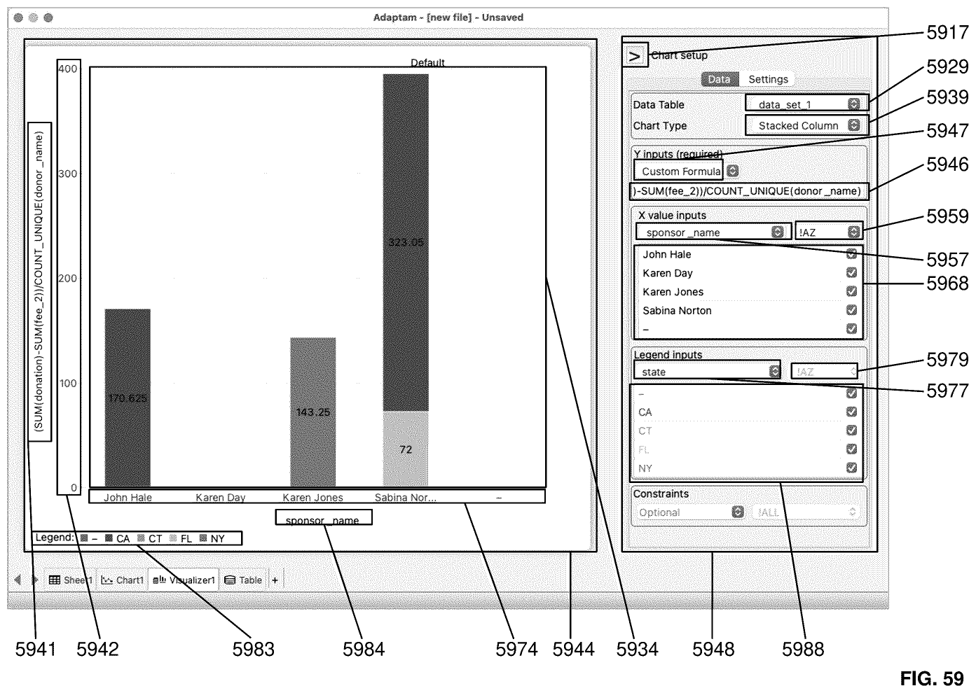

In FIG. 59 the charity user wants to chart the net average donations per donor per sponsor broken by the state where the donor resided. They start by selecting ‘data_set_1’ 5929 in the Visualizer input sidebar 5948. Next, they select a ‘chart Type’ of ‘Stacked Column’ 5939. They then select the function ‘Custom formula’ 5947 in the ‘Y inputs’. This opens up the custom formula box 5946 where because the data sets have been pre-qualified (i.e., qualification flag set) before the visualizer. The user is then aided by selection lists not shown here displaying (directly or via stepwise access) all the joinable data (similar to with more tables FIG. 41A through FIG. 41F, FIG. 18B through FIG. 19E, and FIG. 29B through FIG. 21E). In this example giving access to data fields/columns from the four data sets (5832, 5834, 5836, and 5838 exampled in FIG. 58A). They then type and/or select a more complicated formula:
(SUM(donation)-SUM(fee_2))/COUNT_TEXT_UNIQUE(donor_name) 5946.

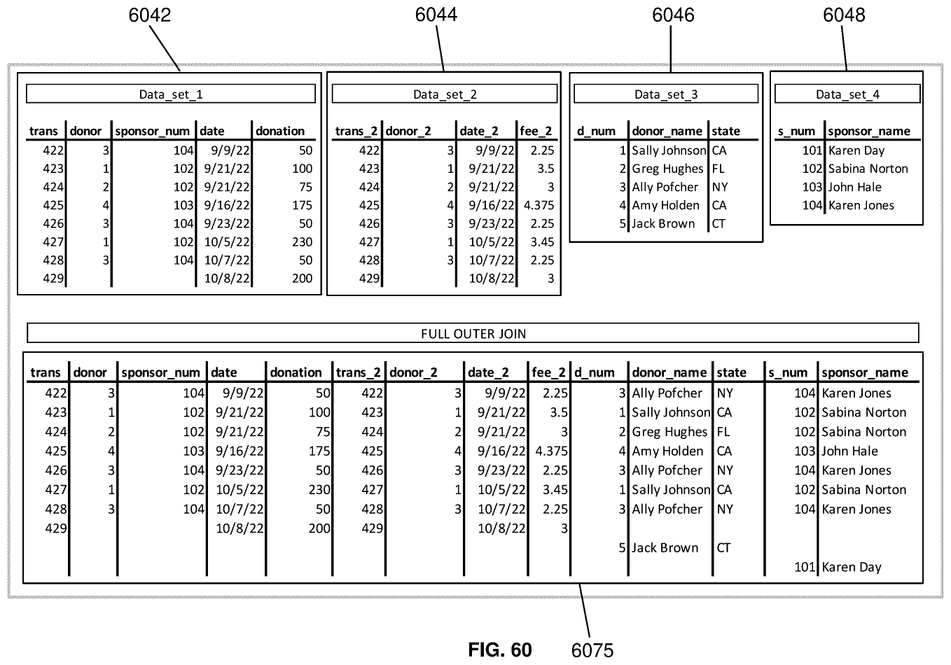

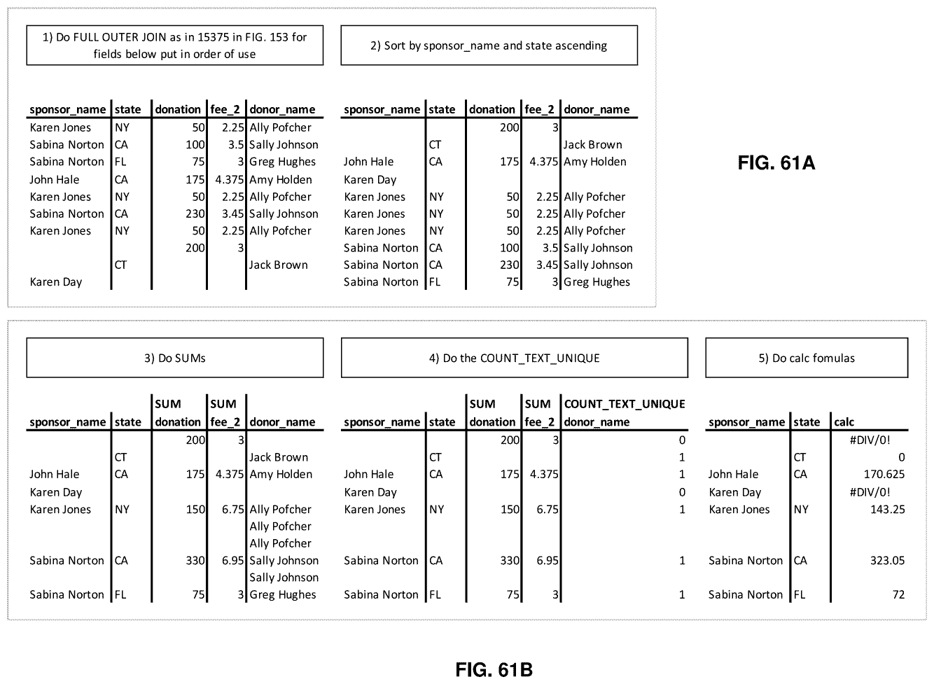

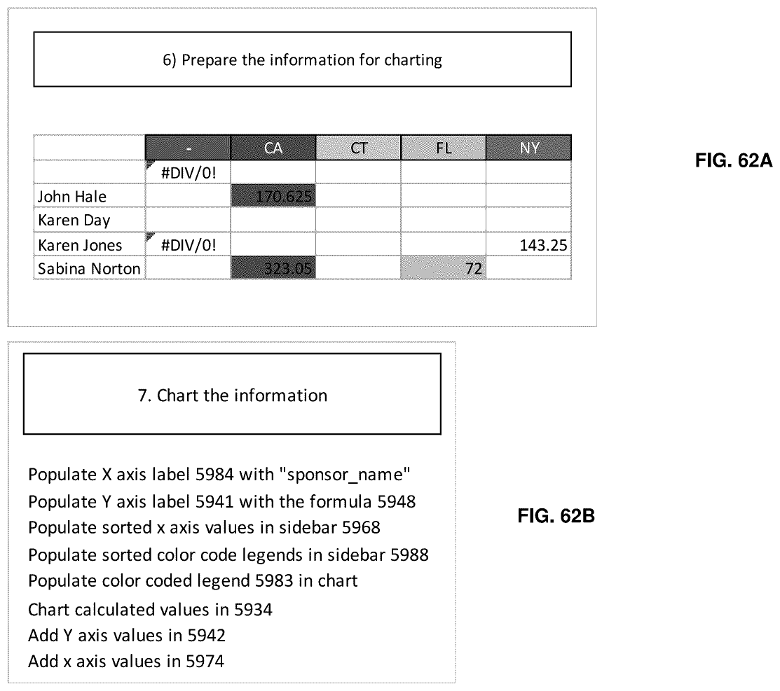

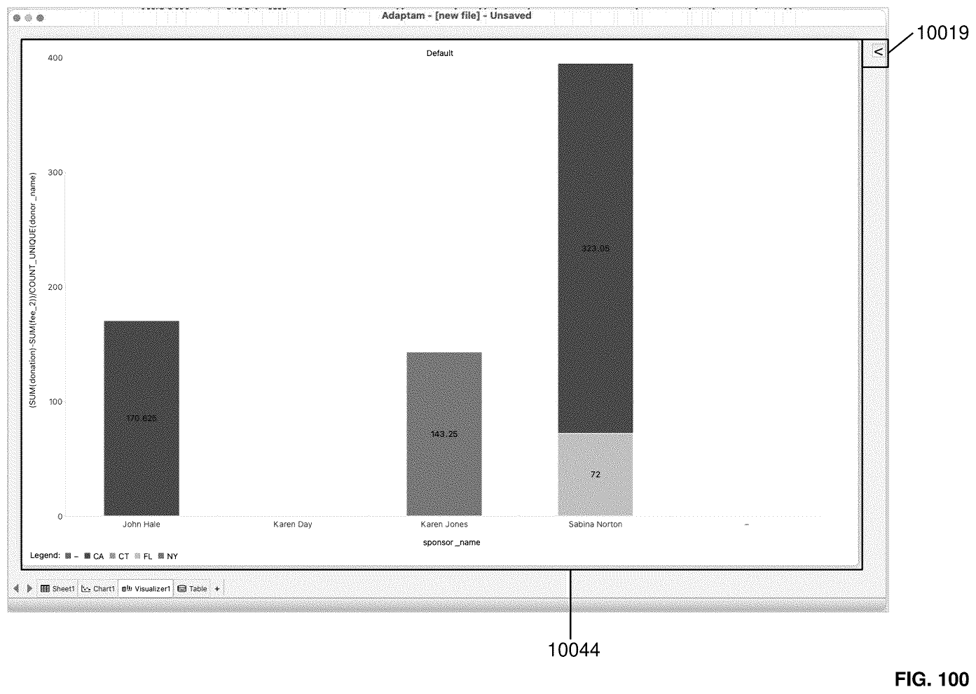

This formula, by itself, uses fields/columns from three of the four joinable data sets. In the next input of sponsor_name' 5957 into the ‘X axis inputs’ the user uses a field/column from the fourth data set. The user then specifies ‘state’ 5977 as the ‘Legend inputs’. As they were fine with the default sort orders (5959 and 5979) for both the ‘X axis inputs’ and the ‘Legend inputs’ they are done and happy with the automatically generated chart 5944. They also see the ‘X axis’ values 5968 and the ‘Legend’ values 5988 in the sidebar 5948 which they realize they can make disappear (clicking the ‘>‘5917) but right now leave in place. Our technology automatically generated the chart by first chain/sequence joining 6075 the data (6042, 6044, 6046, and 6048) as illustratively exampled in FIG. 60. Then using the required joined data fields/columns in the illustrative actions in FIG. 61A through FIG. 62B to generate the visualizer chart 5944 in FIG. 59. Note, our technology ignores the ‘# DIV/0!‘errors in the charting of the data as exampled by the column results 5934 in FIG. 59 not showing any ‘# DIV/0!‘values. Also note that FIG. 100 examples FIG. 59 if the user minimized (hid) the visualizer input panel 5948 by in this embodiment clicking the ‘>‘5917 to only show the chart panel 5944 (10044 in FIG. 100). In this embodiment the user can unhide the visualizer input panel (5948 in FIG. 59) by clicking the ‘<’10019 in FIG. 100. As described in the U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021 our visualizer panel can be displayed many different ways (e.g., full presentation view with no ribbon or border) and in many different places.

Our technology supports even more joins and even more complex formulas using the broad spectrum of prebuilt spreadsheet analytical functions. But for brevity's sake we will move on to discussing a more complicated joining situation, multiple joins between the same two data sets before moving on to discussing more implementations without joins prequalified before the specific visualizer chart being worked on.

### Multiple Joins Between Two Data Sets

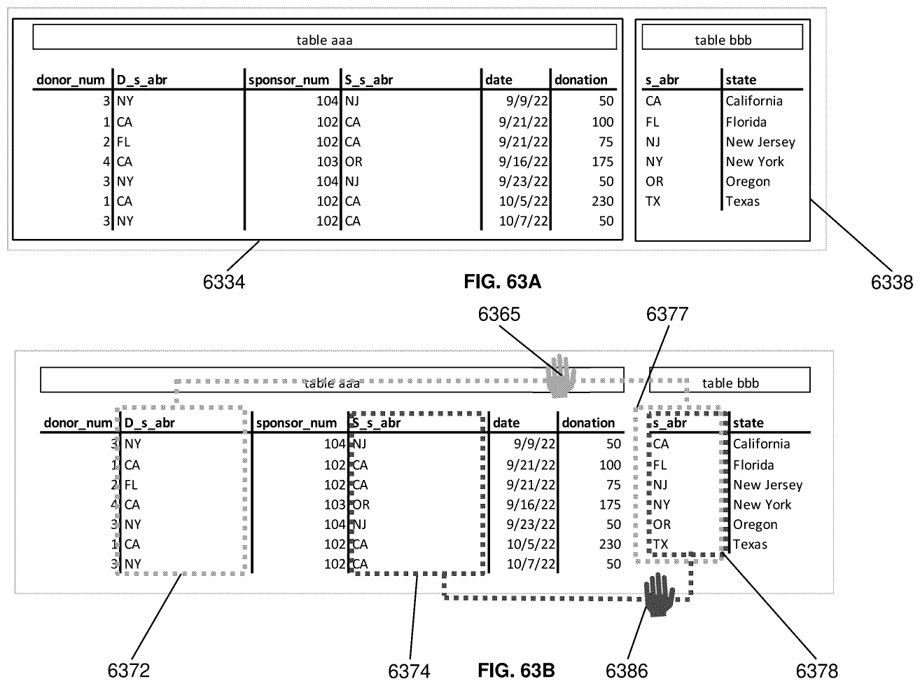

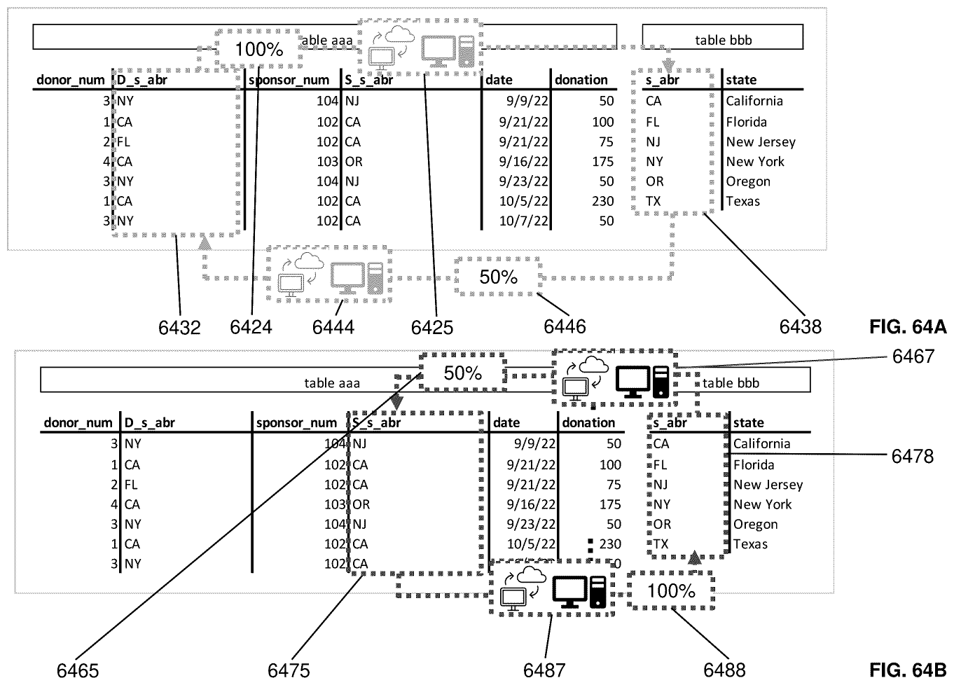

Our technology works for multiple potential join key pairs between the same two tables at the same time. FIG. 63A through FIG. 69B examples our spreadsheet visualizer double joining two data sets as part of the visualizer chart. FIG. 63A examples the charity user using two data sets, ‘table aaa’ 6334 and ‘table bbb’ 6338. They have two potential pairs of join key pairs 6372/6377 and 6374/6378 which are manually specified by the user 6365/6386 as exampled in FIG. 63B. It is worth noting that 6377 and 6378 are actually the same join key simply used for two different joins which are color coded and therefore separately labelled. Those manual specifications 6365 (grey) and 6386 (red) could then be verified by our technology in different embodiments along the lines previously discussed (e.g., FIG. 3). FIG. 64A and FIG. 64B illustratively example those same two join key pairs 6432/6438 (grey) and 6475/6478 (red) being automatically generated and validated 6424/6446 and 6465/6488 (as exampled by match percentages) on the user's computer, in the cloud or some combination of the two 6425/6444 and 6467/6487. The data types are the same for each join key pair, one of each join key pair is unique and the other non-unique, and the values matches are all ‘50%’ or higher (as shown in 6424/6446/6465/6488), thus passing the one-way and two-way match requirements set for this embodiment (e.g., >=50% or >0%). Those setup and validation actions could be done using any of the previously exampled appropriate UIs.

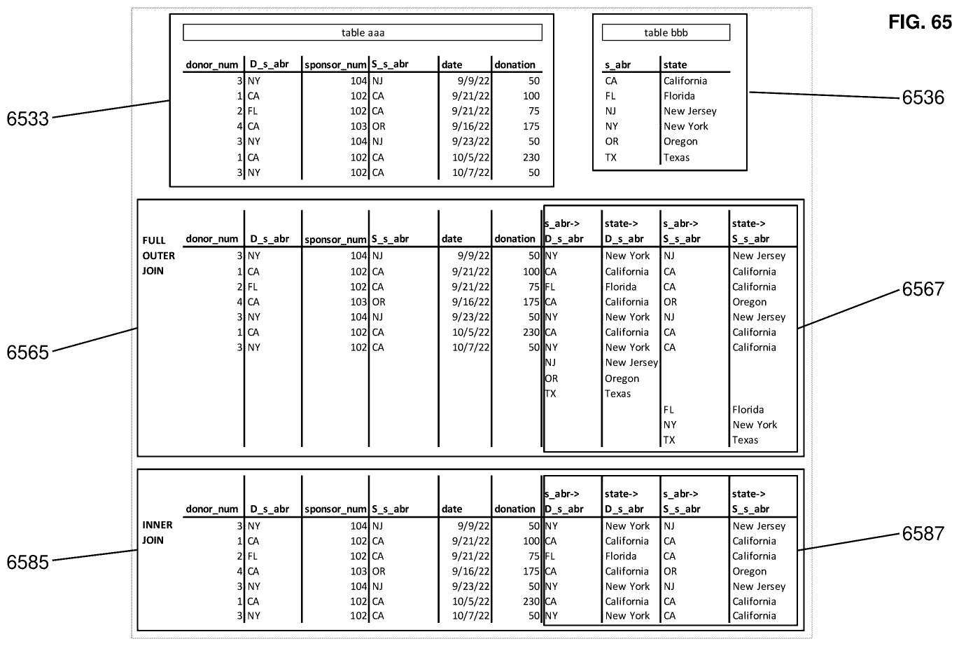

FIG. 65 examples the coexistence of the double joins illustratively qualified in FIG. 63B through FIG. 64B executed in a ‘FULL OUTER JOIN’ 6565 of all the columns/fields of two data sets, ‘table aaa’ 6533 and ‘table bbb’ 6536. While 6585 in FIG. 65 examples a double ‘INNER JOIN’ of all the columns/fields of two tables, ‘table aaa’ 6533 and ‘table bbb’ 6536. Recognizing that in most of situations our visualizer joining technology is using a subset of the joined fields/columns in the chart but FIG. 65 examples the double joining of all the fields. What could also be called a chain join twice of the two data sets with the creation of new field/column names for the double joined fields/columns 6567/6587 in data set from ‘table bbb’ 6536.

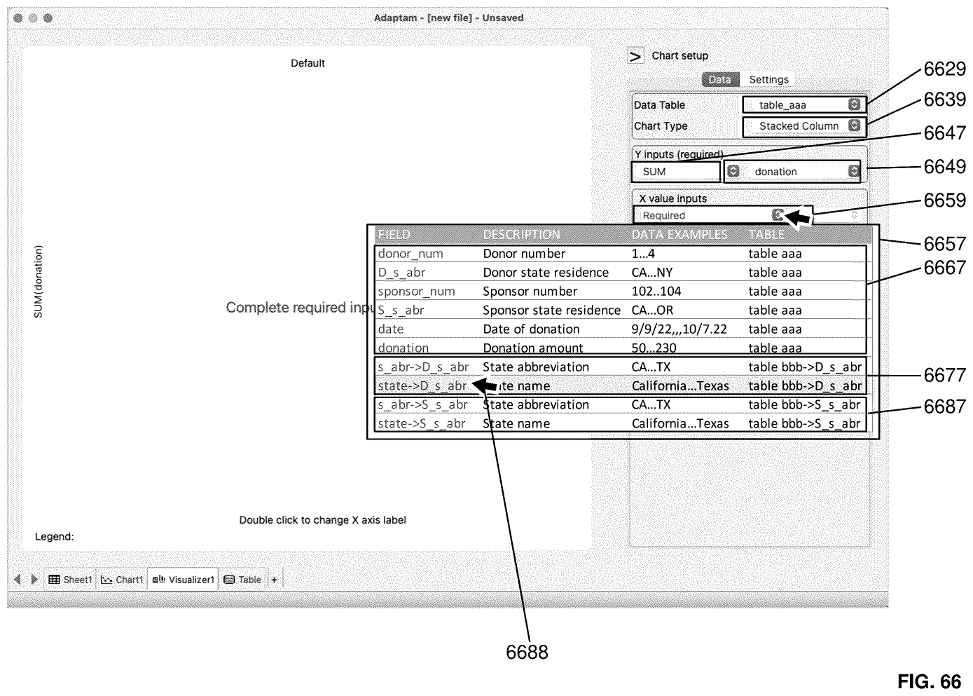

FIG. 66 through FIG. 69B examples our charity user using the double joined data within a visualizer chart. They would like to chart the total donations by donor state of residence (X axis) then further broken by their sponsor state of residence (the legend). With the two double joins prequalified (flag) before the visualizer chart the selection lists function as previously described displaying the joinable data sets together in FIG. 18B through FIG. 19E, FIG. 29B through FIG. 21E, and FIG. 41A through FIG. 41F. The added capability is the changed naming of some of the double joined fields to reflect the join. This embodiment utilizes our technology automatically revising those fields/column names. Other embodiments allow the user who prequalified the joins to add the name of the join.

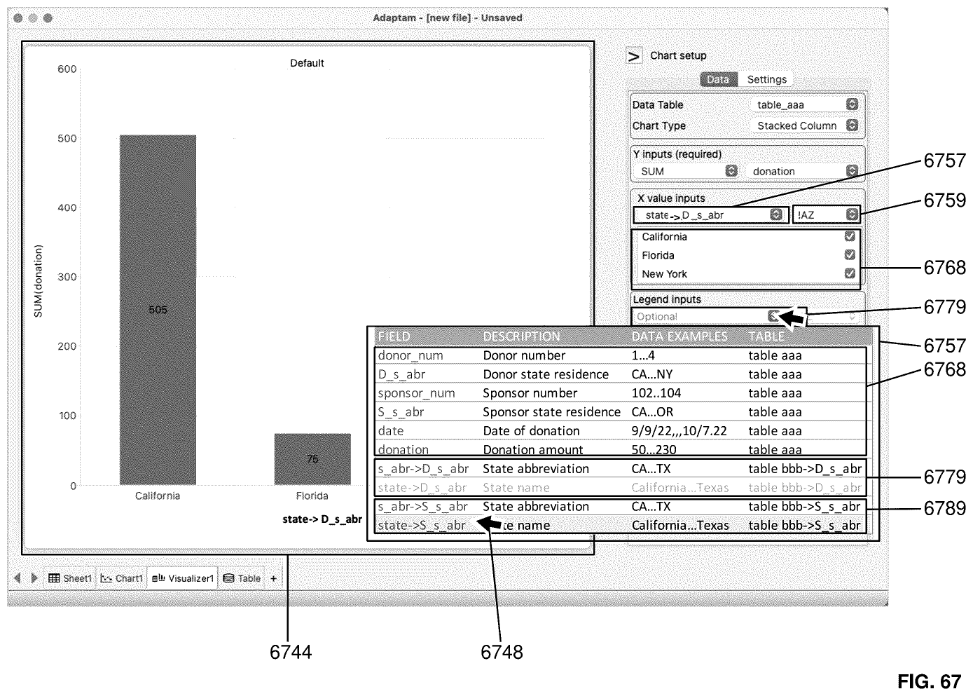

We will now example the user creating the visualizer chart using one of the previously exampled types of selection lists. In populating the inputs in FIG. 66 in this example the user first selects the ‘Data Table’ input ‘table_aaa’ 6629, then the ‘Chart Type’ 6639, the ‘Y inputs’ ‘SUM’ 6647, and ‘donation’ 6649. Because the ‘SUM’ function limits the fields/column selection to numeric fields and ‘table_bbb’ has no numeric fields/columns, the first visible joinable fields show up in the next selection. When the user clicks the button 6659 it opens the selection list 6657. It displays the fields/columns 6667 from ‘table_aaa’ but instead of displaying the fields from ‘table_bbb’ it displays how those fields are joinable to the fields/columns in ‘table_aaa’. Because of the double joining there are two sets of the fields/columns in ‘table_bbb’ that are joinable, 6677 and 6687. In this embodiment each has and appended a label that identifies the join that produces it. That is the a ‘->‘° arrow like set of characters followed by the join key field in ‘table_aaa’ used for it. That join key is a unique identifier in this situation because the join key in ‘table_bbb’ is the same for both of the joins. So, the first listed set of ‘table_bbb’ fields/columns 6677 has the join key identifier ‘->D_s_abr’. It is used to identify each field/column as well as the table. The second listed set of ‘table_bbb’ fields/columns 6687 has the join key identifier ‘->S_s_abr’ as does the ‘TABLE’ identifiers ‘table_bbb->S_s_abr’. In this example the user selects ‘state->D_s_abr’ 6688 which populates the field/column as shown in 6757 in FIG. 67 as well as the values in the sidebar ‘X value inputs’ 6768. Because the user has met the minimum requirements to generate a chart this embodiment does so in the chart output panel 6744. The user is fine with the default sort order of ascending (‘!AZ’) 6759 for the ‘X value inputs so they do not change that.

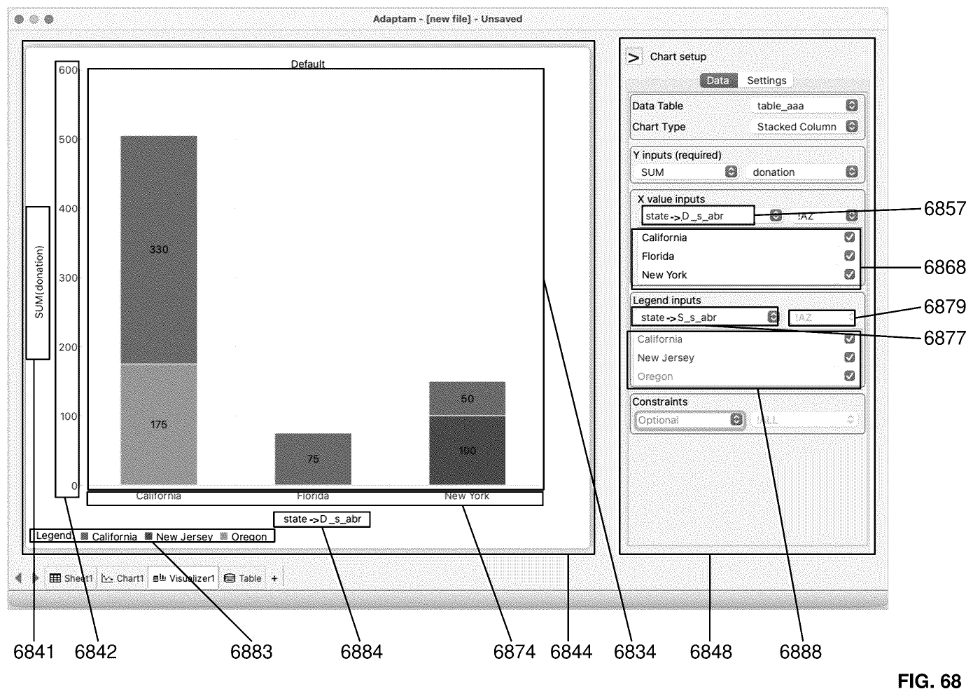

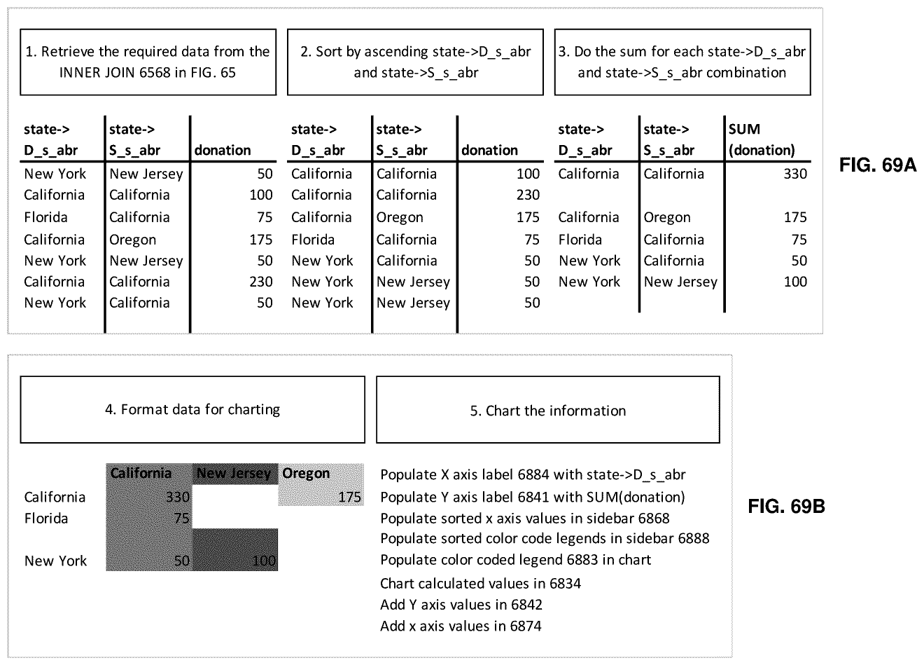

However, the user wants to break out the results by sponsor state, so they are not done. They click on the ‘Legend inputs’ button 6779 that opens the selection list 6757. Like before that selection list contains all the joinable fields from ‘table_aaa’ 6768 and the two joins 6779 and 6789 of ‘table_bbb’. Because ‘state->D_s_abr’ in 6779 was used in the ‘X value inputs’ it is disabled (grayed out) but otherwise the user has access to all the joinable fields/columns. They see the sponsor state field/column ‘state->S_s_abr’ 6748 and click it to automatically get their desired output in the chart panel 6844 in FIG. 68 from their input 6877. Our technology also automatically populated the ‘Legend inputs’ values list 6888 in the sidebar panel 6848 and on the chart 6883 having executed the chained/sequence join of ‘table_aaa’ twice to’table_bbb’ as exampled in FIG. 65 and then used the joined data in the illustrative calculations/actions in FIG. 69A and FIG. 69B to generate the visualizer chart 6844 in FIG. 68. At this point the user has the chart they desire and so they again do not change the default sort order 6879 in the visualizer chart inputs 6848. Our technology took the two prequalified joins (flag) between data sets ‘table_aaa’ and’table_bbb’ and in this embodiment automatically generated the joined fields and tables altered names (to differentiate the two), made them available in selection lists and once selected automatically executed the chained/sequenced double join to deliver the chart 6844 in FIG. 68. While we could example different types of selection lists and different examples for double joins, for brevity's sake we will move onto exampling a further automation that occurs in these multiple chained/sequenced joins between two data sets.

### Multiple Joins Between Two Data Sets—Automated Field Replacement

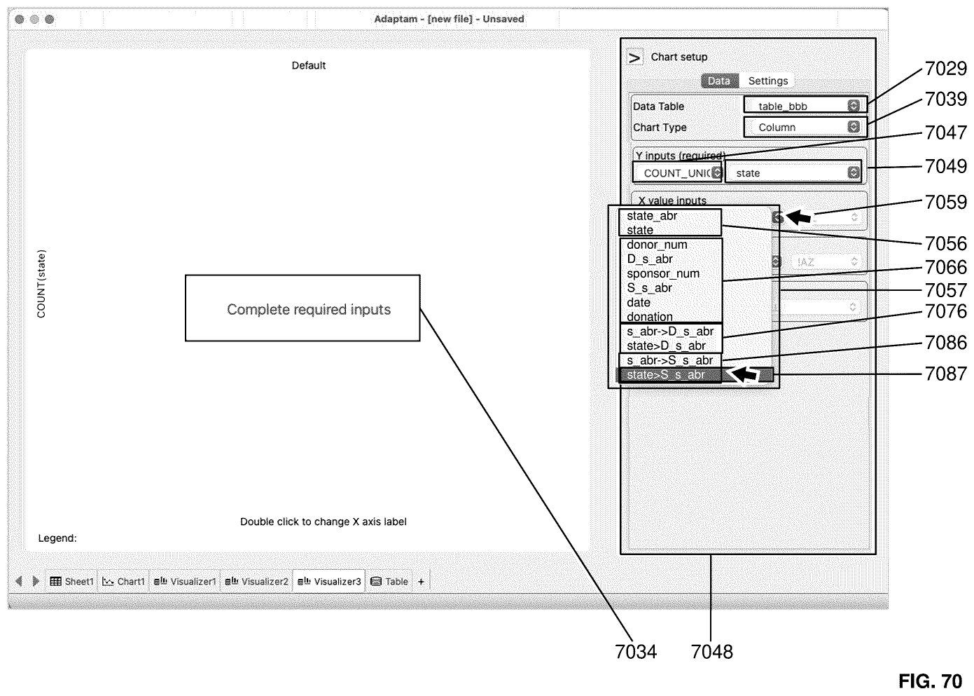

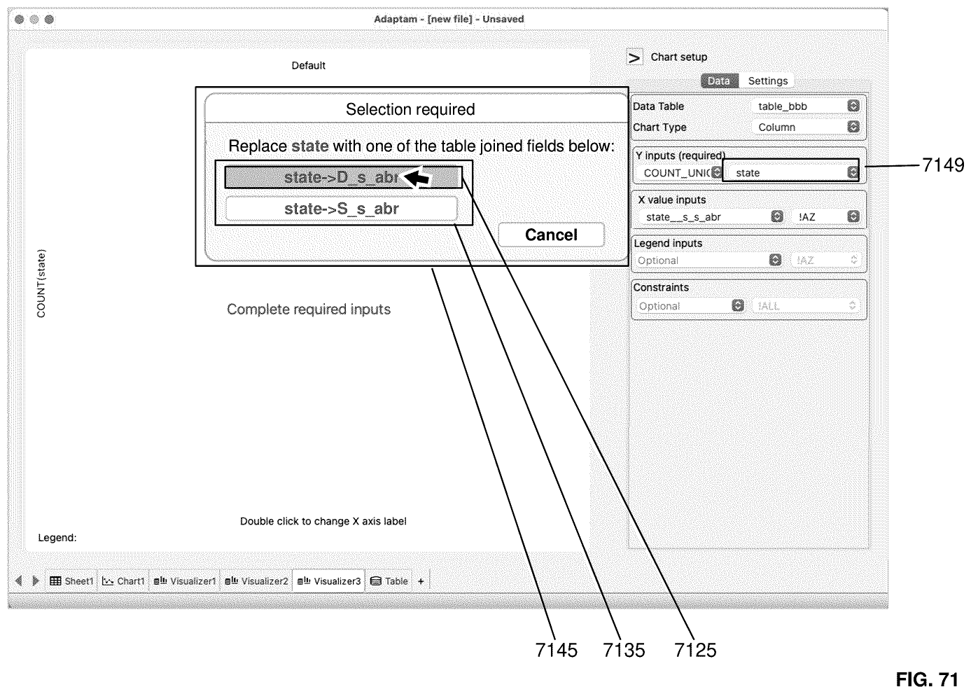

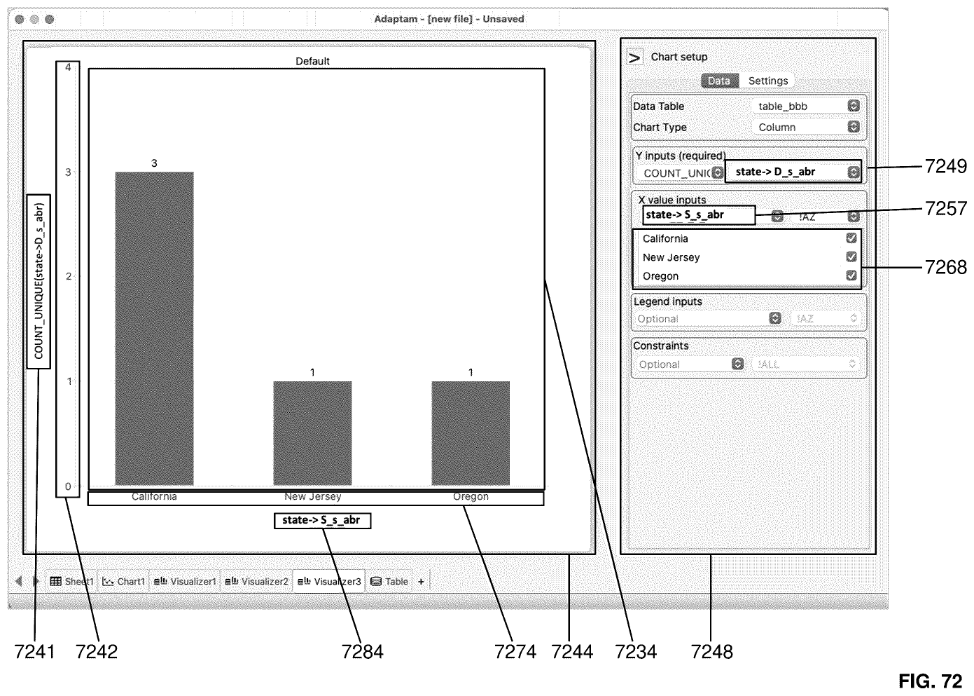

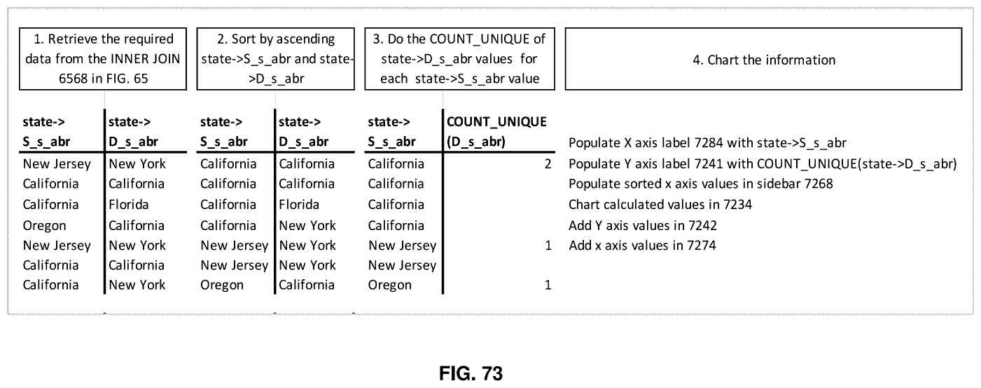

FIG. 70 through FIG. 73 examples additional capabilities of our double (or more multiple joining) technology between two data sets, where user selections result in the automatic or user selection replacement of a non-joined field with one of its double (or more in situations with triple or more joins) join fields. In FIG. 70 the charity user wants to chart the number of states each sponsor gets donations from. They start by selecting the ‘Data Table’ input ‘table_bbb’ 7029, then the ‘Chart Type’ Column’ 7039, the ‘Y inputs’ ‘COUNT_UNIQUE’ 7047, and ‘state’ 7049. Next the user clicks the ‘X value inputs’ button 7059 to open the selection list 7057. That selection list displays the fields/columns 7056 from ‘table_bbb’ and below them the joinable data set fields/columns. Those include the ‘table_aaa’ fields/columns 7066. Followed then by the double joined ‘table_bbb’ fields/columns 7076 and 7086. The user want the ‘COUNT_UNIQUE’ for each of the sponsor states, so they select the joinable data field ‘state->S_s_abr’ 7087. However, at that point they have triggered a join, and our technology knows that the un-joined ‘state’ field/column 7049 cannot coexist with a joined field from the same table. But there is no way for our application to know what joined field/column should replace ‘state’ 7049 because either of the double joined values can coexist in the ‘Y inputs’ field/column input. Thus, our system cannot automatically replace ‘state’ with one of the double joined fields/columns that it could do if the ‘state’ were instead in the legends where the selection would be constrained to the other double joined ‘state’ field/column ‘state->D_s_abr’ in 7076. So, in this situation our system automatically presents the user with the option of which field/column to use to replace ‘state’ 7149 as shown in FIG. 71. In this embodiment that presentation is in popup 7145 which instructs the user to select between the two fields/columns 7125 and 7135. The users then sees the donor state option ‘state->D_s_abr’ and clicks it 7125 to automatically deliver the chart (panel) 7244 in in FIG. 72 and populate the field/column ‘state->D_s_abr’ 7249 in the input in the sidebar (input panel) 7248. To do so our technology automatically executes the chained/sequenced double joins between data sets ‘table_aaa’ 6533 and ‘table_bbb’ 6536 illustratively exampled in FIG. 65 and uses the ‘INNER’ joined data 6585 in the calculations and actions illustratively exampled in FIG. 73.

Thus, we have exampled and described how our technology handles joinable data replacement situations where our technology provides the user with the options to select from (e.g., FIG. 71) and where there is only one option our technology automatically makes the replacement (e.g., where the field/column triggering the situation is in an input which limits the options in the other input to only one). While we could example three joins between two data sets (all sharing one join key in common) and further chaining/sequencing to other data sets (e.g., a data set having the populations and other demographics of each state) these work along the same principals already exampled. Therefore, we are going to move on to exampling more minimalist visualizer operation in our technology, first where there are no prequalified joins, and they are all qualified within the visualizer input panel.

### No Prequalified Joins Joining

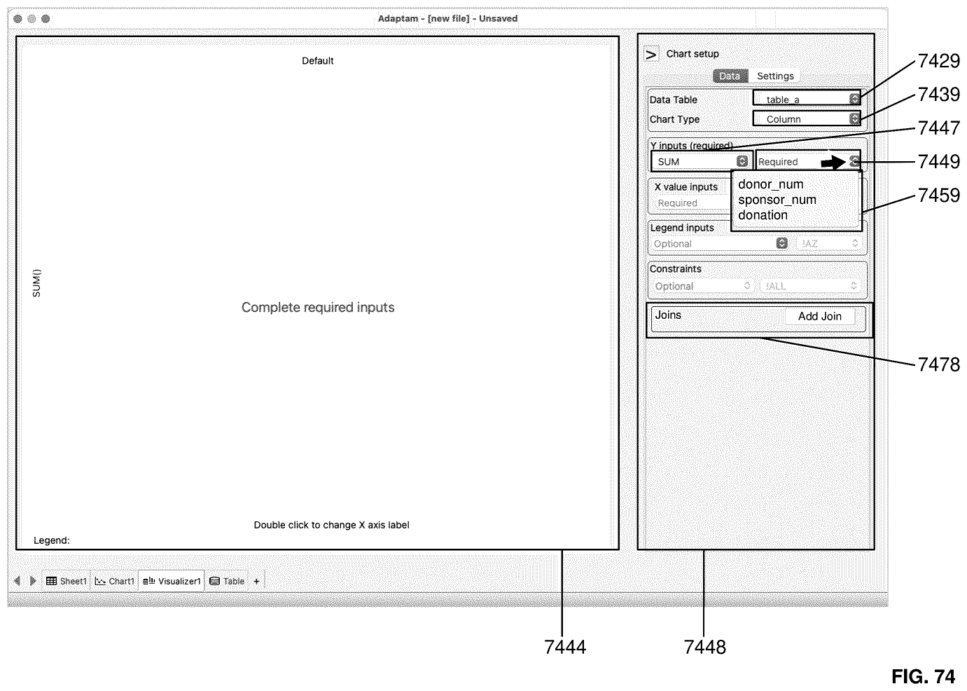

FIG. 74 through FIG. 79 example our technology working in an embodiment with no pre-qualification of joins before this visualizer. The user is using the three data sets in FIG. 15A but has yet to create the join. They want to chart the total donations by donor (name) and therefore need to use data from both ‘table_a’ 1533 and ‘table_b’ 1547. They start the visualizer chart setup in the sidebar (setup panel) 7448 in FIG. 74. They select the ‘Data table’ ‘table_a’ 7429, ‘Chart type’ ‘Column’ 7439, and begins the ‘Y inputs’ selecting ‘SUM’ 7447. However, when they click the field/column selection button 7449 and see the selection list 7459 they realize they do not see the field they want for the ‘X value inputs’ and therefore will need to join data sets to complete the chart they desire. So, they stop their current activity and switch to the ‘Joins’ 7478 specifier and start the process to add a join in this embodiment.

There are many different ways the user can add a join, as has been exampled previously herein. FIG. 75A through FIG. 76E examples embodiments which combine human specification and our application qualification testing against specified criteria. The human specifications are argument selection list driven staring after the clicking of the ‘Add Join’ button 7513 in the ‘Joins’ 7512 specifier in FIG. 75A. In this embodiment that opens the syntax in the join specifier input box 7515 and opens the ‘Select type of join’ popup 7535 where the user sees different types of joins available to them in FIG. 75B. The user selects ‘FULL’ 7525 the ‘Full outer join’ which populates ‘FULL’ in the join specifier box 7518 in FIG. 75C and opens the ‘Select table for the first join key’ selection list 7538. This lists all the data sets available to the user which in this example are the three data sets in FIG. 15A.The user selects ‘table_a’ 7528 which automatically opens the ‘Select field for first join key’ selection list 7573 in FIG. 75D. Note, because the field/column names are unique in these data sets this does not populate ‘table_a’ into the join 7572, however had the fields/column names not been unique it would have. In the selection list 7573 the user sees the join key field/column they want ‘donor_num’ and clicks (selects) 7583 it to populate the key ‘donor_num’ into the join specifier input box 7574 in FIG. 75E and open the ‘Select table for the second join key’ selection list 7575. Where the user sees the data set they selected for the first join key disabled (grayed out) and then selects ‘table_b’ 7585. Note, in this example because the field/column names are unique the selection of ‘table_b’ 7588 in FIG. 75E does not record in the join specifier input 7578 in FIG. 75F, however it could have recorded it in a different variation of this embodiment with non-unique field/column names. This automatically opens the ‘Select field for second join key’ selection list 7578 in FIG. 75F where the user sees and selects the field they desire ‘number’ 7588. This populates ‘number’ into the join specifier box 7613 in FIG. 76A and automatically opens the ‘Select the data modelling cardinality [optional]‘selection list 7633. This and the following arguments are optional and are tests to make sure the join meets the desires of the user. So, the use could hit ENTER/RETURN now and be done and this embodiment of our technology would execute the join as specified. Note the optional arguments are in square brackets denoting optional. The optional arguments if used automatically trigger further join validation tests and reject any join that does not meet the test.

The user decides to proceed as they would not want to inadvertently encounter partial Cartesian Product situations, so they select the ‘3’ 7632 option which joins ‘Unique to unique and unique to non-unique only’. This populates the ‘3’ in the join specifier input box 7618 and automatically opens the ‘Input Match1 percentage [optional]’ selection list 7627 in FIG. 76B asking for an ‘Input percent’ 7626. Here again the user can ignore it and hit ENTER/RETURN. However, they enter ‘50%’ which populates in the join specifier box 7638 in FIG. 76C and opens the ‘Input Match2 percentage [optional]‘selection list 7647 again asking for a ‘Input percent’ 7646. The user again enters ‘50% and hits ENTER/RETURN to populate the join and in this embodiment show it in a very simple form ‘table_a: table_b’ 7667 in FIG. 76D. In this embodiment the more detailed layout of the arguments is visible when you click into the box as exampled in FIG. 76E by:
‘FULL,donor_num,numbe,3.50%,50%’ 7687.

The more detailed layout could have been directly visible in the join specifier box and is in another related embodiment.

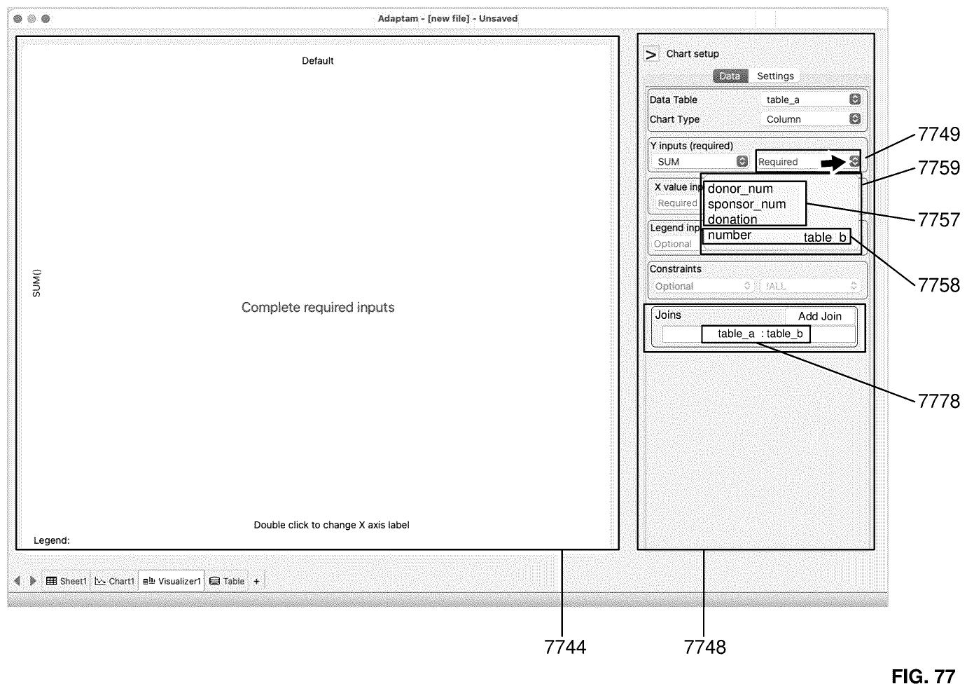

Having set up the join 7667 in FIG. 76D, our technology qualifies it and when it passes all the tests including the cardinality and match tests qualifies the join (flag) for selection list visibility. Note, this embodiment had an additional default validations of testing that the two join keys were the same data type although in embodiments allowing cross joins that validation could be disabled. With the join now set up 7778, in FIG. 77 when the user clicks the selection button 7749 to reopen the selection list 7759, they not only see the ‘table_a’ fields/columns 7557 but also see the joinable ‘table b’ field/column 7558. Note, the fields/columns are limited to numeric by the ‘SUM’ function and this is one of many different selection list alternatives in our technology, with others exampled in FIG. 18B through FIG. 19E, FIG. 29B through FIG. 21E, and FIG. 41A through FIG. 41F.

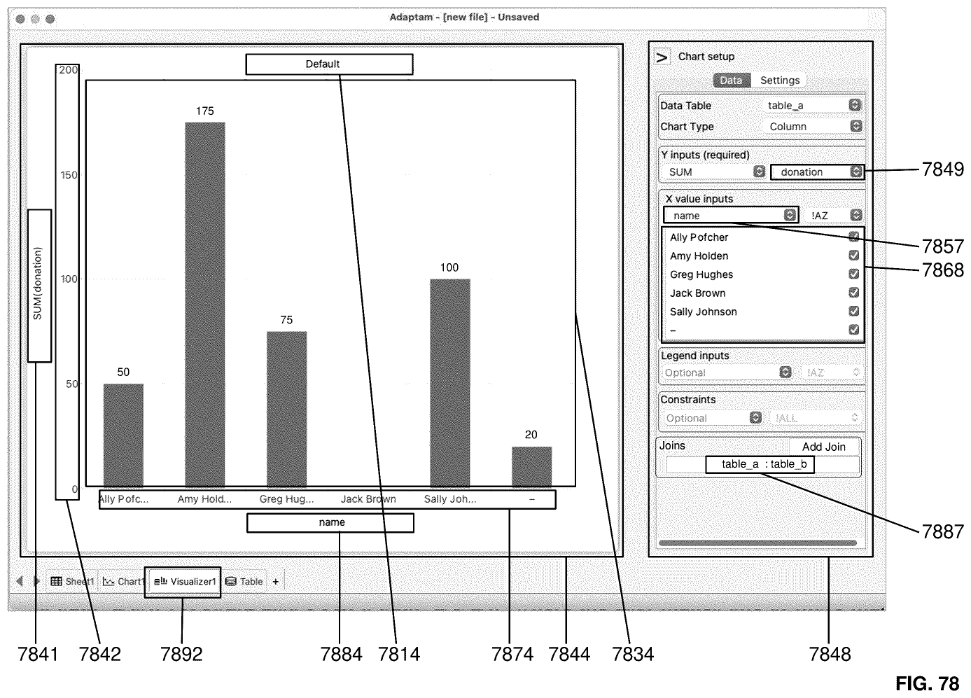

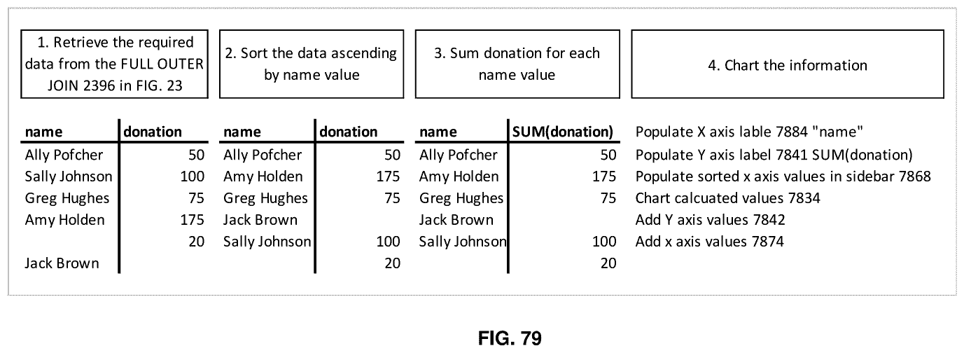

The user selects the field they desire ‘donation’ 7849 as shown in FIG. 78 and using a selection list displaying all the joinable fields/column selects the ‘X value inputs’ field/column ‘name’ 7857 from ‘table_b’. This automatically displays the chart 7844 in the chart display panel as our technology automatically executed the join 2396 in FIG. 23 and used the joined data in the calculations illustratively exampled in FIG. 79. Note, in this embodiment the short form of the join 7887 displays in the visualizer input 7848, but as previously stated that could have been the more complete form 7687 in FIG. 76E.

This embodiment exampled one of many similar embodiments where there are no prequalified joins before the visualizer chart and the joins are set up there. Once they are setup and qualified by any of the applicable ways in FIG. 2 (and other combinations described herein) using any of the paths in FIG. 3, they are visible in the field/column selection lists. Rather than exampling the many mix and match combinations and their spectrum of UIs, and its use in two or more chained/sequenced joins, we will move on to exampling a very manual embodiment of our joining technology.

No Prequalified Joins Joining with No Selection List Support

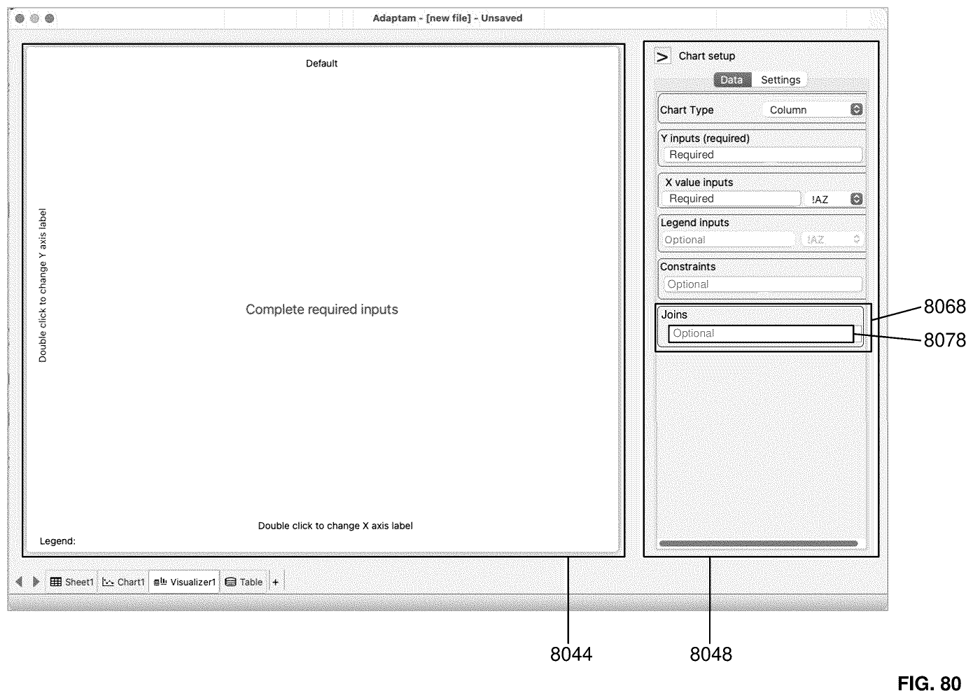

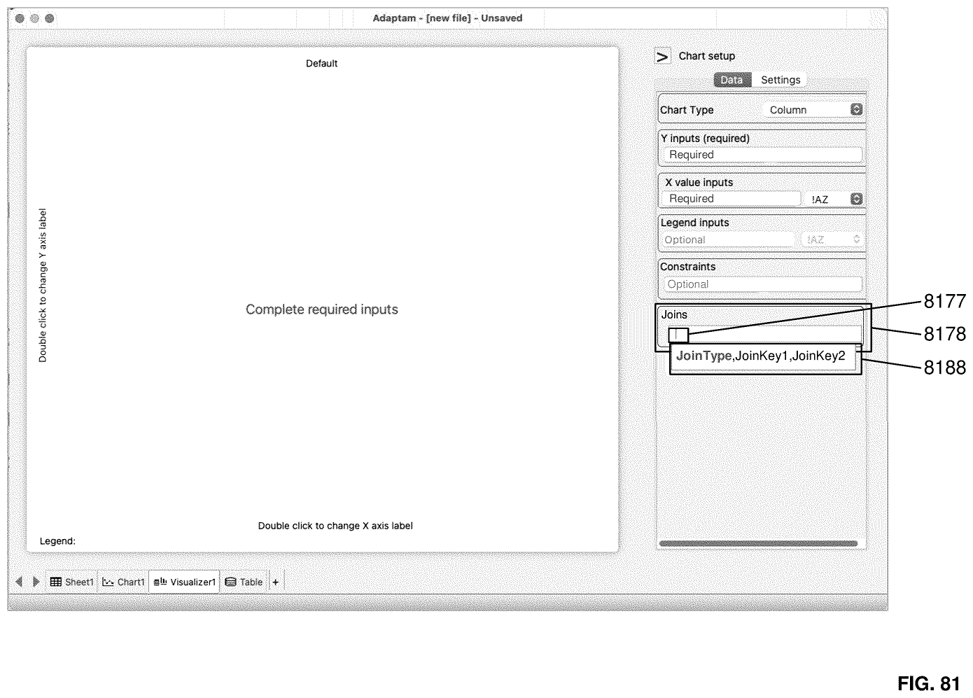

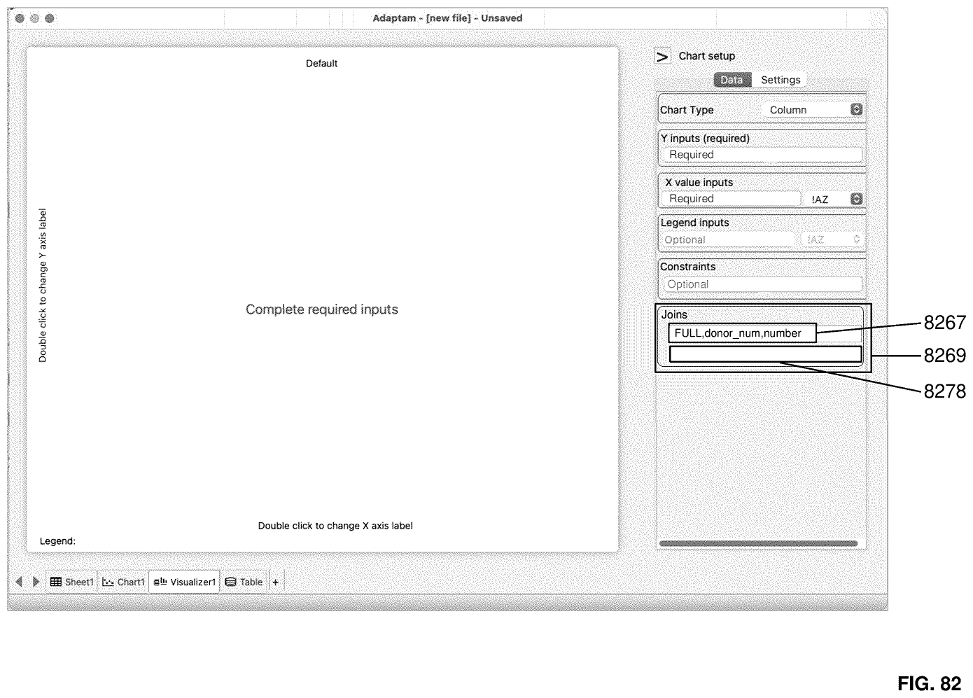

FIG. 80 through FIG. 84 examples the charity user creating the same chart as in FIG. 74 through FIG. 79 except with a much more manual embodiment with no join creation selection lists, no field/column selection lists and only typical spreadsheet syntax help. As with the other examples, FIG. 80 uses the two-panel visualizer with a sidebar input panel 8048 and the chart output panel 8044. It could use any of visualizers exampled in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021 but for simplicity of easily seeing differences between different embodiments and brevity's sake we have used one type of visualizer throughout. The user knows that the chart they want, using the two data sets ‘table_a’ 1533 and ‘table_b’ 1547 in FIG. 15A, that will need to be joined. So, they immediately go to the ‘Joins’ specifier input 8068 to click into the ‘Optiona1’ argument 8078, which they do in 8177 in FIG. 81 in the join specifier 8178. This reveals the typical spreadsheet syntax guide for populating prebuilt function arguments 8188 which tells the user what they must input, the Join type (‘JoinType’), the first join key field/column (‘JoinKey1’) and the second join key field/column (‘JoinKey2’). This is done in an embodiment with unique field/column names however if that were not the case then data set (table) name inputs would be added. The user fills out those arguments as exampled in 8267 in FIG. 82 in the join specifier 8269 and hits ENTER/RETURN to automatically complete the join 8267 and open an additional join specifier box 8278 in the ‘Joins’ 8269 input in the visualizer input. With this the user is done creating joins and returns to the regular visualizer inputs.

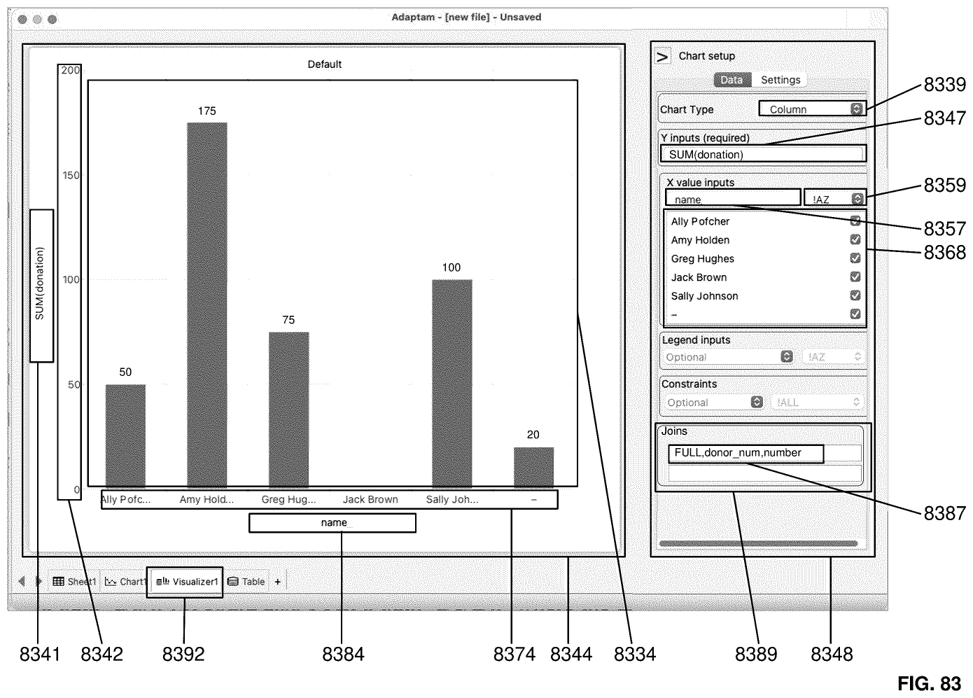

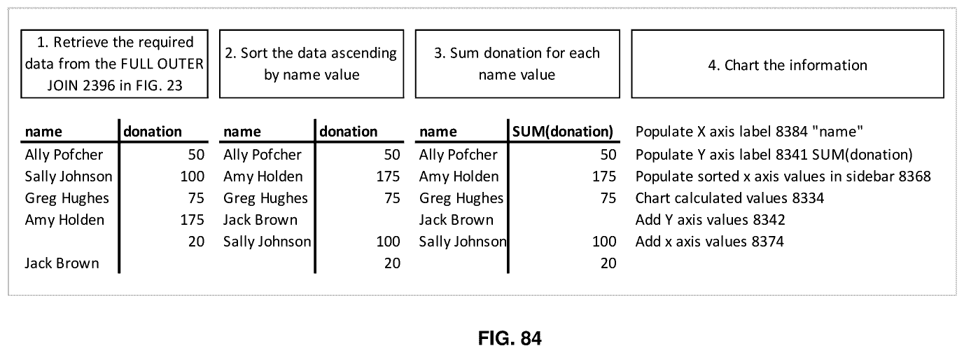

The user first selects a ‘Chart Type’ in this case specifying ‘Column’ 8339 in FIG. 83. The user then types into the visualizer input panel 8348 the ‘SUM(donation)’ 8347 formula into the ‘Y inputs’, types the field/column ‘name’ 8357 into the ‘X value inputs’, leaves the sort at the ‘!AZ’ default 8359, and hits ENTER/RETURN to automatically generate the chart 8374 using the joined data. Our technology automatically executed the ‘FULL OUTER’ join 2396 in FIG. 23 and used the joined data in the calculations illustratively exampled in FIG. 84 to generate the chart 8344 in FIG. 83. There are many different variants of this embodiment using many of the different join set up UIs, qualification types/UIs, different argument types (e.g., more arguments) using examples herein and the examples in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021. This embodiment equally works for chained/sequenced joins.

### Join Specifier Types

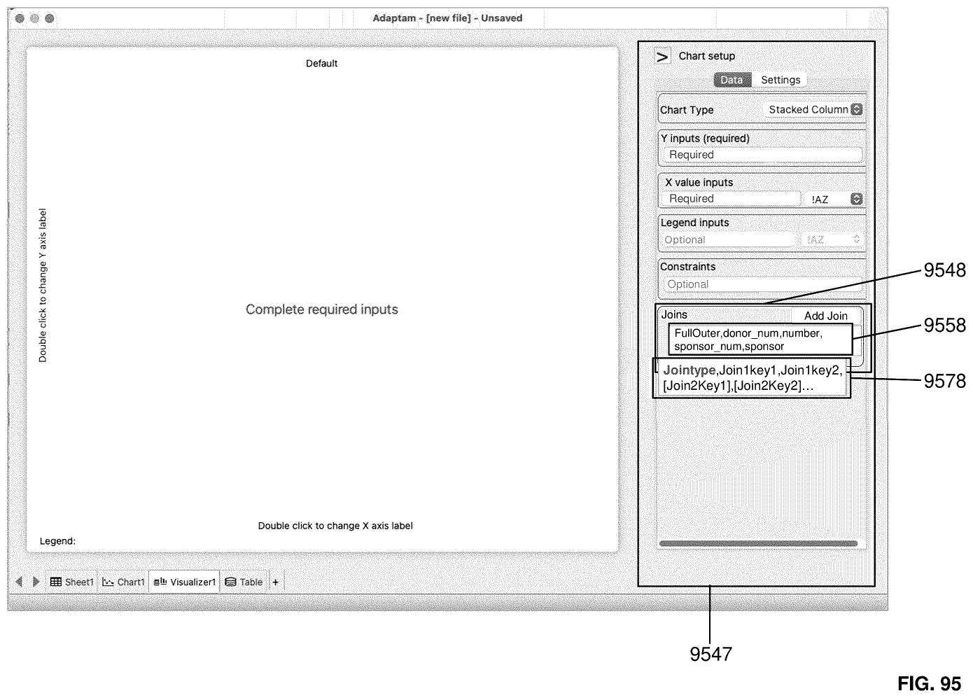

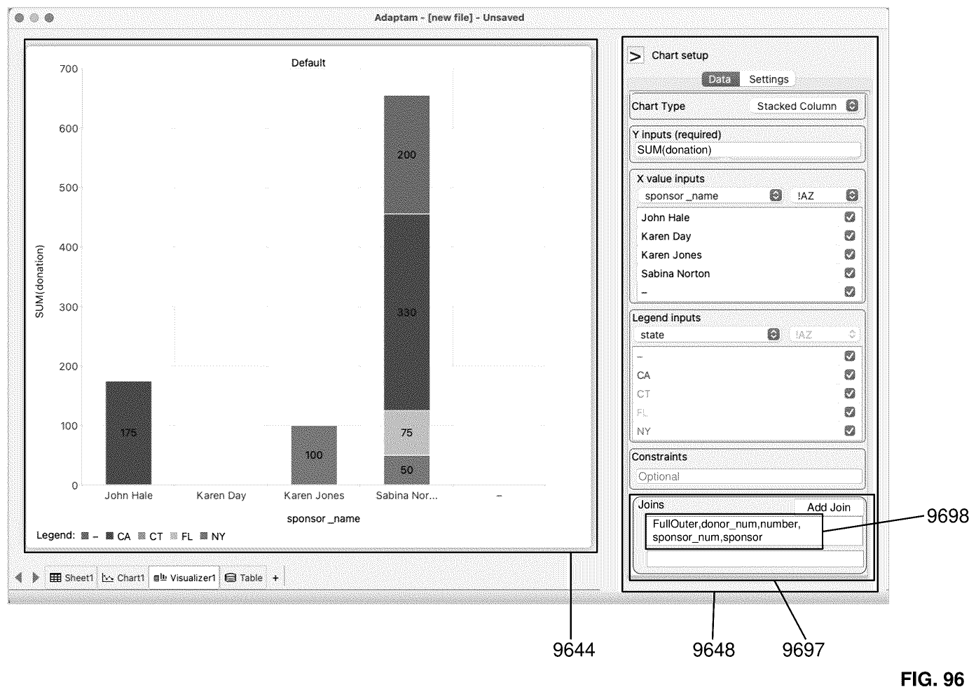

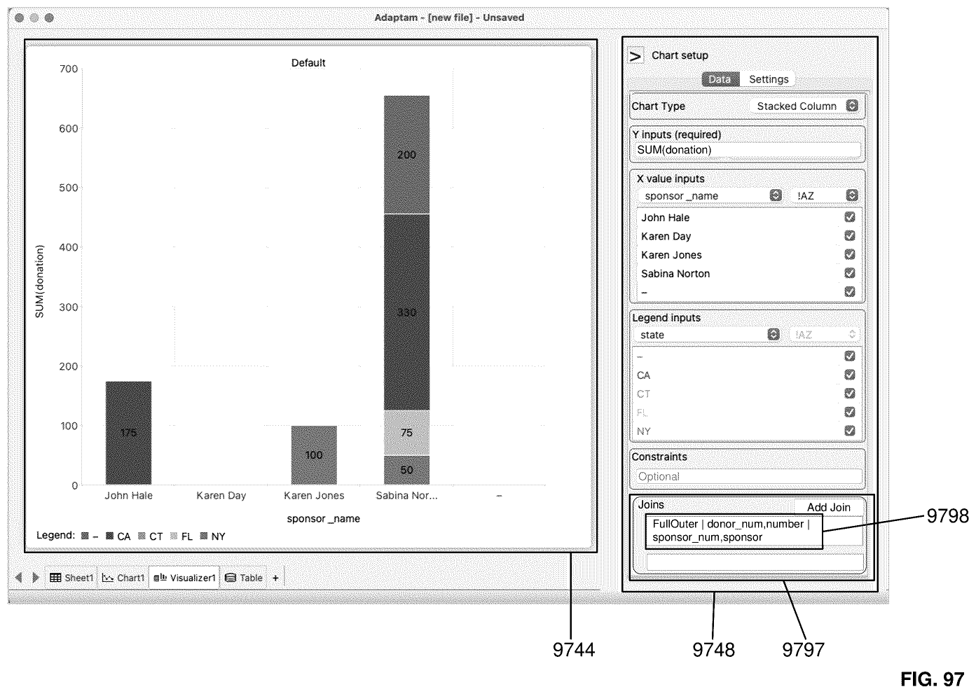

Thus far we have inputted joins in the join specifier using a set of arguments per each join, however our technology supports many different ways of specifying the join. We will now example alternatives for the chained/sequenced join previously exampled in FIG. 93. FIG. 95 and FIG. 96 example an embodiment where multiple joins can be created in the same set of arguments provided they share the same join type. They use the syntax guide 9578 in FIG. 95. That guide 9578 tells the user the first argument ‘JoinType’ is the type of join (e.g., FullOuter, Inner, and LeftOuter) while the next two arguments ‘Join1Key1,Join1Key2’ are the join keys for the first join and from then on there are optional (denoted by the square brackets [ ]) second, and beyond joins the user can add. In this example the user has added both joins from FIG. 93 in 9558 within the join specifier 9548 in the visualizer input panel 9547. When they hit ENTER/RETURN and put all the additional inputs like in FIG. 93 in FIG. 96 to get the same chart result 9644 in FIG. 96 as 9344 in FIG. 93. Although the single set of arguments 9698 in FIG. 96 are different than the two separate join specifier arguments 9398 and 9399 in FIG. 93. Note the join specifier 9697 in FIG. 96 also automatically created an additional input specifier box to allow users to add joins of a different join type. FIG. 97 examples a variant of the embodiment in FIG. 95 and FIG. 96 where the different joins are repeating in what we call argument groups that contain the join key arguments (e.g., JoinKey1 and JoinKey2) separated by a comma and then each group is separated from the next group by a vertical bar ‘l’ as exampled in 9798. Again, generating the same chart 9744 (as 9644 in FIGS. 96 and 9344 in FIG. 93) and using a very similar join specifier 9797 within the visualizer input panel 9748.

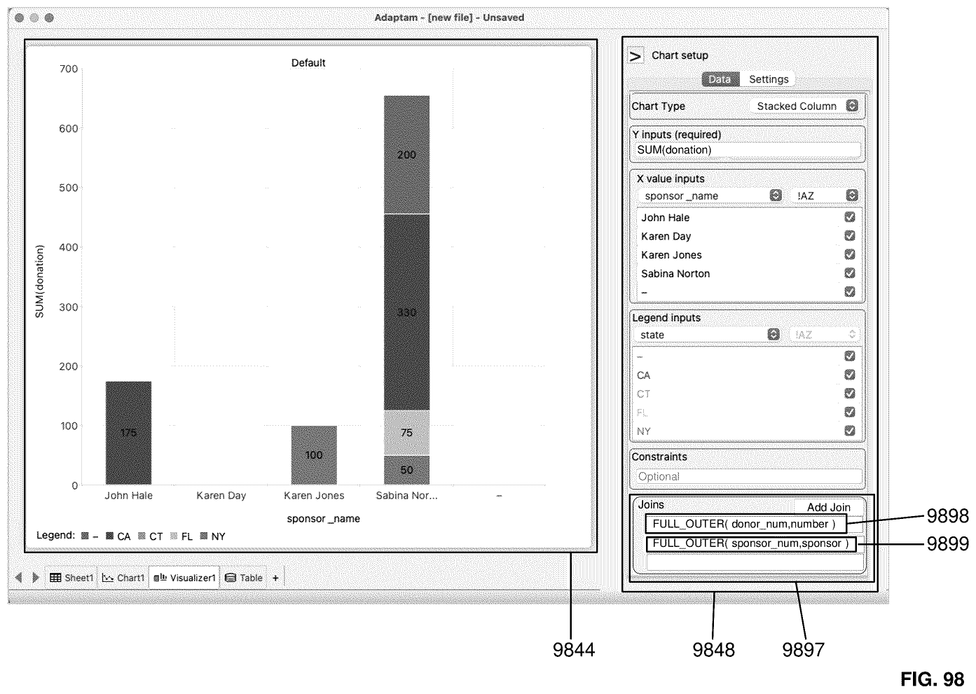

FIG. 98 examples a different join specifier argument type where the argument is a prebuilt function much like you would normally find in a spreadsheet cell formula and was exampled in our related filing U.S. Provisional Patent Application No. 63/525,138, which is incorporated by reference above. Otherwise, this embodiment works very similarly to that in FIG. 93 except instead of a join type argument this embodiment has a join type prebuilt function within which the two join keys are the arguments. Note as before the brevity of the arguments works here because the field/column names are unique and therefore identify their data set, if that were not the case then the arguments would include the table identifiers in some form. The user has entered the two joins 9898 and 9899 in join specifier 9897 within the visualizer input panel 9848 and inputted the other visualizer inputs to automatically chain join the data and generate the chart 9844.

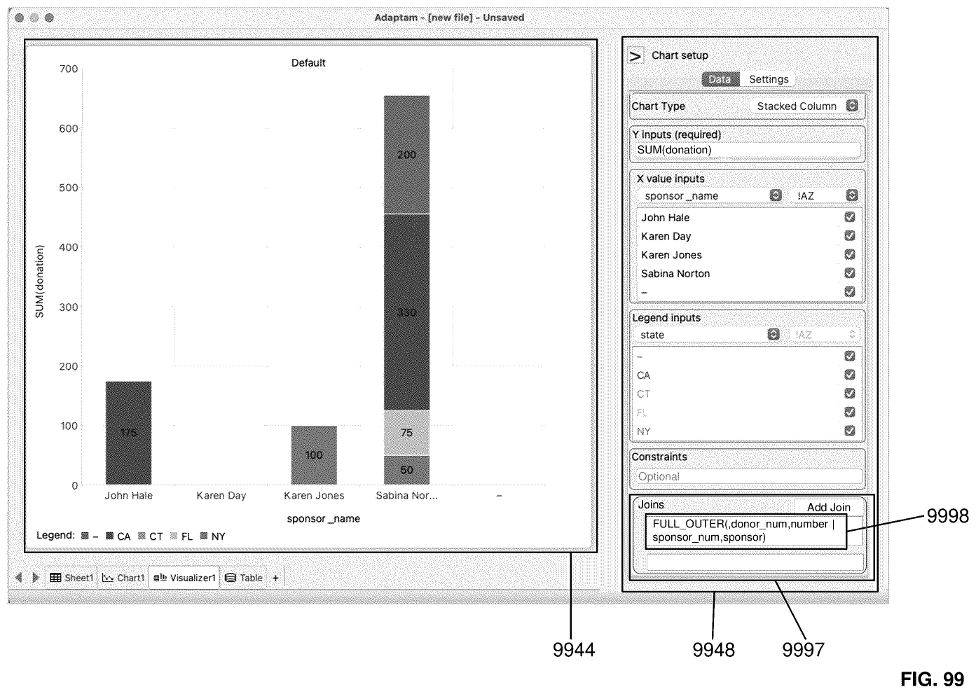

FIG. 99 examples another prebuilt function join specifier embodiment in this example using a join type identifying prebuilt function ‘FULL_OUTER’ which is one of a family of different type of join prebuilt functions. The join key arguments are inputted in argument groups separated by a vertical bar ‘1’ as exampled in 9998. The user has entered the two joins 9998 in join specifier 9997 within the visualizer input panel 9948 and inputted the other visualizer inputs to automatically chain join the data and generate the chart 9944. We could continue with different ways to enter the joins into the visualizer join specifier, but for brevity's sake will leave it to the reader to see the different ways of entering the information and adding more join requirements as previously discussed.

### Mix and Match Embodiments

In the interest of conciseness, the combinations of features disclosed (e.g., locations of joins, types of joining, validation of joins, join selection lists and joinable data selection lists) in this application have not repeated with each of the other features and in all the possible combinations. The reader will understand how features identified in this section can readily be combined with sets of other features. We will therefore move on to describing one of many example computer systems that can be used for our technology.

### Computer System

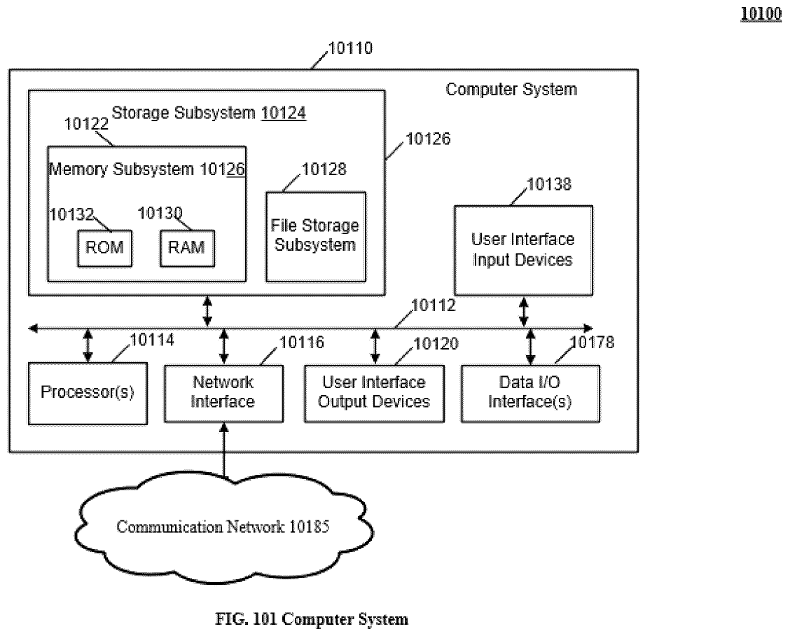

FIG. 101 is a block diagram of an example computer system, according to one implementation. Computer system 10110 typically includes at least one processor 10114 which communicates with a number of peripheral devices via bus subsystem 10112. These peripheral devices may include a storage subsystem 10124 including, for example, memory devices 10126 and a file storage subsystem 10128, user interface input devices 10138, user interface output devices 10120, data I/O interface(s) 10178 and a network interface subsystem 10116. The input and output devices allow user interaction with computer system 10110. Network interface subsystem 10116 provides an interface to outside networks, including an interface to communication network 10185, and is coupled via communication network 10185 to corresponding interface devices in other computer systems or in the cloud and usable for cloud applications.

User interface input devices 10138 may include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 10110 or onto communication network 10185.

User interface output devices 10120 may include a display subsystem, a printer, a fax machine, or non-visual displays such as audio output devices. The display subsystem may include a touch screen, a flat-panel device such as a liquid crystal display (LCD), a projection device, a cathode ray tube (CRT), or some other mechanism for creating a visible image. The display subsystem may also provide a non-visual display such as via audio output devices. In general, use of the term “output device” is intended to include all possible types of devices and ways to output information from computer system 10110 to the user or to another machine or computer system.

Storage subsystem 10124 stores programming and data constructs that provide the functionality of some or all of the modules and methods described herein. These software modules are generally executed by processor 10114 alone or in combination with other processors.

Memory 10126 used in the storage subsystem can include a number of memories including a main random-access memory (RAM) 10130 for storage of instructions and data during program execution and a read only memory (ROM) 10132 in which fixed instructions are stored. A file storage subsystem 10128 can provide persistent storage for program and data files, and may include a hard disk drive, SSD, a tape drive, an optical drive, or removable media cartridges. The modules implementing the functionality of certain implementations may be stored by file storage subsystem 10128 in the storage subsystem 10124, or in other machines accessible by the processor.

Bus subsystem 10112 provides a mechanism for letting the various components and subsystems of computer system 10110 communicate with each other as intended. Although bus subsystem 10112 is shown schematically as a single bus, alternative implementations of the bus subsystem may use multiple busses.

Computer system 10110 can be of varying types including a workstation, server, computing cluster, blade server, server farm, or any other data processing system or computing device. Due to the ever-changing nature of computers and networks, the description of computer system 10110 depicted in FIG. 101 is intended only as one example. Many other configurations of computer system 10110 are possible having more or fewer components than the computer system depicted in FIG. 101.

### Some Particular Implementations

Some particular implementations and features are described in the following discussion. Implementations of our visualizer chart data joining technology support a broad spectrum of situations from two data set joins, multiple joins between two data sets, multi-data set joins to data sets combining all of these. Our implementations support prequalifying joins (before this visualizer chart), so the typical user does not have to deal with the mechanics of determining the join keys and/or the join type. So that the prequalified joinable fields are simply available to users in selection lists for use in their visualizer charts. For the more sophisticated user implementations our technology supports altering (requalifying) those join keys or join types as well as having implementations with no prequalification where all the join setting is done in the visualizer inputs. Implementations of our technology support the full spectrum of cardinality (data modelling relationships between data sets) as well as having implementations that limit cardinality types and implementations with different cardinalities for prequalified joins versus in this visualizer qualified joins. All our implementations support data sets from different types of sources, data external to the spreadsheet and in-cell data, and support combinations of those sources. We will start with a two-data set implementation employing prequalified joins used for selection lists before moving on to implementations further broadening the range of situations supported.

### Two Data Set Qualified Selection List Join

Our data set joining technology supports a spreadsheet chart visualizer joining data from two data sets using any of the SQL supported join types (e.g., full outer, inner, and left outer). This implementation starts by qualifying the joinability of the two data sets based on the field/column in each data set specified for the join keys. That qualification flag setting can be done in many different locations, as exampled in FIG. 1 and in many different ways, as exampled in FIG. 2, with the validation of the join qualification being tested (validated) in different paths, as exampled in FIG. 3. FIG. 8 examples one UI used in the qualification flag setting via a data intake tool external or within the spreadsheet. FIG. 12A through FIG. 12D examples UIs used to access and setup joins for all the tabs within a spreadsheet (including the visualizer tabs). FIG. 14A and FIG. 14B examples UIs used to access, and setup joins within a visualizer which then could apply to that visualizer tab itself or to that visualizer tab and all subsequent visualizer tabs.

Once the user specifies a data set or field within a data set with prequalified joinable data our visualizer technology automatically displays a list of at least some of the joinable fields immediately or accessible in sequential lists as exampled in FIG. 18B through FIG. 19E and FIG. 20B through FIG. 21E. The list contains at least some but not necessarily all the joinable fields because if the fields/columns are used in function that limits the type of fields/column (e.g., SUM limit to numeric) as exampled in FIG. 77 7759. When the user then makes a selection from one of those lists of a joinable field/column our technology automatically populates the joinable field/column as exampled in FIG. 22 2257. And once the user has populated fields from both joinable data sets and triggers chart generation our technology automatically joins the data, as illustratively exampled in FIG. 23, and uses the joined data to produce the chart with illustratively exampled calculations and actions in FIG. 24 and charting in FIG. 22. This implementation supports many different variants exampled herein and discussed in the related (dependent) implementations.

### Two Data Set Qualified Selection List Join—Qualification Before the Visualizer

Our technology supports many different ways to qualify the join flag. In one implementation the join qualifying is done in a data intake tool where the data is prepared most typically by a single user for use by all the spreadsheet users employing that combination of data sets. That way the typical spreadsheet user (not the user qualifying the joins) does not have to deal with the mechanics of determining the join keys and/or the join type when they are creating a spreadsheet visualizer chart. So that the qualified joinable fields are simply available to them in selection lists for use in the visualizer as the join qualification flag is stored with the data. In this implementation the data set join keys are determined, and qualification flag validated before this visualizer tab as exampled in the UIs in FIG. 8, FIG. 9, FIG. 10, and FIG. 11. It is also exampled FIG. 1 for the boxes corresponding to ‘INTAKE—External to spreadsheet’ qualification 135, recognizing that for reasons of conciseness FIG. 1 does not example all the possible combinations supported by our technology including those with combined external and in-cell data sets.

However, our technology supports many other qualification locations before in-cell as exampled by ‘INTAKE—in spreadsheet’ 145 in FIG. 1 where the spreadsheet user qualifies, with or with automated qualification validation, join keys as exampled in paths ‘B’ and ‘I’ in FIG. 1. That can employ a UI similar to those in FIG. 8, FIG. 9, FIG. 10, and FIG. 11. Our technology also supports ‘Spreadsheet capability’ 155 (e.g., visualizer tabs, visualizers embedded in worksheets, or visualizers embedded in other types of tabs) and ‘Worksheet capability’ 165 level join keys qualification which automatically applies to the visualizers). With the join setting and qualification done in a UI like those exampled in FIG. 12A through FIG. 12D or any applicable parts of the other join setup UIs exampled or referenced herein.

Our technology also supports qualification first set in one location and then reset to something else in another location as exampled in the extreme situations in paths ‘G’ and ‘N’ in FIG. 1. All the mix and match combinations were not illustrated for brevity's sake. The ‘All Visualizers’ 175 is also applicable provided the join was created prior to ‘This Visualizer’ where the user is currently creating a chart (see FIG. 14B for an example UI).

### Two Data Set Qualified Selection List Join—Invisible Join Argument or Function

A further implementation employing the before visualizer qualified joinable data sets requires no visible join argument in the visualizer inputs as exampled in FIG. 22, FIG. 27, FIG. 32, and FIG. 33. Therefore, the typical user does not need to deal with the complexity of seeing the join keys and join type but simply sees the fields/columns they desire in the formula. In all these examples the fields/columns have unique names not requiring the inclusion of a data set in the field/column identifier (naming), but our technology supports data identifiers composed of data set names and field/column names.

### Two Data Set Qualified Selection List Join—Visible Join Argument or Function

Another implementation variant employing the qualified joinable data sets populates a visible join argument or function (with its own arguments) in the visualizer (e.g., in the visualizer input panel or some other visible panel or section within a panel of the visualizer) as exampled in FIG. 85 and FIG. 49. That argument or function, with its own arguments, may tell the user the join type (e.g., JOIN_FULL, JOIN_INNER, JOIN_LEFT), the join key fields/columns, the data sets, and/or other join parameters (e.g., data modelling cardinality, and key value match percentages) as exampled in FIG. 85, FIG. 14B, and FIG. 12C. The immediately visible argument may only tell the user that a join exists and require an action like clicking into the argument to see the join specifier details (e.g., join type, join keys, cardinality requirement, and/or key data value match requirement).

### Two Data Set Qualified Selection List Join—Qualified Joins Changed in Visualizer

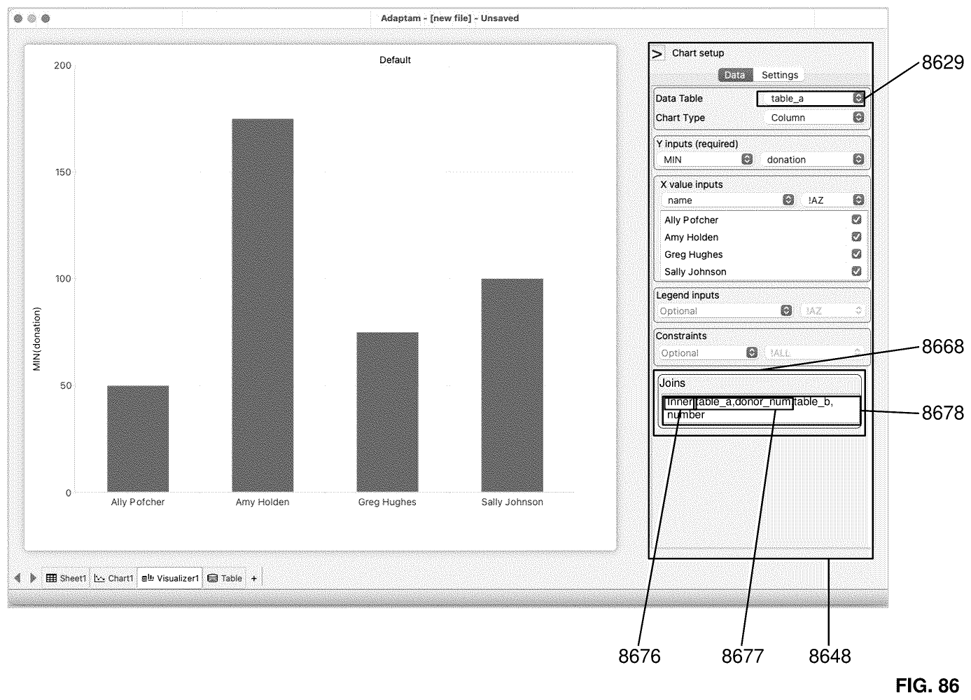

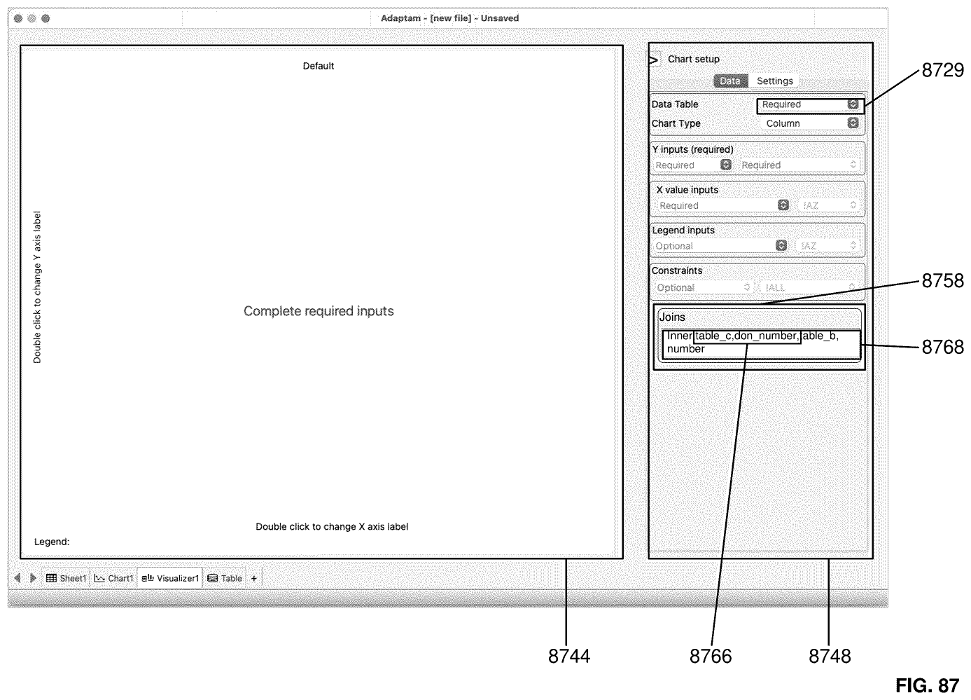

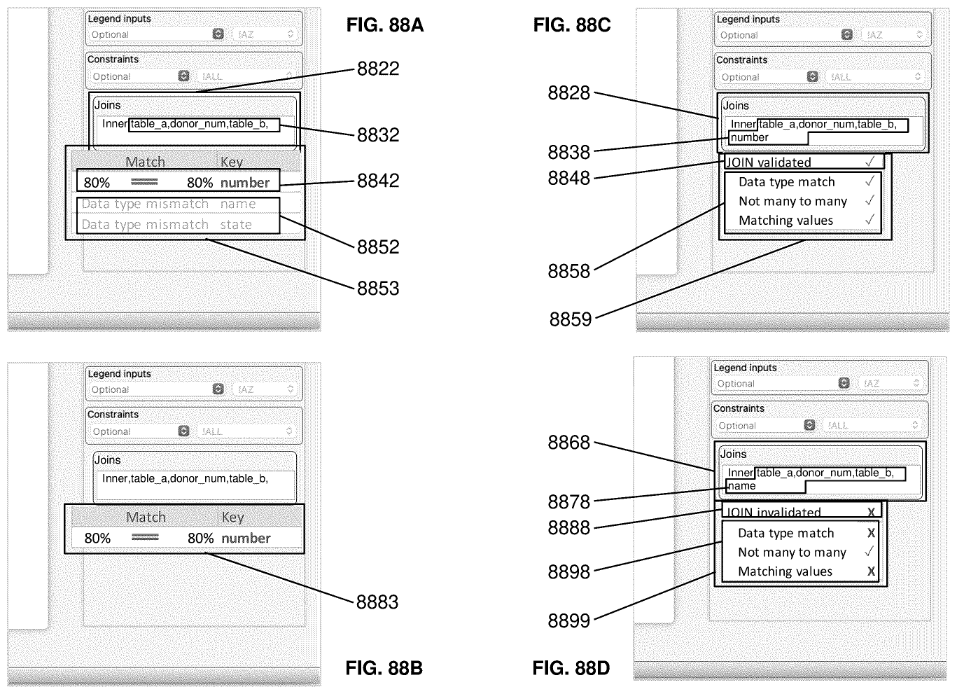

Implementations of our technology also support the overriding of a qualified join in a visualizer by inclusion of a join argument and/or a join prebuilt function changing the join type as exampled in FIG. 86 versus FIG. 85, where the user has a changed the join from a full outer join ‘FullOuter’ 8586 (in FIG. 85) to an inner ‘Inner’8676 (in FIG. 86). The user can change the join keys by typing or selecting different keys (or key and table combinations) in the respective arguments in 8778 in FIG. 87 versus those in 8678 in FIG. 86. This change from ‘table_a,donor_num’ 8677 in FIG. 86 to ‘table_c,don_number’ 8766 in FIG. 87 in this embodiment automatically triggers a reset of the chart inputs as ‘table_a’ 8629 in FIG. 86 is no longer a join table and inputs within the visualizer chart are therefore invalid rendering the chart 8744 also invalid with a ‘Complete required inputs’ message and a reset of the inputs as shown in FIG. 87. Different embodiments of our technology support those join changes in the visualizer tab with join creation selection list support. Ranging from selecting tables and joins as previously exampled in in FIG. 8 to the popups exampled in FIG. 88A through FIG. 88D and other variants of UIs exampled herein.

FIG. 88A and FIG. 88B example two join creation selection lists supported by our technology when a user has specified one data set, its join key, and the other data set. In FIG. 88A the user is working in the visualizer sidebar (input panel) ‘Joins’ input 8822 having specified one data set (‘table_a’) with its join key (‘donor_num’) and the other data set (‘table b’) 8832. This triggers the popup 8853 which includes validation information on the matches 8842 as well as failed validation tests 8852. It has also disabled the failed join keys 8852 to remove any chance of a user inadvertently selecting them. FIG. 88B examples the same situation but where the failed join keys 8852 in FIG. 88A are removed from the selection list 8883.

FIG. 88C and FIG. 88D example selection list join validation outcomes supported by our technology when a user has specified one data set, its join key and the other data set and its join key. In both figures the user is working in the visualizer sidebar (input panel) ‘Joins’ input 8828/8868 having specified one data set (‘table a’) with its join key (‘donor_num’) and the other data set (‘table b’) with its join key (‘number’ in FIG. 88C and ‘name’ in FIG. 88D) 8838/8878. In FIG. 88C the join input automatically triggers the popup 8859 which tests the join against a pre-set set of join qualification validation tests 8858 and in this example determines it has passed 8848. FIG. 88D conducts the same actions on the different join triggering the popup 8899 which tests the join against a pre-set set of join qualification validation tests 8898 where it failed two of the three and therefore it determines that the join has failed 8888 (i.e., failing any one of the tests in this embodiment results in the join invalidated).

### Two Data Set Qualified Selection List Join—in Visualizer Join Specification and Qualification

In another implementation the join can be added to the visualizer by the user via specifying a join argument or a prebuilt join function that specifies the join to be done in the formula, provides the joined data to be used in the formula calculation, and qualifies the joined data sets for the field selection lists as exampled in FIG. 34 (the join specification), FIG. 35 (the join execution), and FIG. 37 (use of the join data to produce the visualizer chart). As previously described that join can be added using any of the ways in FIG. 2, and any further combinations of manual and automated specification with the qualification tests in FIG. 3 using any of the applicable UIs herein. That join can use qualification UIs that include join qualification validation information as exampled in FIG. 8 and FIG. 88A. A further implementation goes further to automatically remove join key pairs that fail the validation tests as exampled in FIG. 88A and FIG. 88B or test a user specified pair for passing all the validation tests and if they fail any indicate to the user which were failed as exampled in FIG. 88C and FIG. 88D. FIG. 74 through FIG. 79 and FIG. 23 example an implementation where there are no prequalified joins and the user adds a join that once completed having the qualification flag supports selection lists used in the visualizer inputs to populate the joined fields which then deliver the chart using those joined fields.

### Two Data Set Qualified Selection List Join—in Formula Join Selection List Support

In another implementation the user creation of a join formula argument or join function within the visualizer, as exampled in FIG. 34, then has selection list support to help them users employ the joinable data, as exampled by the selection lists in FIG. 18B through FIG. 19E and FIG. 20B through FIG. 21E.

### Two Data Set Qualified Selection List Join—Qualification Ways

As previously described our technology supports many different ways to validate the qualification flag of a data set to data set join as exampled in FIG. 2. In one implementation the qualification validation is done by a human as laid out in FIG. 2 pathway ‘a/b/h’ and exampled in a UI in FIG. 9 (where the ‘ADD button simply adds the join), FIG. 12C and FIG. 12D.

In another implementation the human starts the process by specifying a join after which that join is goes through a further qualification step employing one or more validation test as exampled in FIG. 3. That join qualification pathway, exampled in FIG. 2 pathway ‘a/c/d/h’, can employ any one of the automated validation tests in FIG. 3 during step ‘d’. FIG. 10 and FIG. 88D example what a UI might look like if that join is rejected.

In another implementation the joins are automatically identified and qualified without human actions other than specifying the data sets. FIG. 2 pathway ‘a/g/h’ lays this out and it can be set up in our technology, so its automated validation testing uses any of the paths in FIG. 3 other than path A. A related implementation starts with the automated identification of the join key pairs but adds human qualification step allowing ideally a data savvy user to eliminate any auto validated join key pairs that while technically correct do not make sense as laid out in FIG. 2 pathway ‘a/e/f/h’. Such a pathway could be executed in a UI like 1145 in FIG. 11 where the user could then click ‘ADD’ 1148 to add the join to the ‘Existing joins’ 1158. FIG. 11 also examples how our technology can support more than one implementation together such as the ability to have FIG. 2 pathway ‘a/b/h’ coexist with pathway ‘a/e/f/h’ to make it easy for the user to add back pathways they may have previously rejected. There are combinations of the pathways such as the UI exampled in FIG. 8 where the user specified the two data sets and a join key in the first data set and our technology validated all the possible fields in the second data set leaving it for the user to decide between the multiple fields that passed all the validation tests (847 user selected and 857 not selected).

### Two Data Set Qualified Selection List Join—Qualification Location

As previously described our technology supports many different locations to validate the qualification of a data set to data set join as exampled in FIG. 1. In one implementation the qualification is done external to the spreadsheet in the data intake tool 135 in FIG. 1. A more detailed example of that could employ a UI as exampled in FIG. 8, FIG. 9, FIG. 10, and FIG. 11. In another implementation, which can co-exist with the previous implementation, the qualification is done within the spreadsheet in a data intake tool 145 in FIG. 1. This data intake tool can intake data both internal to the spreadsheet (i.e., data sets in cells) and external to the spreadsheet. A more detailed example of that could employ a UI as exampled in FIG. 8, FIG. 9, FIG. 10, and FIG. 11. In another implementation the join qualification is done in a spreadsheet wide (e.g., 155 in FIG. 1) capability with UIs exampled in FIG. 12A through FIG. 12D. And where any location within the spreadsheet, e.g., any cell or worksheet 165 and all visualizers 175 specified before the creating of this visualizer 185. Using any of the applicable UIs herein. As stated previously any of these forementioned qualification locations can coexist with any or all of the others. And any of them other than the first data intake location can requalify (change) a previously qualified data set to data set join qualification.

### Two Data Set Qualified Selection List Join—Join Qualification Validation Tests

Our technology supports the automatic application of many different types of qualification validation tests and combinations of those tests as exampled in FIG. 3. One implementation rejects a join where the join key fields in the two different data sets are not the same data type (e.g., numeric or finer cut to integer and floating point, text, and date) as exampled in failing to pass step ‘2’ in FIG. 3 and as exampled in 887 in FIG. 8, 8853 in FIG. 88A, and in FIG. 88D. Alternatively said, the implementation only accepts the join if both join keys are the same data type.

Another implementation rejects a join if join key pair field values have no overlaps, i.e., none of the same values shared in the two fields which therefore would append no data in the join or yield no rows of data in an inner join. Alternatively said, the implementation only accepts the join if at least one shared value is found in both of the two join keys This is exampled by failing to pass step ‘3’ in FIG. 3 and as exampled in 867 in FIG. 8, 8853 in FIG. 88A, and in FIG. 88D. That same implementation can reject the join if a minimum percentage of shared values is not found in one or both of the two join keys as exampled by failing to pass step ‘3a’ in FIG. 3, or if the values match values 853 or 855 in FIG. 8 had a minimum value below which they were rejected rather than flagged in red. Alternatively said, the implementation only accepts the join if a minimum percentage of shared values is found in one or both of the two join keys.

Another set of implementations rejects or does not reject joins based on the data modelling cardinality of the two join keys as exampled in failing to pass step ‘4’ in FIG. 3. Step ‘4’ rejects based non-unique to non-unique (many to many) joins, said differently accepts only unique to unique and unique to non-unique cardinality joins, as exampled in the data intake UI in FIG. 10 resulting from the action in FIG. 9. Or exampled in 877 in FIG. 8 and in FIG. 88C or FIG. 88D by the check mark indicating that the keys passed the test of being unique to unique or unique to non-unique but ‘Not many to many’ (non-unique to non-unique).

There are many additional variants of the data modelling cardinality implementations including a more rigorous rule rejecting joins that are not one to one (i.e., one join key value/record in a data set is associated with one and only one join key value/record in another data set). An additional implementation varies the modelling cardinality rule, applying one data modelling cardinality rule (e.g., reject many to many) at one qualification location and a different one (e.g., accept everything) at a different location. FIG. 34 examples where our technology blocks qualification of many to many (non-unique to non-unique) joins prior to the visualizer chart but then allows it in setting a join in the visualizer input panel.

### Two Data Set Qualified Selection List Join—Joinable Fields Selection List Types

Our technology supports many different visual representations of the joinable fields. FIG. 18B through FIG. 18E and FIG. 20B through FIG. 20E example an implementation that displays the joinable fields in a single selection list. However, in some instances where there are large numbers of fields in each data set and/or many data sets joined, presenting all the joinable fields in a single selection list can be overpowering and instead the joinable data is accessible in the first selection list and fully displayed in subsequent selection lists. FIG. 19A/B/C, FIG. 19A/D/E, FIG. 21A/B/C, and FIG. 21A/D/E example a first selection list where the joinable fields are accessible via a selection that takes the user to a second selection list displaying the joinable fields. In situations we will discuss later where there are more than two joinable data sets the accessing mode may differ. In different situations what we have labelled ‘ADD . . . ’ is actually substituting one field for another field and therefore the label ‘ADD’ for the action could be different in all situations or change by situation (e.g., change to ‘SUB . . . ’ when substituting one field/column for another field/column.

### Two Data Set Qualified Selection List Join—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. An application default join type can then be overridden by a user selection. All types of SQL joins are supported by our implementations but can also be more limited in their selection list as exampled in FIG. 75B. In other implementations the application has no default join type, and the join type is set by a user as exampled in FIG. 12C, FIG. 14B, and FIG. 75B. Where the user could set a default for all joins, or it is done on a join-by-join basis.

### Two Data Set Qualified Selection List Join—Joinable Field Replacement

Implementations of our technology not only support adding joinable fields to spreadsheet visualizer but also replacing (substituting) a field from one joinable data set by a field from one of the other joinable data sets as exampled in FIG. 15A through FIG. 24. This works the same way in our technology when there are more than one joinable data set.

### Two Data Set Qualified Selection List Join—Joinable Field Formula Usage

Implementations of our technology support usage in the broad spectrum of inputs as exampled herein with straight field/column inputs and inputs into formulas including prebuild functions and/or algebraic operators. Implementations support usage in a broad range of prebuilt spreadsheet functions (e.g., SQRT, COS, SUM, COUNT, STDEV) as exampled in FIG. 15A through FIG. 24, FIG. 26A through FIG. 30B, and FIG. 31A through FIG. 37. Our implementations also support usage of joined data fields in formulas containing many different combinations of functions within functions, combinations of functions and algebraic operators, many formulaic data fields and/or combinations of those combinations as exampled in FIG. 26A through FIG. 30B and FIG. 58A through FIG. 62B (recognizing that example is for a multiple join but a formula of that complexity and more could easily be for a single join).

### Two Data Set Qualified Selection List Join—Data Set Source

Implementations of our technology support data sets external to the spreadsheet (e.g., FIG. 6A, and FIG. 6B), data tables or data ranges within the cells of the spreadsheet (e.g., FIG. 7A, and FIG. 7B), and a combination of the two as described herein.

### Two Data Set Qualified Selection List Join—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

Implementations of our technology support more limited locations of qualifying joins as well as sequencing/chaining joins to join more than two data sets. Before moving to the implementations that sequence/chain joins we will outline the preferred embodiments where all aspects of creating the join are done within the visualizer inputs.

### In Visualizer Two Data Set Join

We are now moving on to a two-data set implementation not employing joins qualified before this visualizer chart inputs but instead employing joins that are populated in this visualizer. Creating those joins in the visualizer may or may not be supported by selection lists going beyond the typical function selection list found in other spreadsheets (e.g., Microsoft Excel or Google Sheets). And those joins may or may not create automatic joinable data selection lists for then using the joinable data in the visualizer inputs. The full range of these implementations start from the core implementation described next.

Implementations of our data set joining technology creating charts within a spreadsheet visualizer joining data from two data sets via a join specifier that sets up a join so that the joined data can be used to execute the chart. This join specifier comes in many different forms, for example at the simple end of the spectrum a set of arguments that specify the join type and the data sets with their keys as exampled in FIG. 80, through FIG. 84. Where an even simpler specifier would have an application set default join and therefore only specify the data sets with their keys. A more elaborate join specifier contains join qualification validation criteria such as data modelling cardinality and/or data key value match criteria as exampled in FIG. 74 through FIG. 79. Any of these join specifiers joins a first and second data set employing a first (join key) field/column in the first data set and a second (join key) field/column in the second data set. Once the user populates at least one field/column from each of the two data sets the join can be done by the visualizer and the joined data used to execute the chart as exampled in FIG. 78 with the join exampled in FIG. 23 2396, and charting action use of the joined data exampled in FIG. 79. As also exampled in FIG. 83 with the join exampled in FIG. 23 2396, and charting action use of the joined data exampled in FIG. 84.

### In Visualizer Two Data Set Join—Specified Keys and Join Type

Our technology supports many different join specifier implementations specifying the join within the visualizer input panel. FIG. 80, through FIG. 84 examples an implementation where the join specifier contains structured arguments specifying the join type, the data set one and its key and data set two and its key. In this example because the key field/column names are unique there is no need for data set arguments, but in a situation where that was not the case then they would be added. An even simpler specifier would have an application set default join and therefore only specify the data sets with their keys.

### In Visualizer Two Data Set Join—Specified Qualification Validation Requirement

Another implementation includes in the join specifier join qualification validation requirements. FIG. 74, through FIG. 79 examples an implementation where the join specifier contains structured arguments specifying the data modelling cardinality requirements (accept only unique to unique) and value matches for each of the key's values found in the other key (e.g., percentage of key rows with value found in the other key). While the example include all of these arguments, any one of them could be added to any mix and match combination of the other join specifier arguments.

### In Visualizer Two Data Set Join—Selection List Support

Our technology has implementations with selection list support extending well beyond the typical function selector found in existing spreadsheets. Those selection lists support very different activities. One set supports the setup of the join specifier while a second set supports the use of the joinable fields after the join setup.

### In Visualizer Two Data Set Join—Join Specifier Selection List Support

An implementation of our technology has data set and data field/column selection support for setting the join key fields/columns as exampled in FIGS. 75C and 75D. Further implementations go beyond presenting the join key options to supplying qualification validation requirements, results, or screening. FIG. 76A through FIG. 76C example an implementation where the join specifier specifies the qualification validation requirements for in this example data modelling cardinality and key value matches. FIG. 88A and FIG. 88B example an implementation that displays the performance of the specified join on those criteria as well as data type match between the join key fields/columns. FIG. 88C and FIG. 88D example an implementation that automatically qualifies the join and informs the user on whether it passes or fails showing how it does on each validation requirement. Along the same lines our technology supports many different ways to specify the joins and modes of determining whether to accept the join.

### In Visualizer Two Data Set Join—Join Qualification Validation Tests

Our technology supports the automatic application of many different types of qualification validation tests and combinations of those tests as exampled in FIG. 3. One implementation rejects a join where the join key fields in the two different data sets are not the same data type (e.g., numeric or finer cut to integer and floating point, text, and date) as exampled in failing to pass step ‘2’ in FIG. 3 and as exampled in 887 in FIG. 8, 8853 in FIG. 88A, and in FIG. 88D. Alternatively said, the implementation only accepts the join if both join keys are the same data type.

Another implementation rejects a join if join key pair field values have no overlaps, i.e., none of the same values shared in the two fields which therefore would append no data in the join or yield no rows of data in an inner join. Alternatively said, the implementation only accepts the join if at least one shared value is found in both of the two join keys This is exampled by failing to pass step ‘3’ in FIG. 3 and as exampled in 867 in FIG. 8, 8853 in FIG. 88A, and in FIG. 88D. That same implementation can reject the join if a minimum percentage of shared values is not found in one or both of the two join keys as exampled by failing to pass step ‘3a’ in FIG. 3, or if the values match values 853 or 855 in FIG. 8 had a minimum value below which they were rejected rather than flagged in red. Alternatively said, the implementation only accepts the join if a minimum percentage of shared values is found in one or both of the two join keys.

Another set of implementations rejects or does not reject joins based on the data modelling cardinality of the two join keys as exampled in failing to pass step ‘4’ in FIG. 3. Step ‘4’ rejects based non-unique to non-unique (many to many) joins, said differently accepts only unique to unique and unique to non-unique cardinality joins, as exampled in the data intake UI in FIG. 10 resulting from the action in FIG. 9. Or exampled in 877 in FIG. 8 and in FIG. 88C or FIG. 88D by the check mark indicating that the keys passed the test of being unique to unique or unique to non-unique but ‘Not many to many’ (non-unique to non-unique).

There are many additional variants of the data modelling cardinality implementations including a more rigorous rule rejecting joins that are not one to one (i.e., one join key value/record in a data set is associated with one and only one join key value/record in another data set).

### In Visualizer Two Data Set Join—Joinable Fields Selection List Types

Our technology supports many different visual representations of the joinable fields. FIG. 77 7759, FIG. 18B through FIG. 18E, and FIG. 20B through FIG. 20E example an implementation that displays the joinable fields in a single selection list. However, in some instances where there are large numbers of fields in each data set and/or many data sets joined, presenting all the joinable fields in a single selection list can be overpowering and instead the joinable data is accessible in the first selection list and fully displayed in subsequent selection lists. FIG. 19A/B/C, FIG. 19A/D/E, FIG. 21A/B/C, and FIG. 21A/D/E example a first selection list where the joinable fields are accessible via a selection that takes the user to a second selection list displaying the joinable fields. In situations we will discuss later where there are more than two joinable data sets the accessing mode may differ. In different situations what we have labelled ‘ADD . . . ’ is actually substituting one field for another field and therefore the label ‘ADD’ for the action could be different in all situations or change by situation (e.g., change to ‘SUB . . . ’ when substituting one field/column for another field/column.

### In Visualizer Two Data Set Join—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. An application default join type can then be overridden by a user selection. All types of SQL joins are supported by our implementations but can also be more limited in their selection list as exampled in FIG. 75B.

### In Visualizer Two Data Set Join—Joinable Field Formula Usage

Implementations of our technology support usage in the broad spectrum of inputs as exampled herein with straight field/column inputs and inputs into formulas including prebuild functions and/or algebraic operators. Implementations support usage in a broad range of prebuilt spreadsheet functions (e.g., SQRT, COS, SUM, COUNT, STDEV) as exampled in FIG. 74 through FIG. 84, FIG. 15A through FIG. 24, FIG. 26A through FIG. 30B, and FIG. 31A through FIG. 37. Our implementations also support usage of joined data fields in formulas containing many different combinations of functions within functions, combinations of functions and algebraic operators, many formulaic data fields and/or combinations of those combinations as exampled in FIG. 26A through FIG. 30B and FIG. 58A through FIG. 62B (recognizing that example is for a multiple join but a formula of that complexity and more could easily be used with a single join).

### In Visualizer Two Data Set Join—Data Set Source

Implementations of our technology support data sets external to the spreadsheet (e.g., FIG. 6A, and FIG. 6B), data tables or data ranges within the cells of the spreadsheet (e.g., FIG. 7A, and FIG. 7B), and a combination of the two as described herein.

### In Visualizer Two Data Set Join—Integration of Panels

Implementations of our join technology support different variants of the visualizer input panel and the visualizer chart panel as described in our U.S. application Ser. No. 18/074,301 titled “Method and System for Improved Visualization of Charts in Spreadsheets,” filed 2 Dec. 2022 and incorporated herein. Those implementations include a variant where the visualizer input panel is incorporated into the visualizer chart panel.

### In Visualizer Two Data Set Join—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

### Chain Qualified Selection List Joins

As previously discussed, our data set joining technology supports joining more than two data sets. When there is no overlap between the joined data sets then that is just multiple implementations of the two data set join implementations just discussed. However, when the pairs of data sets include a common data set then those joined data sets can chain together in our technology to join all three of the data sets (e.g., two pairs of two data sets with one shared data set). In our technology that chaining is not limited to three data sets but can continue on until there are no additional chain possibilities, subject to data modelling cardinality limitations (if specified) which may invalidate some of the chain joins. There is one specialized additional situation worth discussion which is multiple joins between two data sets which chain together to effectively create more than two data sets. For example, two data sets employing two pairs of join keys between the two data sets sharing one common join key effectively creates two joins and the equivalent of three data sets out of the two data sets as we will example later. Our technology also supports chaining of the multiple joins between two data sets and joins to other data sets. All these situations are supported for any of the applicable SQL join types (e.g., full outer, inner, and left outer).

### Chain Qualified Selection List Joins—One or More Chained Join

There are many different variants of the chained/sequenced join technology so we will first describe the core implementation for one or more chained/sequenced joins and then more specific variations. The implementation starts by individually qualifying the joinability of the multiple data sets based on the fields/columns in each data set pair specified join keys. That qualification flag setting can be done in many different locations, as exampled in FIG. 1 and in many different ways, as exampled in FIG. 2, with the validation of the join qualification being tested (validated) in different paths, as exampled in FIG. 3. FIG. 12A through FIG. 12D examples UIs used to access and setup joins for all the tabs within a spreadsheet (including the visualizer tabs). FIG. 14A and FIG. 14B examples UIs used to access, and setup joins within a visualizer which then could apply to that visualizer tab itself or to that visualizer tab and all subsequent visualizer tabs.

Then our technology determines the joinable data set pairs that can also be sequence/chain joined. In most, but not all, situations if the qualified joinable data sets pairs contain a common data set they can be chained. The exception would be if there is a data modelling cardinality constraint that the chained join fails but both of the pairs’ pass, as we example in FIG. 50A through 54. In those situations, the joined combination of the data sets is not sequence/chained joinable and only the pairs of data sets will be joinable. Our technology does not require the pairs of data set joins to share any common join keys to sequence/chain joins as exampled in FIG. 38A through FIG. 43B, FIG. 44A through FIG. 49 and FIG. 58A through FIG. 62B.

With the individual joins and sequenced/chained joins setting a qualification flag, once the user populates one of the fields from those joinable data sets our technology displays a way for the user to access and select the fields in the other joinable data sets in a selection list as exampled in FIG. 18B through FIG. 19E, FIG. 20B through FIG. 21E, FIG. 41A through FIG. 41F, and FIG. 52 for a user entering their first field and as exampled in FIG. 40 4049 (first field), FIG. 66 (second field), and FIG. 67 (third field) for a user entering or altering a field later in the formula. Once the user has selected at least one field from the two joinable data sets requiring a sequenced/chained join and executed the visualizer chart our technology sequence/chain joins the data, as exampled in FIG. 47, FIG. 60, and FIG. 65, and uses it to determine the outcome of the spreadsheet visualizer as exampled in FIG. 46, FIG. 59, and FIG. 68 via the supporting illustrative visualizer actions/calculations, as exampled in FIG. 48A/B, FIG. 61A through FIG. 62B, and FIG. 69A/B.

### Chain Qualified Selection List Joins—One Chained Join

We will now describe an implementation for a one chained/sequenced join, using the example in FIG. 44A through FIG. 49 and FIG. 89, so that we can get very specific on the fields and the joins. We are going to call ‘table_aa’ 4432 in FIG. 44A data set one as it has qualification flag joins to both of the other tables, ‘table_bb’ 4435 (data set two) and ‘table_cc’ 4438 (data set three), as exampled in FIG. 44B, and FIG. 45A/B.

The qualification flag setting can be done in many different locations, as exampled in FIG. 1 and in many different ways, as exampled in FIG. 2, with the validation of the join qualification being tested (validated) in different paths, as exampled in FIG. 3. FIG. 12A through FIG. 12D examples UIs used to access and setup joins for all the tabs within a spreadsheet (including the visualizer tabs). FIG. 14A and FIG. 14B examples UIs used to access, and setup joins within a visualizer which then could apply to that visualizer tab itself or to that visualizer tab and all subsequent visualizer tabs. FIG. 8 examples a UI that could be used to qualify the joins external to the spreadsheet or in the spreadsheet.

The qualification join flag setting for the chained join could be set manually by a user in our implementations but most frequently is automatically executed once the individual joins are determined applying an accepted data modelling cardinality or set of cardinalities. As previously exampled the acceptable data modelling cardinality can vary by the location of where it was set. It can be the same as for the individual join validation flag or could be specified separately. FIG. 44A through FIG. 49 examples a situation where the chained/sequenced cardinality rule is the same as for the individual joins and automatically evaluates and then accepts the chained join between data sets two and three (because it passed the cardinality requirements). FIG. 50A through FIG. 54 examples a situation where the chained/sequenced cardinality rule is the same as for the individual joins but automatically rejects the chained join between its data sets two and three.

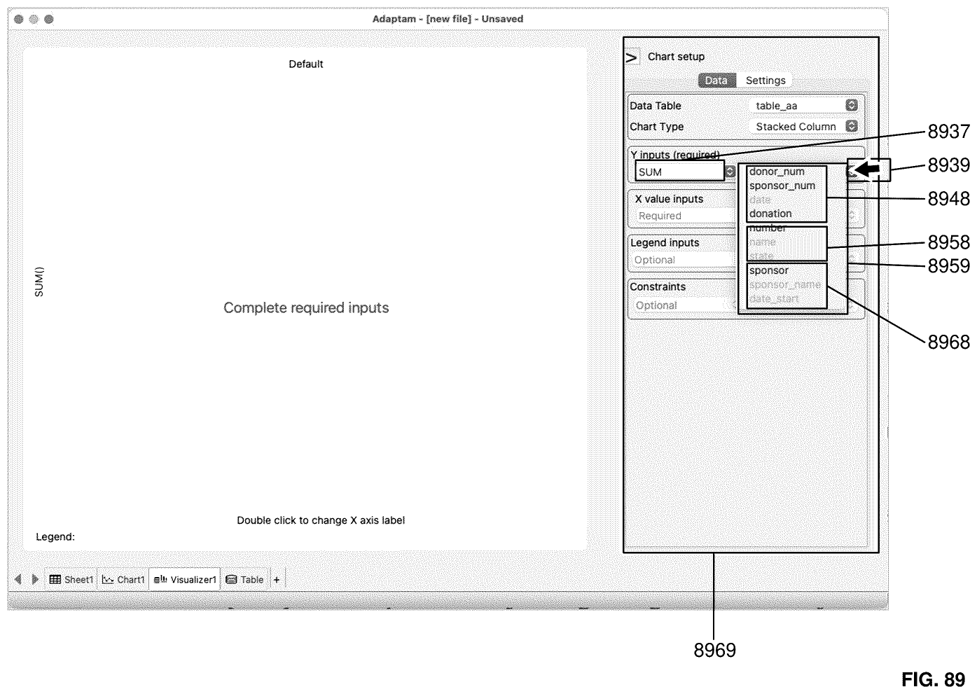

Returning to our example, when the user opens 8939 the first field selection list 8959 in FIG. 89 in the visualizer input panel 8969, they automatically see a selection list displaying access to the fields in data set one 8948, data set two 8958 and data set three 8968 in the selection list 8959. In this embodiment and situation disabling (but not hiding) the non-numeric fields because of the SUM function 8937. Our technology supports many different ways to display the joinable fields selection list as example in FIG. 18B through FIG. 18E (one step), FIG. 20B through FIG. 20E (one step), FIG. 19A through FIG. 19E (two step), FIG. 21A through FIG. 21E (two step), and FIG. 41A through FIG. 41F (three step). Once the user has entered fields into the visualizer input that requires the chained/sequence join and completes the visualizer requirements our technology automatically executes the chained join (FIG. 47,) for all the fields in the visualizer inputs, and uses the joined fields to execute the actions (FIG. 48A/B) that deliver the visualizer chart (FIG. 46).

### Chain Qualified Selection List Joins—Qualification Before Visualizer

Our technology supports many different ways to qualify the join flag. In one implementation the join qualifying is done in a data intake tool where the data is prepared most typically by a single user for use by all the spreadsheet users employing that combination of data sets. That way the typical spreadsheet user (not the user qualifying the joins) does not have to deal with the mechanics of determining the join keys and/or the join type when they are creating a spreadsheet visualizer. So that the qualified joinable fields are simply available to them in selection lists for use in the visualizer. In this implementation the data set join keys are determined, and qualification flag validated before this visualizer tab as exampled in the UIs in FIG. 8, FIG. 9, FIG. 10, and FIG. 11. It is also exampled FIG. 1 for the boxes corresponding to ‘INTAKE—External to spreadsheet’ qualification 135, recognizing that for reasons of conciseness FIG. 1 does not example all the possible combinations supported by our technology including those with combined external and in-cell data sets.

However, our technology supports many other qualification locations before in-cell as exampled by ‘INTAKE—in spreadsheet’ 145 in FIG. 1 where the spreadsheet user qualifies, with or with automated qualification validation, join keys as exampled in paths ‘B’ and ‘I’ in FIG. 1. That can employ a UI similar to those in FIG. 8, FIG. 9, FIG. 10, and FIG. 11. Our technology also supports ‘Spreadsheet capability’ 155 and ‘Any cell or any worksheet’ 165 level join keys qualification which automatically applies to the visualizers (tabs or visualizers embedded in worksheets). With the join setting and qualification done in a UI like those exampled in FIG. 12A through FIG. 12D or any applicable parts of the other join setup UIs.

Our technology also supports qualification first set in one location and then reset to something else in another location as exampled in the extreme situations in paths ‘G’ and ‘N’ in FIG. 1. All the mix and match combinations were not illustrated for brevity's sake. The ‘All Visualizers’ 175 is also applicable provided the join was created prior to ‘This Visualizer’ where the user is currently creating a chart (see FIG. 14B for an example UI).

Our technology supports chained/sequenced joins automatically following the data modelling cardinality used for the individual joins as well as letting the user specify something different through a rule set or individual chained/sequenced join validation flag setting.

### Chain Qualified Selection List Joins—Invisible Join Argument

A further implementation employing the before visualizer qualified joinable data sets requires no visible join argument or join function in the visualizer inputs as exampled in FIG. 40, FIG. 46, FIG. 59, FIG. 68, and FIG. 72. Therefore, the typical user does not need to deal with the complexity of seeing the join keys and join type but simply sees the fields/columns they desire in the formula. In all these examples the fields/columns have unique names not requiring the inclusion of a data set in the field/column identifier (naming), but our technology supports data identifiers composed of data set names and field/column names.

### Chain Qualified Selection List Joins—Visible Join Argument or Function

Another implementation variant employing the qualified joinable data sets populates a visible join argument or function (with its own arguments) in the visualizer (e.g., in the visualizer input panel or some other visible panel or section within a panel of the visualizer) as exampled in FIG. 85 and FIG. 49. That argument or function, with its own arguments, may tell the user the join type (e.g., JOIN_FULL, JOIN_INNER, JOIN_LEFT), the join key fields/columns, the data sets, and/or other join parameters (e.g., data modelling cardinality, and key value match percentages) as exampled in FIG. 85, FIG. 14B, and FIG. 12C. The immediately visible argument may only tell the user that a join exists and require an action like clicking into the argument to see the join specifier details (e.g., join type, join keys, cardinality requirement, and/or key data value match requirement).

### Chain Qualified Selection List Joins—Qualified Joins Changed in Formula

Implementations of our technology also support the overriding of a qualified join in a visualizer by inclusion of a join argument and/or a join prebuilt function changing the join type as exampled in FIG. 86 versus FIG. 85. The user can change the join keys by typing or selecting different tables and/or keys in the join specifier as exampled in FIG. 87 versus FIG. 86. Different embodiments of our technology support those join changes in the visualizer tab with selection list support. Ranging from selecting tables and joins as previously exampled in in FIG. 8 to the popups exampled in FIG. 88A through FIG. 88D and other variants of UIs exampled herein and in our U.S. application Ser. No. 18/074,301 titled, “Method and System for Improved Visualization of Charts in Spreadsheets,” filed 2 Dec. 2022 which claims the benefit of U.S. Provisional Patent Application No. 63/25,945, filed 3 Dec. 2021.

### Chain Qualified Selection List Joins—Same Data Sets Multiple Joins

In an implementation of our technology two or more joins are supported between the same two data sets provided those joins share the same first field in the first data set but have different second fields in the second data set as exampled in FIG. 63A through FIG. 74. Both of those joins can be qualified in our technology and be accessible in the same selection lists although with an additional change to differentiate their field/column names, so the two different joins are distinguishable. Our technology automatically implements the field/column joinable data name changes to the fields/columns in the first data sets so that they are differentiated when used in the joins. Those names could be anything that differentiates the fields/columns from their original fields/columns and that then differentiates the multiple join variants from each other. In one implementation our technology appends the respective first data sets first field/column names to the second data set field/column names. In another implementation it appends those respective first data sets first field/column names to the second data set field names prefaced (prefixed) with an ‘->‘(e.g., ‘field/column name dataset one->second field/column name in second data’ set like’state->sponsor_num’) so that it displays as exampled in FIG. 66 6677/6687,FIG. 67 6757/6779/6789, FIG. 68 6857/6877, FIG. 70 7076/7086, FIG. 71 7134, and FIG. 72 7249/7257.

### Chain Qualified Selection List Joins—in Visualizer Join Specification and Qualification

In another implementation the join can be added to the visualizer by the user via a join specifier join argument or a join specifier prebuilt function that specifies the join to be done in the formula, provides the joined data to be used in the formula calculation, and qualifies the joined data sets for the field selection lists as exampled in FIG. 34 (the join specification), FIG. 35 (the join execution), and FIG. 37 (use of the join data to produce the visualizer chart) and examples for chained/sequenced joins in FIG. 90 (the join specification), FIG. 47 (the join execution), and FIG. 91 (use of the join data to produce the visualizer chart). As previously described that join can be added using any of the ways in FIG. 2, and any further combinations of manual and automated specification with the qualification tests in FIG. 3 using any of the applicable UIs herein (e.g., in FIG. 75B through FIG. 76C). That join can use qualification UIs that include join qualification validation information as exampled in FIG. 8 and FIG. 88A. A further implementation goes further to automatically remove join key pairs that fail the validation tests as exampled in FIG. 88A and FIG. 88B or test a user specified pair for passing all the validation tests and if they fail any indicate to the user which were failed as exampled in FIG. 88C and FIG. 88D.

### Chain Qualified Selection List Joins—in Visualizer Joinable Data Selection List Support

In a related implementation after the user creation of a join formula argument or join function within the visualizer join specifier, as exampled in FIG. 34, then has selection list support to help them users employ the joinable data, as exampled by the selection lists in FIG. 18B through FIG. 19E and FIG. 20B through FIG. 21E. With the specification of chained/sequenced joins the user also automatically has selection list support as exampled in FIG. 41A through FIG. 41F.

### Chain Qualified Selection List Join—Qualification Ways

As previously described our technology supports many different ways to validate the qualification flag of a data set to data set join as exampled in FIG. 2. In one implementation the qualification validation is done by a human as laid out in FIG. 2 pathway ‘a/b/h’ and exampled in a UI in FIG. 9 (where the ‘ADD button simply adds the join), FIG. 12C and FIG. 12D.

In another implementation the human starts the process by specifying a join after which that join is goes through a further qualification step employing one or more validation test as exampled in FIG. 3. That join qualification pathway, exampled in FIG. 2 pathway ‘a/c/d/h’, can employ any one of the automated validation tests in FIG. 3 during step ‘d’. FIG. 10 and FIG. 88D example what a UI might look like if that join is rejected.

In another implementation the joins are automatically identified and qualified without human actions other than specifying the data sets. FIG. 2 pathway ‘a/g/h’ lays this out and it can be set up in our technology, so its automated validation testing uses any of the paths in FIG. 3 other than path A. A related implementation starts with the automated identification of the join key pairs but adds human qualification step allowing ideally a data savvy user to eliminate any auto validated join key pairs that while technically correct do not make sense as laid out in FIG. 2 pathway ‘a/e/f/h’. Such a pathway could be executed in a UI like 1145 in FIG. 11 where the user could then click ‘ADD’ 1148 to add the join to the ‘Existing joins’ 1158. FIG. 11 also examples how our technology can support more than one implementation together such as the ability to have FIG. 2 pathway ‘a/b/h’ coexist with pathway ‘a/e/f/h’ to make it easy for the user to add back pathways they may have previously rejected. There are combinations of the pathways such as the UI exampled in FIG. 8 where the user specified the two data sets and a join key in the first data set and our technology validated all the possible fields in the second data set leaving it for the user to decide between the multiple fields that passed all the validation tests (847 user selected and 857 not selected).

### Chain Qualified Selection List Join—Qualification Location

As previously described our technology supports many different locations to validate the qualification of a data set to data set join as exampled in FIG. 1. In one implementation the qualification is done external to the spreadsheet in the data intake tool 135 in FIG. 1. A more detailed example of that could employ a UI as exampled in FIG. 8, FIG. 9, FIG. 10, and FIG. 11. In another implementation, which can co-exist with the previous implementation, the qualification is done within the spreadsheet in a data intake tool 145 in FIG. 1. This data intake tool can intake data both internal to the spreadsheet (i.e., data sets in cells) and external to the spreadsheet. A more detailed example of that could employ a UI as exampled in FIG. 8, FIG. 9, FIG. 10, and FIG. 11. In another implementation the join qualification is done in a spreadsheet wide (e.g., 155 in FIG. 1) capability with UIs exampled in FIG. 12A through FIG. 12D. And where any location within the spreadsheet, e.g., ‘Worksheet capability’ 165 and ‘All Visualizers’ 175 specified before the creating of this visualizer 185. Using any of the applicable UIs herein. As stated previously any of these forementioned qualification locations can coexist with any or all of the others. And any of them other than the first data intake location can requalify (change) a previously qualified data set to data set join qualification.

### Chain Qualified Selection List Join—Join Qualification Validation Tests

Our technology supports the automatic application of many different types of qualification validation tests and combinations of those tests as exampled in FIG. 3. One implementation rejects a join where the join key fields in the two different data sets are not the same data type (e.g., numeric or finer cut to integer and floating point, text, and date) as exampled in failing to pass step ‘2’ in FIG. 3 and as exampled in 887 in FIG. 8, 8853 in FIG. 88A, and in FIG. 88D. Alternatively said, the implementation only accepts the join if both join keys are the same data type. In chain joined situations this validation applies to the individual joins which once individually validated there is no data type validation across the two sets of join keys.

Another implementation rejects a join if join key pair field values have no overlaps, i.e., none of the same values shared in the two fields which therefore would append no data in the join or yield no rows of data in an inner join. Alternatively said, the implementation only accepts the join if at least one shared value is found in both of the two join keys This is exampled by failing to pass step ‘3’ in FIG. 3 and as exampled in 867 in FIG. 8, 8853 in FIG. 88A, and in FIG. 88D. That same implementation can reject the join if a minimum percentage of shared values is not found in one or both of the two join keys as exampled by failing to pass step ‘3a’ in FIG. 3, or if the values match values 853 or 855 in FIG. 8 had a minimum value below which they were rejected rather than flagged in red. Alternatively said, the implementation only accepts the join if a minimum percentage of shared values is found in one or both of the two join keys. Again, these validations apply at the individual join and once approved there is no across the multiple joins validation in chain joining on this dimension.

Another set of implementations rejects or does not reject joins based on the data modelling cardinality of the two join keys as exampled in failing to pass step ‘4’ in FIG. 3. Step ‘4’ rejects based non-unique to non-unique (many to many) joins, said differently accepts only unique to unique and unique to non-unique cardinality joins, as exampled in the data intake UI in FIG. 10 resulting from the action in FIG. 9. Or exampled in 877 in FIG. 8 and in FIG. 88C or FIG. 88D by the check mark indicating that the keys passed the test of being unique to unique or unique to non-unique but ‘Not many to many’ (non-unique to non-unique). This validation can be different in that it can apply at the individual join and then can be reapplied across the chain joins as we will example in later implementations. So individual joins that pass the validation can then fail the validation when chained.

There are many additional variants of the data modelling cardinality implementations including a more rigorous rule rejecting joins that are not one to one (i.e., one join key value/record in a data set is associated with one and only one join key value/record in another data set). An additional implementation varies the modelling cardinality rule, applying one data modelling cardinality rule (e.g., reject many to many) at one qualification location and a different one (e.g., accept everything) at a different location. FIG. 34 examples where our technology blocks qualification of many to many (non-unique to non-unique) joins prior to the visualizer chart but then allows it in setting a join in the visualizer input panel.

Another implementation is exampled in FIG. 50 through FIG. 57A where the individual joins pass the data modelling cardinality qualification tests (e.g., accept only unique to unique and unique to non-unique) but the chained/sequenced joins do not. In that situation our technology supports automatically acting on it (e.g., FIG. 50 through FIG. 54) or letting a user override the situation (e.g., FIG. 55 through FIG. 57B).

### Chain Qualified Selection List Join—Joinable Fields Selection List Types

Our technology supports many different visual representations of the joinable fields. FIG. 18B through FIG. 18E and FIG. 20B through FIG. 20E example an implementation that displays the joinable fields in a single selection list. However, in some instances where there are large numbers of fields in each data set and/or many data sets joined, presenting all the joinable fields in a single selection list can be overpowering and instead the joinable data is accessible in the first selection list and fully displayed in subsequent selection lists. FIG. 19A/B/C, FIG. 19A/D/E, FIG. 21A/B/C, and FIG. 21A/D/E example a first selection list where the joinable fields are accessible via a selection that takes the user to a second selection list displaying the joinable fields. In situations we will discuss later where there are more than two joinable data sets the accessing mode may differ. In different situations what we have labelled ‘ADD . . . ’ is actually substituting one field for another field and therefore the label ‘ADD’ for the action could be different in all situations or change by situation (e.g., change to ‘SUB . . . ’ when substituting one field/column for another field/column.

In chain/sequenced joined data our technology supports a first selection list where the joinable fields are accessible via a selection that takes the user to a second selection list that displays the joinable data sets that then takes the user to a third selection list displaying the joinable fields for the table selected in the second selection list as exampled in FIG. 41A through FIG. 41F.

### Chain Qualified Selection List Join—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. An application default join type can then be overridden by a user selection. All types of SQL joins are supported by our implementations but can also be more limited in their selection list as exampled in FIG. 75B. In other implementations the application has no default join type, and the join type is set by a user as exampled in FIG. 12C, FIG. 14B, and FIG. 75B. Where the user could set a default for all joins, or it is done on a join-by-join basis.

### Chain Qualified Selection List Join—Joinable Field Replacement

Implementations of our technology not only support adding joinable fields to spreadsheet visualizer but also replacing (substituting) a field from one joinable data set by a field from one of the other joinable data sets as exampled in FIG. 15A through FIG. 24. This works the same way in our technology when there are more than one joinable data set.

### Chain Qualified Selection List Join—Joinable Field Formula Usage

Implementations of our technology support usage in the broad spectrum of inputs as exampled herein with straight field/column inputs and inputs into formulas including prebuild functions and/or algebraic operators. Implementations support usage in a broad range of prebuilt spreadsheet functions (e.g., SQRT, COS, SUM, COUNT, STDEV) as exampled in FIG. 15A through FIG. 24, FIG. 26A through FIG. 30B, and FIG. 31A through FIG. 37. Our implementations also support usage of joined data fields in formulas containing many different combinations of functions within functions, combinations of functions and algebraic operators, many formulaic data fields and/or combinations of those combinations as exampled in FIG. 26A through FIG. 30B and FIG. 58A through FIG. 62B.

### Chain Qualified Selection List Join—Data Set Source

Implementations of our technology support data sets external to the spreadsheet (e.g., FIG. 6A, and FIG. 6B), data tables or data ranges within the cells of the spreadsheet (e.g., FIG. 7A, and FIG. 7B), and a combination of the two as described herein.

### Chain Qualified Selection List Joins—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

Our technology supports other implementations of the chained/sequenced joins as we will now layout.

### In Visualizer Chained Joins

Implementations of our technology support chained/sequenced joins not employing prequalified joins used for selection lists but instead employing joins that are populated in the visualizer. Creating those joins in the visualizer may or may not be supported by selection lists going beyond the typical function selection list found in other spreadsheets (e.g., Microsoft Excel or Google Sheets). And those chained/sequenced joins may or may not create automatic joinable data selection lists for then more easily using the chain/sequence joinable data in the visualizer inputs. The full range of these implementations start from the core implementation described next.

In these implementations the user sets up in a join specifier more than one pair of joins that can be chained/sequenced joined to be used with the other visualizer inputs to execute a chained/sequenced chart. This join specifier comes in many different forms, with a version exampled in FIG. 92 through FIG. 94B having no selection list support and typical spreadsheet syntax guides. FIG. 92 examples our visualizer with a chart output panel 9244 and visualizer input panel 9247 that includes a join specifier 9248. Where the join specifier 9248 has accepted a join input 9258 between a first data set (‘table_aa’ 4732 in FIG. 47) and a second data set (‘table_bb’ 4735 in FIG. 47) and is in process to accepting a join input 9268 between the first data set (‘table_aa’ 4732 in FIG. 47) and a third data set (‘table_cc’ 4738 in FIG. 47). The user is typing these join input arguments using the syntax guide 9278 (typical spreadsheet syntax guide laying out arguments) to inform their inputs. Once the user hits ENTER/RETURN on the second join arguments 9268 (9399 in FIG. 93) the visualizer is ready to individually join data sets one and two (via join 9398 in FIG. 93) and data sets one and three (via join 9399 in FIG. 93) and automatically or manually qualify the chain/sequence join of data set two and three. Once that has taken place, as in exampled in FIG. 93, the user can input fields from the second and third data sets to utilize that chain/sequence join as exampled by the input of ‘sponsor_name’ 9357 from data set three (‘table_cc’ 4738 in FIG. 47) and ‘state’ 9377 from data set two (‘table_bb’ 4735 in FIG. 47). In this example the user also type inputs the field/column ‘donation’ in the ‘SUM(donation)’ input 9349 from data set one (‘table_aa’ 4732 in FIG. 47). Those inputs then chain/sequence join the three data sets to create the visualizer chart 9344 as illustratively exampled in the join 4754 in FIG. 47 and then the actions in FIG. 94A and FIG. 94B. Note, in this embodiment the user does not start selecting a data set in a ‘Data Table’ input, but the selection of the fields determines the data sets used (because the fields are unique to a data set). The user does select a ‘Chart Type’ 9339 or goes with the default starting ‘Chart Type’ setting.

A similar process with extensive selection list support creating the joins and then using those joins to accomplish the same outcome is exampled in FIG. 90 through FIG. 91B and two passes through FIG. 75A through FIG. 75F to set up the joins and multiple usages of the selection lists supporting using the joinable data as exampled in FIG. 18B through FIG. 19E, FIG. 20B through FIG. 21E, or FIG. 41A through FIG. 41F.

### In Visualizer Chained Joins—Specified Keys and Join Type

Our technology supports many different join specifier implementations specifying the join within the visualizer input panel. FIG. 92 through FIG. 94B and FIG. 90 through FIG. 91B example implementations where the join specifier contains structured arguments specifying the join type, the data set one and its key and data set two and its key. In this example because the key field/column names are unique there is no need for data set arguments, but in a situation where that was not the case then they would be added. An even simpler specifier would have an application set default join and therefore only specify the data sets with their keys. Joins containing more arguments are exampled in FIG. 14B and FIG. 75A and FIG. 76E.

### In Visualizer Chained Joins—Specified Qualification Validation Requirement

Another implementation includes in the join specifier join qualification validation requirements. FIG. 74, through FIG. 79 examples an implementation where the join specifier contains structured arguments specifying the data modelling cardinality requirements (accept only unique to unique) and value matches for each of the keys’ values found in the other key (e.g., percentage of key rows with value found in the other key). While the example include all of these arguments, any one of them could be added to any mix and match combination of the other join specifier arguments.

### In Visualizer Chained Joins—Selection List Support

Our technology has implementations with selection list support extending well beyond the typical function selector found in existing spreadsheets. Those selection lists support very different activities. One set supports the setup of the join specifier while a second set supports the use of the joinable fields after the join setup.

### In Visualizer Chained Joins—Join Specifier Selection List Support

An implementation of our technology has data set and data field/column selection support for setting the join key fields/columns as exampled in FIGS. 75C and 75D. Further implementations go beyond presenting the join key options to supplying qualification validation requirements, results, or screening. FIG. 76A through FIG. 76C example an implementation where the join specifier specifies the qualification validation requirements for in this example data modelling cardinality and key value matches. FIG. 88A and FIG. 88B example an implementation that displays the performance of the specified join on those criteria as well as data type match between the join key fields/columns. FIG. 88C and FIG. 88D example an implementation that automatically qualifies the join and informs the user on whether it passes or fails showing how it does on each validation requirement. Along the same lines our technology supports many different ways to specify the joins and modes of determining whether to accept the join.

### In Visualizer Chained Joins—Join Qualification Validation Tests

Our technology supports the automatic application of many different types of qualification validation tests and combinations of those tests as exampled in FIG. 3. One implementation rejects a join where the join key fields in the two different data sets are not the same data type (e.g., numeric or finer cut to integer and floating point, text, and date) as exampled in failing to pass step ‘2’ in FIG. 3 and as exampled in 887 in FIG. 8, 8853 in FIG. 88A, and in FIG. 88D. Alternatively said, the implementation only accepts the join if both join keys are the same data type.

Another implementation rejects a join if join key pair field values have no overlaps, i.e., none of the same values shared in the two fields which therefore would append no data in the join or yield no rows of data in an inner join. Alternatively said, the implementation only accepts the join if at least one shared value is found in both of the two join keys This is exampled by failing to pass step ‘3’ in FIG. 3 and as exampled in 867 in FIG. 8, 8853 in FIG. 88A, and in FIG. 88D. That same implementation can reject the join if a minimum percentage of shared values is not found in one or both of the two join keys as exampled by failing to pass step ‘3a’ in FIG. 3, or if the values match values 853 or 855 in FIG. 8 had a minimum value below which they were rejected rather than flagged in red. Alternatively said, the implementation only accepts the join if a minimum percentage of shared values is found in one or both of the two join keys.

Another set of implementations rejects or does not reject joins based on the data modelling cardinality of the two join keys as exampled in failing to pass step ‘4’ in FIG. 3. Step ‘4’ rejects based non-unique to non-unique (many to many) joins, said differently accepts only unique to unique and unique to non-unique cardinality joins, as exampled in the data intake UI in FIG. 10 resulting from the action in FIG. 9. Or exampled in 877 in FIG. 8 and in FIG. 88C or FIG. 88D by the check mark indicating that the keys passed the test of being unique to unique or unique to non-unique but ‘Not many to many’ (non-unique to non-unique).

There are many additional variants of the data modelling cardinality implementations including a more rigorous rule rejecting joins that are not one to one (i.e., one join key value/record in a data set is associated with one and only one join key value/record in another data set).

### In Visualizer Chained Joins—Joinable Fields Selection List Types

Our technology supports many different visual representations of the joinable fields. FIG. 18B through FIG. 18E, and FIG. 20B through FIG. 20E example an implementation that displays the joinable fields in a single selection list. However, in cain/sequenced joined situations where the user will have at least three data sets, selection lists making access to the data sets in more manageable chunks is provided. If the two or more additional data sets do not have too many fields/column, then the approaches providing access in the first selection list and fully displaying the joinable data sets in subsequent selection lists. As exampled in FIG. 19A/B/C, FIG. 19A/D/E, FIG. 21A/B/C, and FIG. 21A/D/E is an attractive alternative supported by our technology. In many chain/sequence joined situations where the data sets have many fields/columns, our technology supports a three sequential joinable data access as exampled in FIG. 41A through FIG. 41F.

### In Visualizer Chained Joins—Join Type

Implementations of our technology support the qualified joinable data sets being joinable by an application set or user specified join type (e.g., inner, full outer, left full outer, and cross join). The application set default join which could be any of the joins, e.g., the left outer join to append data, an inner join to limit outcomes to overlapping values, or a full outer join to ensure no data loss. An application default join type can then be overridden by a user selection. All types of SQL joins are supported by our implementations but can also be more limited in their selection list as exampled in FIG. 75B.

### In Visualizer Chained Joins—Joinable Field Formula Usage

Implementations of our technology support usage in the broad spectrum of inputs as exampled herein with straight field/column inputs and inputs into formulas including prebuild functions and/or algebraic operators. Implementations support usage in a broad range of prebuilt spreadsheet functions (e.g., SQRT, COS, SUM, COUNT, STDEV) as exampled in FIG. 70 through FIG. 73, FIG. 74 through FIG. 84, and FIG. 63A through FIG. 69B. Our implementations also support usage of joined data fields in formulas containing many different combinations of functions within functions, combinations of functions and algebraic operators, many formulaic data fields and/or combinations of those combinations as exampled in FIG. 26A through FIG. 30B and FIG. 58A through FIG. 62B.

### In Visualizer Chained Joins—Data Set Source

Implementations of our technology support data sets external to the spreadsheet (e.g., FIG. 6A, and FIG. 6B), data tables or data ranges within the cells of the spreadsheet (e.g., FIG. 7A, and FIG. 7B), and a combination of the two as described herein.

### In Visualizer Chained Joins—Other Implementations

Other implementations may include a non-transitory computer readable storage medium storing instructions executable by a processor to perform any of the methods described above. Yet another implementation may include a system including memory and one or more processors operable to execute instructions, stored in the memory, to perform any of the methods described above.

### Double Joins

Implementations of our technology make the execution of spreadsheet visualizers using fields employing one or both of the double joins very easy for the user. Joins between two data sets where the two join keys for one of the data sets is the same field while the corresponding join keys in the other data set differ. Thus, creating two possible joins between the two data sets where one or more of each of the double joined data sets can be used in generating a spreadsheet visualizer outcome as exampled in FIG. 63A through FIG. 69B and FIG. 70 through FIG. 73. Implementations support different usages of the double joins, for example visualizer charts employing one of the double joins as exampled in FIG. 63A through FIG. 67 and situations where generating the visualizer chart involves the chain joining of both of the double joins as exampled in FIG. 63A through FIG. 69B and FIG. 70 through FIG. 73.

Implementations of our technology further makes double join usage easy by automatically changing the double joined data set field names for the data set which has the same join keys. Those name changes then identify which of the two different joins in the other data set has been used as exampled in the selection lists in FIG. 66 and FIG. 67 and the chained double joins in FIG. 65. One implementation uses the two different join key field names as the automatically altered names as exampled by ‘D_s_abr’ and “automatically appended to the data set field names (in the double joined data set with the same field as the two join keys) in FIG. 66 and FIG. 67. Implementations also include character(s) automatically appended to differentiate the appended characters from the original data set field names such as the dash and right pointing greater than characters ‘->‘exampled in FIG. 66 and FIG. 67 before the other table join key field names. For example, ‘field/column name dataset two->join key field/column name data set one’ as in the example ‘state->D_s_abr’ FIG. 66 6688 where ‘state’ is a field/column in data set two and ‘D_s_abr’ is one of the two different data set one join keys. Additional implementations replace the automatically generated additions to differentiate the double joined data set field names with a user specified set of characters for each of the double joins.

### Double Joins—Involving Double Join Conversion

Situations occur in the spreadsheet visualizer inputs where users have already populated a spreadsheet visualizer input with a double joinable field and then make an additional input that requires that already populated field to need to be converted to one of the two double joins. In some of those situations the spreadsheet visualizer input limitations make it knowable by our technology as to which of the double joins that field should be converted to. In that situation an implementation of our technology automatically converts the field to the joined field. In other situations where it is impossible to know which of the two joins the field should be converted to, our applicable automatically presents the user with both options for their selection as exampled in FIG. 70 through FIG. 73. Once the user makes a selection from the popup 7145 in FIG. 71 (or some other UI supporting selection) our technology automatically alters the field in the spreadsheet visualizer input.

### Double Joins—Join Types

Implementations of our double joins technology support all types of SQL joins including inner, full outer, left outer, right outer, self, and cross joins as exampled in FIG. 65 and FIG. 75B 7535. Implementations support the types of join used being application specified or user specified. Implementation support any of the different type of joins used as the application default join, with the full outer join being an attractive option that drops no data.

### Double Joins—Data Sources

All of our double joins involving both doubles implementations support using data sets from non-spreadsheet cell external to the spreadsheet cells data as exampled in FIG. 6A and FIG. 6B. Those implementations also support using data sets that are ranges of data or tables within cells of the spreadsheet as exampled in FIG. 7A and FIG. 7B and those implementations support use of combinations of external data sets and in-cell data sets.

### Double Joins—Selection Lists

Our double join implementations support automatically displaying the double joined data fields in visualizer selection lists as exampled in FIG. 66 and FIG. 67. That displaying of the double joined fields can be triggered by setting or resetting the joins in any of the locations exampled in FIG. 1. The specified joins can be invisible as exampled in FIG. 68 and FIG. 72 or visibly included in the visualizer inputs as exampled many times herein (e.g., FIG. 90, FIG. 93 and FIG. 98). The double joins can be displayed in a single selection list, as exampled in FIG. 66 and FIG. 67, or in a series of selection list as exampled many times herein (e.g., FIG. 19A through FIG. 19E and FIG. 21A through FIG. 21E).

### Double Joins—Other Implementations

Other implementations of our double joins technology may include a non-transitory computer readable storage medium storing instructions executable by a processor to perform any of the methods described above. Yet another implementation may include a system including memory and one or more processors operable to execute instructions, stored in the memory, to perform any of the methods described above. Implementations also support triple, quadruple, and so on multiple joins working in the same manner where all the join keys in one data set are the same key and each of the join keys in the other data set are different fields.

### Mix and Match Implementations

While the technology disclosed is disclosed by reference to the embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following clauses and claims.

### CLAUSES

### Two Data Set Qualified Selection List Join

1. A method of qualifying a join to be performed within a spreadsheet data visualizer that accepts a list of values as input, displaying those qualified joinable fields in spreadsheet data visualizer populating selection lists, and in the spreadsheet data visualizer joining and using the fields to populate the visualizer chart, including:
   receiving a user input setting at least one input of a spreadsheet data visualizer, wherein the input is a specified field in a first data set;
   accessing a join qualification flag for joinability of the first data set with at least a second data set via a first join key field in the first data set and a second join key field in the second data set;
   responsive to the specified field in the first data set and the join qualification flag for joinability of the first data set and the second data set, automatically displaying a list including a plurality of fields of the second data set, receiving a user selection from the list of a field from the second data set, and populating an input of the spreadsheet data visualizer with the selected field from the second data set;
   joining the specified field from the first set and the selected field from the second data set employing an application default or user specified join type employing the first join key field in the first data set and the second join key field in the second data set to produce a list of joined values; and
   using the list of values in the joined data to create the spreadsheet visualizer chart.
2. The method of clause 1, wherein the join qualification flag is set before user input in the visualizer chart input.
3. The method of clause 2, wherein the join of the first and second data sets requires no visible joining input or joining function input in the visualizer inputs panel.
4. The method of clause 2, wherein the join of the first and second data sets includes a visible joining input or joining function input in the visualizer inputs panel.
5. The method of clause 4, wherein the joining input or joining function input specifies the join type.
6. The method of clause 4, wherein the joining input or joining function input specifies the join keys.
7. The method of clause 2, wherein a type of join and/or the join keys can be changed via inclusion in the spreadsheet data visualizer inputs of a joining input or joining function input changing the type of join and/or changing the join keys used by the join.
8. The method of clause 2, wherein the join qualification flag for the first data set is stored with and accessed with first data set.
9. The method of clause 2, wherein the join qualification flag for the first data set is stored within the spreadsheet by a data intake tool used before inputting the visualizer inputs.
10. The method of clause 1, wherein a join can be added via a spreadsheet visualizer join input or a join prebuilt function input inputted within the spreadsheet visualizer inputs.
11. The method of clause 10, wherein after the input into the spreadsheet visualizer inputs of the completed join input or join prebuilt function input the joined fields are qualified for selection list support in the visualizer.
12. The method of clause 10, wherein that join is supported by a join key pair selection list that includes automated validation of the qualification of the join.
13. The method of clause 1, wherein the qualified join is human qualified to set the flag.
14. A method of clause 13, wherein a human qualified join is further automatically qualified for at least data type and data match.
15. The method of clause 1, wherein a join is automatically identified and qualified to set the flag.
16. The method of clause 15, wherein the automatically qualified joins are further human qualified to set the join qualification flag.
17. The method of clause 1, wherein data set one and join key field one and data set two are human specified, join key field two candidates are automatically qualified, and the final join key two field is human selected.
18. The method of clause 2, wherein the join qualification flag setting is done before the spreadsheet in a data intake tool.
19. The method of any of clause 2, wherein the join qualification flag setting is done within the spreadsheet by a data intake tool used before the visualizer input.
20. The method of any of clause 2, wherein the join qualification flag setting is done within a spreadsheet location where it is applicable to all visualizers.
21. The method in clause 1, wherein automated flag qualification accepts the first data set first key and the second data set second key only when they are of the same data type.
22. The method in clause 1, wherein the automated flag qualification accepts between the first data set first key and the second data set second key only if they have at least some matching values.
23. The method of clause 1, wherein the automated flag qualification accepts joins the first data set first key and the second data set second key provided they have specified data modeling cardinalities.
24. The method of clause 23, wherein the accepted data modelling cardinality differs by location of qualification.
25. The method of clause 23, wherein the accepted data modeling cardinality is unique to unique, unique to non-unique, or non-unique to unique.
26. The method of clause 24, wherein the join qualification flag set prior to this visualizer input accepts data modeling cardinality unique to unique, unique to non-unique, or non-unique to unique and the join qualification flag set within this visualizer input accepts all data modelling cardinalities.
27. The method of clause 1, wherein fields in joinable data sets are displayed in a single list for selection.
28. The method of clause 1, wherein the fields in joinable sets are accessible from a single selection list.
29. The method of clause 28, wherein accessing the fields in the joinable data set involves one or more sequential selection list selections.
30. The method of clause 2, wherein the flag qualified joins have an application or a user specified join type.
31. The method of clause 30, wherein the join type is a full outer join.
32. The method of clause 1, wherein all SQL join types are supported.
33. The method of clause 1, wherein a user selected joined field replaces a field in the other joined data set.
34. The method of clause 1, wherein the joined fields are used in formulaic data field formulas within the visualizer input.
35. The method of clause 1, wherein the joined fields are used in a prebuilt function formula within the visualizer input.
36. The method of clause 1, wherein the joined fields are used in multi-prebuilt function and multi-algebraic operator formulas within the visualizer input.
37. The method of clause 1, wherein the data sets are data tables external to the spreadsheet.
38. The method of clause 1, wherein the data sets are ranges of data or tables within cells of the spreadsheet.
39. The method of clause 1, wherein the data sets are a combination of data tables external to the spreadsheet and ranges of data or tables within cells of the spreadsheet.
40. The method of clause 1, wherein the join qualification flag is set after automatically determining that the first field and second field are of the same data type, have overlapping values and have data modelling cardinalities of unique to unique or unique to non-unique.
41. A non-transitory computer readable memory, the memory impressed with computer instructions that, when executed on hardware, cause the hardware to carry out the method of any of clauses 1 through 40.
42. A system including processing hardware coupled to memory, the memory impressed with computer instructions that, when executed, cause the hardware to carry out the method of any of clauses 1 through 40.

### In Visualizer Two Data Set Join

43. A method for joining and using the joined fields from two different data sets within a spreadsheet visualizer, including:
   causing display of a spreadsheet visualizer chart interface that includes at least a chart panel and an input panel;
   wherein the input panel accepts a join specifier input employing an application default or user specified join type and accepting a first key field in the first data set and a second key field in the second data set;
   responsive to the user selecting at least one field from data set one and at least one field from data set two in the join specifier panel visualizer chart inputs, employing the join type and the first join key field in the first data set and the second join key field in the second data set to produce a list of joined values; and
   using the list of values of the joined data to create the spreadsheet visualizer chart.
44. The method of clause 43, wherein the join specifier has structured arguments or a join function with structured arguments that specify the first data set/first field and second data set/second field used as keys in the join.
45. The method of clause 43, wherein the join specifier also contains an argument or a join function with structured arguments specifying the type of join.
46. The method of clause 43, wherein the join specifier structured arguments or a join function with structured arguments specify the accepted data modelling cardinality or cardinalities.
47. The method of clause 43, wherein the join specifier structured arguments or a join function with structured arguments specifies a minimum value match (e.g., percentage) between the join keys.
48. The method of clause 43, wherein adding a join specifier that joins a first and a second data set via a first field in the first data set and a second field in the second data set has join specifier selection list support.
49. The method of clause 48, wherein that selection list support includes join setup data set and data field selections (within the data sets).
50. The method of clause 48, wherein that selection list support includes qualification validation requirements of the join.
51. The method of clause 48, wherein that selection list support includes join key validation analytical results for data type match and data value match.
52. The method of clause 48, wherein that selection list support includes automated validation of the qualification of the join.
53. The method in clause 43, wherein automated flag qualification accepts join key fields one and two only when they are of the same data type.
54. The method in clause 43, wherein the automated flag qualification accepts join key fields one and two only if they have at least one matching value.
55. The method of clause 43, wherein the automated flag qualification only accepts join key field joins that have specified data modelling cardinalities.
56. The method of clause 55, wherein the accepted data modelling cardinality is unique to unique, non-unique to unique or unique to non-unique.
57. The method of clause 47, wherein manual specification of the join between the first and second data sets causes the fields in the first and second datasets to become automatically visible together in selection lists for subsequent use of the first and second datasets visualizer inputs.
58. The method of clause 57, wherein the fields in joinable data sets are displayed in a single selection list.
59. The method of clause 57, wherein the fields in joinable data sets are accessible from a single selection list.
60. The method of clause 59, wherein accessing the fields in the joinable data sets involves one or more sequential selection list selections.
61. The method of clause 43, wherein all SQL join types are supported.
62. The method of clause 43, wherein the joined fields can be used in formulaic data field formulas within the visualizer input.
63. The method of clause 43, wherein the joined fields are used in a prebuilt function formula within the visualizer input.
64. The method of clause 43, wherein the joined fields can be used multi-prebuilt function and multi-algebraic operator formulas within the visualizer input.
65. The method of clause 43, wherein the data sets are data tables external to the spreadsheet.
66. The method of clause 43, wherein the data sets are ranges of data or tables within cells of the spreadsheet.
67. The method of clause 43, wherein the data sets are a combination of data tables external to the spreadsheet and ranges of data or tables within cells of the spreadsheet.
68. The method of clause 43, wherein the visualizer input panel is integrated into the visualizer chart panel.
69. A non-transitory computer readable memory, the memory impressed with computer instructions that, when executed on hardware, cause the hardware to carry out the method of any of clauses 43 through 68.
70. A system including processing hardware coupled to memory, the memory impressed with computer instructions that, when executed, cause the hardware to carry out the method of any of clauses 43 through 68.

### Chain Qualified Selection List Joins

71. A method for chain joining and using the joined fields from multiple different data sets within a spreadsheet chart visualizer, including:
   causing display of a spreadsheet visualizer chart interface that includes at least a chart panel and an input panel;
   wherein the input panel accepts a join specifier input employing an application default or user specified join type and accepting a
   setting a join qualification flag for the joinability of:
      a first and second data set via a first key field in the first data set and a second key field in the second data set and
      a first and a third data set via a third key field in the third data set and a fourth key field in the first data set;
   setting a chained join qualification flag for the chained joinability of the second and the third data sets;
   receiving input from a user from an input panel specifying a field belonging to the second data set;
   responsive to the specified field in the second data set and the chained join qualification flag: automatically displaying at least some of the fields of the second, first, and third data sets, accepting a user selection of a field in the third data set, and
      populating the spreadsheet visualizer input with the selected field from the from the third data set; and
   chain joining the fields from each data set shown in the visualizer input; and using the joined data to create the spreadsheet visualizer chart.
72. The method of clause 71, wherein the join qualification flag is set before user input in the visualizer input panel.
73. The method of clause 72, wherein the joins of the first, second, and third data sets, based on the parameters of the visualizer input requires no visible joining argument or function in the visualizer input.
74. The method of clause 72, wherein the qualified join requires a visible joining argument or function in the visualizer.
75. The method of clause 71, wherein the joining argument or joining function specifies the join type.
76. The method of clause 71, wherein the joining argument or joining function specifies the join keys.
77. The method of clause 72, wherein the join flag join can be changed via inclusion in the visualizer input of a join prebuilt function and/or a join argument.
78. The method of clause 77, wherein join prebuilt function and/or a join formula argument changes at least one of the first, second, third and/or fourth field used as a key for one or both of the joins.
79. The method of clause 77, wherein a join prebuilt function and/or a join formula argument changes at least one join type.
80. The method of clause 71, wherein two or more joins are between the same two data sets sharing the same first and fourth field in the first data set but have different second and third fields in the second data set.
81. The method of clause 80, wherein the joinable field names for field one and field four are automatically changed for use in the join.
82. The method of clause 81, wherein the automatic change of the field names includes appending the second field name to field one and the third field name to field four in the first data set.
83. The method of clause 71, wherein a new qualified join flag can be added via a visualizer join specifier input argument or join specifier input prebuilt function specified by the spreadsheet user.
84. The method of clause 83, wherein the join specifier input has data set and join key field selection list support.
85. The method of clause 84, wherein that join specifier input is supported by a join key pair selection list that includes validation information and results for the qualification of the join.
86. The method of clause 84, wherein that join specifier input is supported by a join key pair selection list that includes automated validation of the qualification of the join.
87. The method of clause 71, wherein the input into the visualizer join specifier of the completed join argument or completed join prebuilt function qualifies the data sets for joined selection list support for inputs in the visualizer panel.
88. The method of clause 71, wherein the qualified join is human qualified to set the flag.
89. A method of clause 88, wherein a human qualified join is further automatically qualified algorithmically to set the flag.
90. The method of clause 71, wherein a join is automatically identified and qualified to set the flag.
91. The method of clause 90, wherein the automatically qualified joins are further human qualified to set the flag.
92. The method of clause 71, wherein data set one and join key field one and data set two are human specified, join key field two candidates are automatically qualified, and the final join key two field is human selected.
93. The method of clause 72, wherein the join qualification flag setting is done within the spreadsheet by a data intake tool used before the visualizer input.
94. The method of any of clause 72, wherein the join qualification flag setting is done within a spreadsheet location where it is applicable to all visualizers.
95. The method in clause 71, wherein automated flag qualification accepts join key fields one and two when they are of the same data type and accepts join key fields three and four when they are of the same data type.
96. The method in clause 71, wherein the automated flag qualification accepts fields one and two only if they have at least one matching value and accepts fields three and four only if they have at least one matching value.
97. The method of clause 71, wherein the automated qualification accepts joins that have specified data modelling cardinalities.
98. The method of clause 97, wherein the accepted data modelling cardinality differs by location of qualification.
99. The method of clause 97, wherein the individual joins pass the data modeling cardinality validation test but when chain joined automatically fail the validation test and therefore not setting the chained join qualification flag.
100. The method of clause 97, wherein the accepted data modelling cardinality is unique to unique, non-unique to unique, or unique to non-unique.
101. The method of clause 98, wherein the join qualification flag set prior to this visualizer input accepts data modelling cardinality unique to unique, non-unique to unique, or unique to non-unique and the join qualification flag set within this visualizer input accepts all modelling cardinalities.
102. The method of clause 71, wherein the fields in joinable data sets are displayed in a single selection list.
103. The method of clause 71, wherein the fields in joinable data sets are accessible from a single selection list.
104. The method of clause 103, wherein accessing the fields in the joinable data sets involves one or more sequential selection list selections.
105. The method of clause 72, wherein the flag qualified joins have an application or a user specified join type.
106. The method of clause 72, wherein the qualified joins have a user specified join type.
107. The method of clause 72, wherein the qualified joins are stored with the data sets or within the spreadsheet.
108. The method of clause 105, wherein the join type is a full outer join.
109. The method of clause 71, wherein all SQL join types are supported.
110. The method of clause 71, wherein a user selected joined field replaces a field in the other joined data set.
111. The method of clause 71, wherein the joined fields are used in formulaic data field formulas within the visualizer input.
112. The method of clause 71, wherein the joined fields are used in multi-function and multi-algebraic operator formulas within the visualizer input.
113. The method of clause 71, wherein the data sets are data tables external to the spreadsheet.
114. The method of clause 71, wherein the data sets are ranges of data or tables within cells of the spreadsheet.
115. The method of clause 71, wherein the data sets are a combination of data tables external to the spreadsheet and ranges of data or tables within cells of the spreadsheet.
116. A non-transitory computer readable memory, the memory impressed with computer instructions that, when executed on hardware, cause the hardware to carry out the method of any of clauses 71 through 115.
117. A system including processing hardware coupled to memory, the memory impressed with computer instructions that, when executed, cause the hardware to carry out the method of any of clauses 71 through 115.

### In Visualizer Chained Joins

118. A method for chain joining and using the joined fields from three or more different data sets within a spreadsheet visualizer chart, including:
causing display of a spreadsheet visualizer chart interface that includes at least a chart panel and an input panel including a join specifier;
   wherein the join specifier panel accepts input to join:
   a first and second data set via a first key field in the first data set and a second key field in the second data set and
      a first and a third data set via a third key field in the third data set and a fourth key field in the first data set;
   automatically or manually qualifying chain joinability between the second and third data sets via the first data set using the key fields;
   responsive to the user selecting fields from the second and third data sets, automatically chain joining the selected fields via the first data set; and using the joined data to create the spreadsheet visualizer chart.
119. The method of clause 118, wherein the join specifier has structured arguments that specify the first data set/first field and second data set/second field used as keys in the join.
120. The method of clause 119, wherein the join specifier also contains an argument specifying the type of join.
121. The method of clause 118, wherein the join specifier join has an automatically applied type of join.
122. The method of clause 121, wherein the join type is a full outer join.
123. The method of clause 118, wherein the join specifier structured arguments specify the accepted data modelling cardinality.
124. The method of clause 118, wherein the join specifier structured arguments specifies a minimum value match percentage between the join keys.
125. The method of clause 118, wherein adding a join specifier that has selection list support for populating the join(s).
126. The method of clause 125, wherein that join selection list support includes join setup data set and field selections.
127. The method of clause 125, wherein that selection list support includes qualification validation requirements of the join.
128. The method of clause 125, wherein that selection list support includes validation analytical results for the qualification of the join.
129. The method of clause 125, wherein that selection list support includes automated validation of the qualification of the join.
130. The method in clause 118, wherein automated flag qualification accepts join key fields one and two only when they are of the same data type and accepts join key fields three and four only when they are of the same data type.
131. The method in clause 118, wherein the automated flag qualification accepts join key fields one and two only if they have at least one matching value and accepts join key fields three and four only if they have at least one matching value.
132. The method of clause 118, wherein the automated flag qualification accepts joins that have specified data modelling cardinalities.
133. The method of clause 132, wherein the accepted data modelling cardinality is unique to unique or unique to non-unique.
134. The method of clause 118, wherein after the input into the visualizer join specifier of a chain joinable completed join argument or join prebuilt function the chain joinable fields are automatically qualified for selection list support.
135. The method of clause 134, wherein the fields in joinable data sets are displayed in a single selection list.
136. The method of clause 134, wherein the fields in joinable data sets are accessible from a single selection list.
137. The method of clause 136, wherein accessing the fields in the joinable data sets involves one or more sequential selection list selections.
138. The method of clause 118, wherein the flag qualified joins have an application or a user specified join type.
139. The method of clause 118, wherein all SQL join types are supported.
140. The method of clause 118, wherein a user selected joined field replaces a field in the other joined data set.
141. The method of clause 118, wherein the joined fields are used in formulaic data field formulas within the visualizer input.
142. The method of clause 118, wherein the joined fields are used in prebuilt function formulas within the visualizer input.
143. The method of clause 118, wherein the joined fields are used in multi-function and multi-algebraic operator formulas within the visualizer input.
144. The method of clause 118, wherein the data sets are data tables external to the spreadsheet.
145. The method of clause 118, wherein the data sets are ranges of data or tables within cells of the spreadsheet.
146. The method of clause 118, wherein the data sets are a combination of data tables external to the spreadsheet and ranges of data or tables within cells of the spreadsheet.
147. A non-transitory computer readable memory, the memory impressed with computer instructions that, when executed on hardware, cause the hardware to carry out the method of any of clauses 118 through 146.
148. A system including processing hardware coupled to memory, the memory impressed with computer instructions that, when executed, cause the hardware to carry out the method of any of clauses 118 through 146.

### Double Joins

149. A method of selecting between two potentially simultaneous joins between two data sets within a spreadsheet visualizer and using one or more of the two joins to produce the spreadsheet visualizer chart, including:
receiving a definition of two potentially simultaneous joins:
   join one a first and second data set via a first key field in the first data set and a second key field in the second data set and
   join two the same first and the second data sets via a third key field in the first data set that is different than the first key field and the second key field in the second data set that is the same second key as used with the first key in the first join;
receiving input into the spreadsheet cell formula from a user that specifies:
   at least on field from the first data set; and
   at least one field from second data set employing join one;
not receiving any input from a user specifying a field from the second data set employing join two;
   joining the inputted fields from the first and the second datasets using join one; and using the joined data to generate the spreadsheet visualizer chart.
150. The method of clause 149, further including:
   where the user specifies at least one field from the second data set employing the second join: chain joining the inputted fields from second datasets and any inputted fields from the first data
      set using join one and join two; and using the chain joined data to generate the spreadsheet visualizer chart.
151. The method of clause 149, wherein the joinable field names for the join one data set two and the join two data set two are automatically changed so they are differentiated from the other versions.
152. The method of clause 151, wherein the automatic change of the field names includes appending the first key field name to each of the fields in data set two to make the join one version of data set two field names and appending the third key field name to each of the fields in data set two to make the join two version of data set two fields names.
153. The method of clause 152, wherein the appended second and third key field names are preceded by the dash and right pointing characters (->).
154. The method of clause 149, wherein the joinable field names for the join one data set two and the join two data set two are changed by a user specified data field name addition so they are differentiated from the other versions.
155. The method of clause 149, wherein a previous population of a non-join one or non-join two data set two field into an input is automatically converted to a join one version of the same field once a user populates an input with a data set two join one field of the same field into spreadsheet visualizer inputs that do not allow multiple use of the same field.
156. The method of clause 149, wherein a previous population of a non-join one or non-join two data set two field into an input is automatically presented an option for a join one or join two version of the same field once a user populates an input with a data set one field, a data set two join one field, or a data set two join two field.
157. The method of clause 149, wherein inner, full outer, right outer, self, cross and left outer SQL join types are supported.
158. The method of clause 149, wherein the default join type is a full outer join.
159. The method of clause 149, wherein the data sets are data tables external to the spreadsheet.
160. The method of clause 149, wherein the data sets are ranges of data or tables within cells of the spreadsheet.
161. The method of clause 149, wherein the data sets are a combination of ranges of data or tables within cells of the spreadsheet and the data sets are data tables external to the spreadsheet.
162. The method of clause 149, wherein specification of join one and join two automatically make visible the joined fields in spreadsheet visualizer input selection lists.
163. The method of clause 162, wherein specification of join one and join two is done prior to the spreadsheet visualizer inputs.
164. The method of clause 162, wherein specification of join one and/or join two is done within the spreadsheet visualizer inputs.
165. The method of clause 163, wherein specification of join one and join two is invisible in the spreadsheet visualizer inputs.
166. The method of clause 163, wherein specification of join one and join two is visible in the spreadsheet visualizer inputs.
167. The method of clause 162, wherein the fields in joinable data sets are displayed in a single selection list.
168. The method of clause 162, wherein the fields in joinable data sets are accessible from multiple selection lists.
169. The method of clause 168, wherein accessing the fields in the joinable data sets involves one or more sequential selection list selections.
170. A non-transitory computer readable memory, the memory impressed with computer instructions that, when executed on hardware, cause the hardware to carry out the method of any of clauses 149 through 169.
171. A system including processing hardware coupled to memory, the memory impressed with computer instructions that, when executed, cause the hardware to carry out the method of any of clauses 149 through 169.

We claim as follows:

1. A method of qualifying a join to be performed within a spreadsheet data visualizer that accepts a list of values as input, displaying those qualified joinable fields in spreadsheet data visualizer populating selection lists, and in the spreadsheet data visualizer joining and using the fields to populate the visualizer chart, including:
receiving a user input setting at least one input of a spreadsheet data visualizer, wherein the input is a specified field in a first data set;
accessing a join qualification flag for joinability of the first data set with at least a second data set via a first join key field in the first data set and a second join key field in the second data set;
responsive to the specified field in the first data set and the join qualification flag for joinability of the first data set and the second data set, automatically displaying a list including a plurality of fields of the second data set, receiving a user selection from the list of a field from the second data set, and populating an input of the spreadsheet data visualizer with the selected field from the second data set;
joining the specified field from the first set and the selected field from the second data set employing an application default or user specified join type employing the first join key field in the first data set and the second join key field in the second data set to produce a list of joined values; and
using the list of values in the joined data to create the spreadsheet visualizer chart.

2. The method of claim 1, wherein the join qualification flag is set before user input in the visualizer chart input.

3. The method of claim 2, wherein the join of the first and second data sets requires no visible joining input or joining function input in the visualizer inputs panel.

4. The method of claim 1, wherein the join of the first and second data sets includes a visible joining input or joining function input in the visualizer inputs panel.

5. The method of claim 4, wherein the joining input or joining function input specifies the join type.

6. The method of claim 4, wherein the joining input or joining function input specifies the join keys.

7. The method of claim 2, wherein a type of join and/or the join keys can be changed via inclusion in the spreadsheet data visualizer inputs of a joining input or joining function input changing the type of join and/or changing the join keys used by the join.

8. The method of claim 2, wherein the join qualification flag for the first and second data set is stored with and accessed with first data and second sets.

9. The method of claim 2, wherein the join qualification flag for the first and second data set is stored within the spreadsheet.

10. The method of claim 2, wherein a join can be added via a spreadsheet visualizer join input or a join prebuilt function input inputted within the spreadsheet visualizer inputs.

11. The method of claim 1, wherein fields in joinable data sets are displayed in a single list for selection.

12. The method of claim 1, wherein accessing the fields in the second data set involves sequential selection list selections.

13. The method of claim 1, wherein the join type for the joining is an SQL join type.

14. The method of claim 1, wherein the joined fields are used in a prebuilt function formula within the visualizer input.

15. The method of claim 1, wherein a spreadsheet visualizer input formula includes multiple prebuilt spreadsheet functions combined by one or more algebraic operators.

16. The method of claim 1, wherein the data sets are data tables external to the spreadsheet.

17. The method of claim 1, wherein the data sets are ranges of data or tables within cells of the spreadsheet.

18. The method of claim 1, wherein the data sets are a combination of data tables external to the spreadsheet and ranges of data or tables within cells of the spreadsheet.

19. A non-transitory computer readable memory, the memory impressed with computer instructions that, when executed on hardware, cause the hardware to carry out the method of qualifying a join to be performed within a spreadsheet data visualizer that accepts a list of values as input, displaying those qualified joinable fields in spreadsheet data visualizer populating selection lists, and in the spreadsheet data visualizer joining and using the fields to populate the visualizer chart, including:
receiving a user input setting at least one input of a spreadsheet data visualizer, wherein the input is a specified field in a first data set;
accessing a join qualification flag for joinability of the first data set with at least a second data set via a first join key field in the first data set and a second join key field in the second data set;
responsive to the specified field in the first data set and the join qualification flag for joinability of the first data set and the second data set, automatically displaying a list including a plurality of fields of the second data set, receiving a user selection from the list of a field from the second data set, and populating an input of the spreadsheet data visualizer with the selected field from the second data set;
joining the specified field from the first set and the selected field from the second data set employing an application default or user specified join type employing the first join key field in the first data set and the second join key field in the second data set to produce a list of joined values; and
using the list of values in the joined data to create the spreadsheet visualizer chart.

20. The non-transitory computer-readable medium of claim 19, wherein the join qualification flag is set before input in the visualizer chart input.

21. The non-transitory computer-readable medium of claim 20, wherein the join of the first and second data sets requires no visible joining input or joining function input in the visualizer inputs panel.

22. The non-transitory computer-readable medium of claim 19, wherein the join of the first and second data sets includes a visible joining input or joining function input in the visualizer inputs panel.

23. A system including processing hardware coupled to memory, the memory impressed with computer instructions that, when executed, cause the hardware to carry out the method of qualifying a join to be performed within a spreadsheet data visualizer that accepts a list of values as input, displaying those qualified joinable fields in spreadsheet data visualizer populating selection lists, and in the spreadsheet data visualizer joining and using the fields to populate the visualizer chart, including:
receiving a user input setting at least one input of a spreadsheet data visualizer, wherein the input is a specified field in a first data set;
accessing a join qualification flag for joinability of the first data set with at least a second data set via a first join key field in the first data set and a second join key field in the second data set;
responsive to the specified field in the first data set and the join qualification flag for joinability of the first data set and the second data set, automatically displaying a list including a plurality of fields of the second data set, receiving a user selection from the list of a field from the second data set, and populating an input of the spreadsheet data visualizer with the selected field from the second data set;
joining the specified field from the first set and the selected field from the second data set employing an application default or user specified join type employing the first join key field in the first data set and the second join key field in the second data set to produce a list of joined values; and
using the list of values in the joined data to create the spreadsheet visualizer chart.

24. The system of claim 23, wherein fields in joinable data sets are displayed in a single list for selection.

25. The system of claim 23, wherein accessing the fields in the second data set involves sequential selection list selections.
